(19) United States
(12) Patent Application Publication
(10) Pub. No.: US 2025/0268118 A1
(43) Pub. Date: Aug. 28, 2025

(54) ROW DETECTION SYSTEM, AGRICULTURAL MACHINE PROVIDED WITH ROW DETECTION SYSTEM, AND ROW DETECTION METHOD

(71) Applicant: Kubota Corporation, Osaka-shi (JP)

(72) Inventors: Mitsuaki NAGAO, Sakai-shi (JP); Yuma ARAKAWA, Sakai-shi (JP)

(21) Appl. No.: 19/196,724

(22) Filed: May 1, 2025

Related U.S. Application Data
(63) Continuation of application No. PCT/JP2023/039198, filed on Oct. 31, 2023.

(30) Foreign Application Priority Data
Nov. 2, 2022 (JP) 2022-176122
Nov. 2, 2022 (JP) 2022-176123

(51) Int. Cl. A01B 69/00; A01B 69/04

(52) U.S. Cl. CPC A01B 69/001; A01B 69/008

(57) ABSTRACT

A row detection system includes a first imager attached to an agricultural machine to capture images of a ground surface and generate a first image of a first region of the ground surface, a second imager attached to the agricultural machine to capture images of the ground surface and generate a second image of a second region of the ground surface, the second region partially overlapping the first region, and a processor configured or programmed to perform image processing on the first and second images, generate a combined image through processing that includes planar panorama image synthesis based on the first and second images, and detect rows of crops or ridges on the ground surface based on the combined image.

### CROSS REFERENCE TO RELATED APPLICATIONS

This application claims the benefit of priority to Japanese Patent Application Nos. 2022-176122 and 2022-176123 filed on Nov. 2, 2022 and is a Continuation Application of PCT Application No. PCT/JP2023/039198 filed on Oct. 31, 2023. The entire contents of each application are hereby incorporated herein by reference.

### BACKGROUND OF THE INVENTION

### 1. Field of the Invention

The present invention relates to row detection systems, agricultural machines including row detection systems, and row detection methods.

### 2. Description of the Related Art

Research and development has been directed to the automation of work vehicles, such as tractors, to be used in fields. For example, work vehicles have been put to practical use which travel via automatic steering by utilizing a positioning system capable of precise positioning, e.g., GNSS (Global Navigation Satellite System). Work vehicles that automatically perform speed control as well as automatic steering have also been put to practical use.

Moreover, vision guidance systems are being developed which detect rows of crops (crop rows) or ridges in a field by using an imager such as a camera, and control the travel of a work vehicle along the detected crop rows or ridges.

Japanese Laid-Open Patent Publication No. 2016-208871 discloses an implement that travels along a ridge in cultivated land where crops are planted in ridges which are formed in rows. Japanese Laid-Open Patent Publication No. 2016-208871 describes binarizing a raw image acquired by capturing an image of the cultivated land from obliquely above with an onboard camera, and thereafter generating a planar perspective projection image. With the technique disclosed by Japanese Laid-Open Patent Publication No. 2016-208871, the planar perspective projection image is rotated to generate a large number of rotated images having different orientations from each other and thus to detect a work path between the ridges.

### SUMMARY OF THE INVENTION

When an agricultural machine is to move by automatic steering along a row region such as crop rows, ridges or the like by use of an image recognition technique, it is required to detect the row region at high precision.

Example embodiments of the present invention provide row detection systems capable of improving the detection precision of a row region, agricultural machines including such row detection systems, and row detection methods.

A row detection system according to an example embodiment of the present disclosure includes a first imager attached to an agricultural machine to capture an image of a ground surface to generate a first image of a first region of the ground surface, a second imager attached to the agricultural machine to capture an image of the ground surface to generate a second image of a second region of the ground surface partially overlapping the first region, and a processor configured or programmed to execute image processing on the first image and the second image, execute a process including planar panorama image synthesis based on the first image and the second image to generate a synthesized image, and detect a crop row or a ridge on the ground surface based on the synthesized image.

An agricultural machine according to another example embodiment of the present disclosure includes the above-described row detection system, and an automatic steering device configured or programmed to control a traveling direction of the agricultural machine based on the position of the crop row or the ridge detected by the row detection system.

A row detection method according to still another example embodiment of the present disclosure is a row detection method to be implemented by a computer. The row detection method causes the computer to execute acquiring a first image from a first imager attached to an agricultural machine to capture an image of a ground surface to generate the first image of a first region of the ground surface, acquiring a second image from a second imager attached to the agricultural machine to capture an image of the ground surface to generate the second image of a second region of the ground surface partially overlapping the first region, executing a process including planar panorama image synthesis based on the first image and the second image to generate a synthesized image, and detecting a crop row or a ridge on the ground surface based on the synthesized image.

A row detection system according to still another example embodiment of the present disclosure includes an imager attached to an agricultural machine to capture an image of a ground surface to generate time-series images including at least a portion of the ground surface, and a processor configured or programmed to execute image processing on the time-series images, determine an index value of at least a portion of pixels of the time-series images, the index value being to distinguish a crop row or a ridge as a target of detection from the remaining region, divide a portion of, or an entirety of, the time-series images or a plan view image obtained as a result of transformation of the time-series images into a plurality of band-shaped blocks arranged in an image vertical direction, and for each of the plurality of blocks, while changing the direction of the plurality of scanning lines to a plurality of directions, executing a process of determining a total value or an average value of the index values along each of a plurality of scanning lines parallel to each other, the process being executed for each of the plurality of directions, determining one direction corresponding to the direction of the crop row or the ridge among the plurality of directions based on the relationship between the position of the scanning lines and the total value or the average value, determining positions of edge lines of the crop row or the ridge based on the relationship between the position of the scanning lines and the total value or the average value in the determined direction, and determining an approximation line of the crop row or the ridge based on the direction and the positions of the edge lines determined for each of the plurality of blocks.

An agricultural machine according to still another example embodiment of the present disclosure includes the above-described row detection system, and an automatic steering device configured or programmed to control a traveling direction of the agricultural machine based on the approximation line of the crop row or the ridge determined by the row detection system.

A row detection method according to still another example embodiment of the present disclosure is a row detection method to be implemented by a computer. The row detection method causes the computer to execute acquiring time-series images from an imager attached to an agricultural machine to capture an image of a ground surface to generate the time-series images including at least a portion of the ground surface, determining a distribution of index values of at least a portion of pixels of the time-series images, the index values being to distinguish a crop row or a ridge as a target of detection from the remaining region, dividing a portion of, or the entirety of, the time-series images or a plan view image obtained as a result of transformation of the time-series images into a plurality of band-shaped blocks arranged in an image vertical direction, and for each of the plurality of blocks, while changing the direction of the plurality of scanning lines to a plurality of directions, executing a process of determining a total value or an average value of the index values along each of a plurality of scanning lines parallel to each other, the process being executed for each of the plurality of directions, determining one direction corresponding to the direction of the crop row or the ridge among the plurality of directions based on the relationship between the position of the scanning lines and the total value or the average value, determining positions of edge lines of the crop row or the ridge based on the relationship between the position of the scanning lines and the total value or the average value in the determined direction, and determining an approximation line of the crop row or the ridge based on the direction and the positions of the edge lines determined for each of the plurality of blocks.

Example embodiments of the present disclosure may be implemented using a device, a system, a method, an integrated circuit, a computer program, a non-transitory computer-readable storage medium, or any combination thereof. The computer-readable storage medium may be inclusive of a volatile storage medium, or a non-volatile storage medium. The device may include a plurality of devices. In the case where the device includes two or more devices, the two or more devices may be disposed within a single apparatus, or divided over two or more separate apparatuses.

According to example embodiments of the present disclosure, it is made possible to improve the detection precision of the row region such as the crop rows, the ridges or the like.

The above and other elements, features, steps, characteristics and advantages of the present invention will become more apparent from the following detailed description of the example embodiments with reference to the attached drawings.

### BRIEF DESCRIPTION OF DRAWINGS

FIG. 1 is a block diagram showing a configuration of a row detection system according to an example embodiment 1 of the present disclosure.

FIG. 2 is a flowchart showing an overview of an operation executed by a processor.

FIG. 3A schematically shows how a first imager and a second imager attached to an agricultural machine capture images of a portion of a crop row.

FIG. 3B shows an example of region of a ground surface that is shown in a synthesized image.

FIG. 4 schematically shows how the first imager and the second imager attached to the agricultural machine captures images of the ground surface.

FIG. 5 is a perspective view schematically showing the relationship among a vehicle coordinate system Σb, a camera coordinate system Σc1 of the first imager, a camera coordinate system Σc2 of the second imager, and a world coordinate system Σw fixed to the ground surface.

FIG. 6 is a plan view schematically showing a portion of a field where a plurality of crop rows are provided on the ground surface.

FIG. 7 schematically shows an example of image acquired by an imager of an agricultural machine shown in FIG. 6.

FIG. 8 is a plan view schematically showing a state where a traveling direction of the agricultural machine is inclined with respect to a direction in which the crop rows extend.

FIG. 9 schematically shows an example of image acquired by an imager of an agricultural machine shown in FIG. 8.

FIG. 10 is a plan view schematically showing a portion of a field where a plurality of curved crop rows are provided on the ground surface.

FIG. 11 is a block diagram showing an example hardware configuration of the processor.

FIG. 12 is a flowchart showing an example operation of the processor.

FIG. 13 is a perspective view schematically showing positions of each of a camera coordinate system Σc1 of an imager at a first pose and a camera coordinate system Σc3 of an imaginary imager at a second pose, with respect to a reference plane Re.

FIG. 14 is a view provided to describe a synthesis process performed on a first plan view image and a second plan view image.

FIG. 15 shows an example of a first image, a second image, the first plan view image and the second plan view image.

FIG. 16 shows an example of synthesized image generated in the example of FIG. 15.

FIG. 17 shows an example of state where an image of a calibration subject placed on the ground surface is captured by two imagers.

FIG. 18 shows an example of images acquired by image capturing of the calibration subject.

FIG. 19 shows a synthesized enhanced image provided as a result of RGB values in the synthesized image shown in FIG. 16 being transformed into “2×g−r−b”.

FIG. 20 shows an example of binary image provided as a result of binarization of the synthesized enhance image shown in FIG. 19.

FIG. 21 shows a histogram of excess green index (E×G) in the synthesized enhanced image shown in FIG. 19.

FIG. 22 schematically shows an example of image showing three crop rows.

FIG. 23 schematically shows the relationship between the position of the scanning lines and the total value of the index values, obtained for the image shown in FIG. 22.

FIG. 24 shows an example of image in which the crop rows extend obliquely.

FIG. 25 schematically shows the relationship between the position of the scanning lines and the total value of the index values, obtained for the image shown in FIG. 24.

FIG. 26 is a flowchart showing an example of procedure for searching for the direction, of the scanning lines, that is parallel to the direction of the crop rows by changing the direction of the scanning lines.

FIG. 27 is a perspective view showing an example of external appearance of an agricultural machine.

FIG. 28 is a side view schematically showing an example of the agricultural machine in a state where an implement is attached thereto.

FIG. 29 is a block diagram schematically showing an example configuration of the agricultural machine and the implement.

FIG. 30 is a block diagram showing a configuration of the row detection system according to an example embodiment 2 of the present disclosure.

FIG. 31 is a flowchart showing a flow of operations of the processor.

FIG. 32 schematically shows how the imager attached to the agricultural machine captures an image of the ground surface.

FIG. 33 is a perspective view schematically showing the relationship among the vehicle coordinate system Σb, a camera coordinate system Σc and the world coordinate system Σw.

FIG. 34 is a plan view schematically showing a portion of a field in which a plurality of crop rows are provided on the ground surface.

FIG. 35 is a plan view schematically showing a state where the agricultural machine is steered to adjust the position and the orientation thereof so that the positional error thereof with respect to a target path is reduced.

FIG. 36 is a plan view schematically showing a portion of a field in which a plurality of curved crop rows are provided on the ground surface.

FIG. 37 is a flowchart showing an example operation of the processor.

FIG. 38 shows an image corresponding to a one-frame image, among the time-series color images acquired by the imager mounted on the agricultural machine.

FIG. 39 shows an enhanced image obtained as a result of the RGB values in the image shown in FIG. 38 being transformed into “2×g−r−b”.

FIG. 40 shows an example of the plan view image, as seen from above the ground, in which the pixels are classified into first pixels and second pixels.

FIG. 41 shows an example in which the plan view image is divided into a plurality of blocks.

FIG. 42 schematically shows an example of one block in the plan view image.

FIG. 43 schematically shows the relationship between the position of the scanning lines and the total value of the index values, obtained for the block shown in FIG. 42.

FIG. 44 shows an example in which the crop rows extend obliquely.

FIG. 45 schematically shows the relationship between the position of the scanning lines and the total value of the index values, obtained for the block of the plan view image shown in FIG. 44.

FIG. 46 shows an example of state where the direction of the scanning lines and the direction of the crop rows match each other.

FIG. 47 schematically shows the relationship between the position of the scanning lines and the total value of the index values, obtained for the block of the plan view image shown in FIG. 46.

FIG. 48 shows an example of distribution of the total values, which is created from one block in the plan view image shown in FIG. 41.

FIG. 49 shows an example of edge lines of the crop row extending in a curved manner.

FIG. 50 schematically shows an example of range of the scanning lines in each block.

FIG. 51 shows an example of approximation lines of the crop rows.

FIG. 52 is a perspective view schematically showing rows of ridges provided on the ground surface.

FIG. 53 is a flowchart showing another example operation of the processor.

FIG. 54 shows a one-frame image, among time-series images, acquired at time t by the imager mounted on the agricultural machine.

FIG. 55 schematically shows the correspondence of feature points between the image acquired from the imager at time t and the image acquired from the imager at time t+1.

FIG. 56 is a perspective view schematically showing a movement of a ridge and an intermediate region appearing in the images acquired by the imager.

FIG. 57 schematically shows the relationship between an amount of movement (L) of a point F1 on the ridge, corresponding to a feature point f1 on an image plane Im1 of the imager, and an amount of movement (L+dL) of a point F1p projected onto the reference plane Re.

FIG. 58 shows the relationship between the average value of the height of the feature points on each of the scanning lines parallel to the direction in which the ridges extend and the position of the scanning line.

FIG. 59 is a perspective view showing an example of external appearance of an agricultural machine.

FIG. 60 is a side view schematically showing an example of the agricultural machine in a state where an implement is attached thereto.

FIG. 61 is a block diagram showing an example configuration of the agricultural machine and the implement.

### DETAILED DESCRIPTION OF THE EXAMPLE EMBODIMENTS

Hereinafter, example embodiments of the present disclosure will be described. Note, however, that unnecessarily detailed descriptions may be omitted. For example, detailed descriptions on what is well known in the art or redundant descriptions on what is substantially the same configuration may be omitted. This is to avoid lengthy description and to facilitate the understanding of those skilled in the art. The accompanying drawings and the following description, which are provided by the present inventors so that those skilled in the art can sufficiently understand the present disclosure, are not intended to limit the scope of claims. In the following description, component elements having identical or similar functions are denoted by identical reference numerals.

The following example embodiments are only exemplary, and the techniques according to an example embodiment of the present disclosure are not limited to the ones in the following example embodiments. For example, numerical values, shapes, materials, steps, orders of steps, layout in a display screen, etc., that are indicated in the following example embodiments are only exemplary, and admit of various modifications so long as it makes technological sense. Any one implementation may be combined with another so long as it makes technological sense to do so.

As used in the present disclosure, an “agricultural machine” broadly includes any machine that performs basic tasks of agriculture, e.g., “tilling”, “planting”, “harvesting”, and “spraying drugs” in fields. An agricultural machine is a machine that has a functionality and structure to perform agricultural operations such as tilling, seeding, preventive pest control, manure spreading, planting of crops, or harvesting for the ground surface within a field. Such agricultural work, tasks, or operations may be referred to as “groundwork”, or simply as “work”, “tasks”, or “operations”. An agricultural machine does not need to include a traveling device moving the agricultural machine itself, and may travel by being attached to, or towed by, another vehicle including a traveling device. Not only does a work vehicle, such as a tractor, function as an “agricultural machine” by itself alone, but an implement that is attached to, or towed by, a work vehicle and the work vehicle may, as a whole, function as one “agricultural machine”. Examples of agricultural machines include tractors, vehicles for crop management, vegetable transplanters, mowers, agricultural drones, and field-moving robots.

### Example Embodiment 1

A row detection system according to example embodiment 1 of the present disclosure includes a plurality of imagers used while being attached to an agricultural machine, and a processor. The plurality of imagers are each secured to the agricultural machine so as to capture an image of a ground surface on which the agricultural machine performs groundwork and thus acquire an image including at least a portion of the ground surface. The images acquired by the plurality of imagers include overlapping regions. The processor is configured or programmed to generate a synthesized image based on the plurality of images generated by the plurality of imagers and detects a row region such as a crop row or a ridge from the synthesized image. The processor may be configured or programmed to determine a target path based on the detected row region and thus to output information on the target path to an automatic steering device of the agricultural machine. The automatic steering device is configured or programmed to perform steering control on the agricultural machine so that the agricultural machine moves along the target path. As a result, the agricultural machine is made movable along the crop row or the ridge. Hereinafter, an overview of a configuration and an operation of the row detection system will be described by way of an example in which the row detection device includes two imagers.

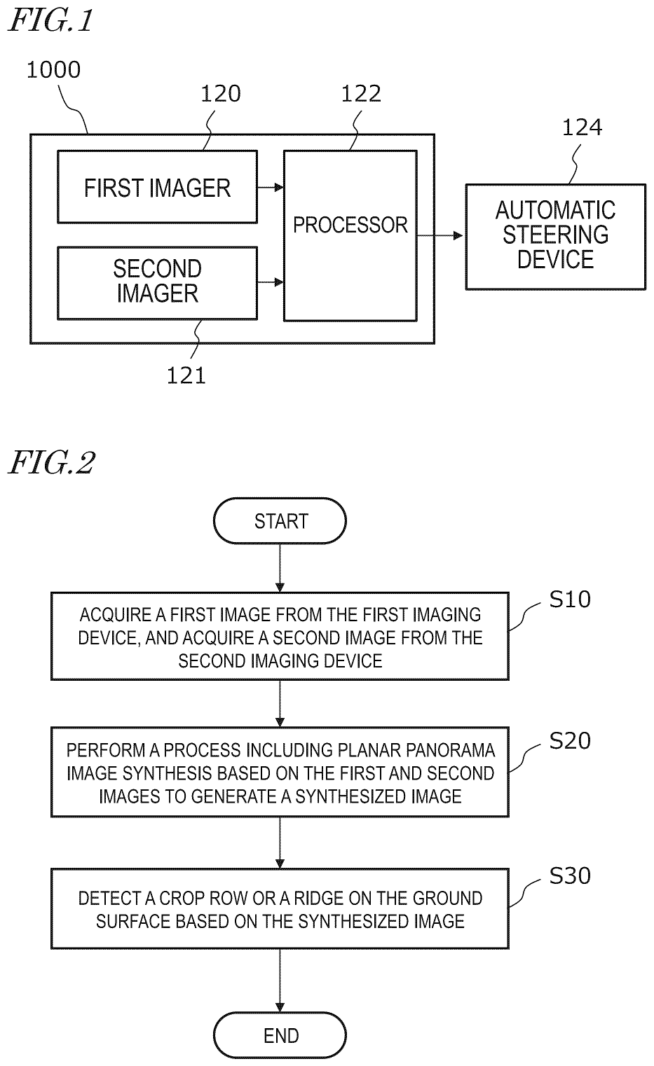

FIG. 1 is a block diagram showing a configuration of a row detection system 1000 according to an example embodiment of the present disclosure. The row detection system 1000 includes a first imager 120, a second imager 121, and a processor 122. The processor 122 may be connected to, for example, an automatic steering device 124 included in the agricultural machine. The first imager 120 and the second imager 121 are attached to the agricultural machine. The first imager 120 captures an image of the ground surface on which the agricultural machine performs groundwork to generate a first image of a first region of the ground surface. The second imager 121 captures an image of the ground surface to generate a second image of a second region of the ground surface partially overlapping the first region. The processor 122 is configured or programmed to execute image processing on the first image and the second image to detect a crop row or a ridge on the ground surface.

FIG. 2 is a flowchart showing an overview of an operation executed by the processor 122. The processor 122 executes operations of steps S10, S20 and S30 to detect the crop row or the ridge on the ground surface.

In step S10, the processor 122 acquires the first image from the first imager 120 and acquires the second image from the second imager 121. In step S20, the processor 122 executes a process including planar panorama image synthesis based on the first image and the second image to generate a synthesized image. In step S30, the processor 122 detects the crop row or the ridge on the ground surface based on the synthesized image.

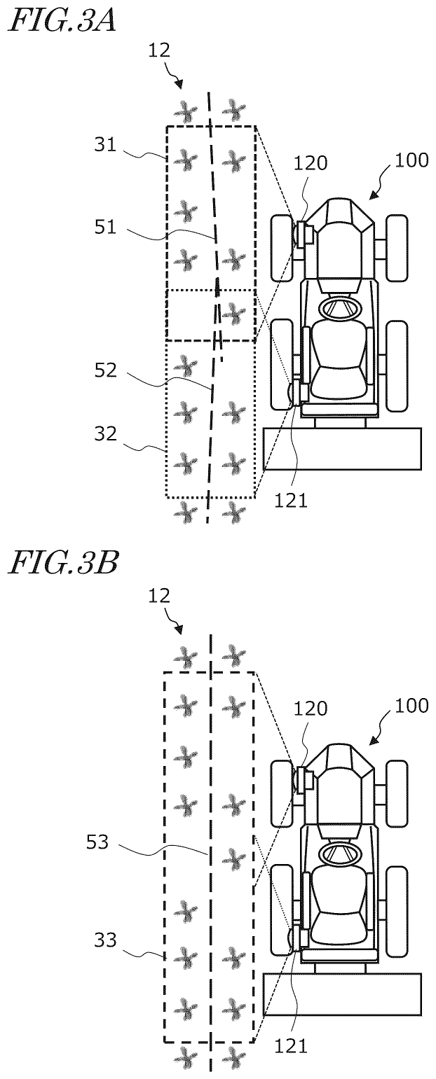

FIGS. 3A and 3B are provided to describe an operation of the row detection system 1000. FIGS. 3A and 3B each show an example of agricultural machine 100 traveling along a crop row 12. The agricultural machine 100 in this example is a work vehicle such as a tractor, a vehicle for crop management or the like. The agricultural machine 100 is not limited to the work vehicle, and may be, for example, a flying object such as an agricultural drone that performs work of, for example, spraying drugs or fertilizers while moving along a target path. The agricultural machine 100 is configured to travel along the crop row 12 and perform agricultural work such as, for example, planting of crops, seeding, manure spreading, preventive pest control, harvesting or tilling or the like. In the example shown in FIG. 3A, the agricultural machine 100 travels beside the crop row 12 by automatic steering. As described below, the agricultural machine 100 may travel while straddling the crop row 12.

FIG. 3A schematically shows how the first imager 120 and the second imager 121 attached to the agricultural machine 100 capture images of a portion of the crop row 12. The first imager 120 is attached to a first position on the agricultural machine 100. The second imager 121 is attached to a second position on the agricultural machine 100 rearward of the first position. In the example shown in FIGS. 3A and 3B, the first imager 120 is attached to a side surface of a portion frontward of the center of gravity of the agricultural machine 100, and the second imager 121 is attached to a side surface of a portion rearward of the center of gravity of the agricultural machine 100. The agricultural machine 100 may be configured to travel, by automatic steering, beside a region where the crop row 12 exists, along the crop row 12. The position and the orientation of each of the first imager 120 and the second imager 121 are not limited to those shown in the figures. As in another example described below, the first imager 120 and the second imager 121 may be provided in a bottom portion of the agricultural machine 100. Alternatively, the first imager 120 may be provided at a front end of the agricultural machine 100 whereas the second imager 121 may be provided at a rear end of the agricultural machine 100 or an implement. In such a configuration, the agricultural machine 100 may be configured to travel while straddling the crop row 12.

In the example shown in FIG. 3A, the first imager 120 is attached to the first position on the agricultural machine 100 while being directed obliquely downward so as to capture an image of a first region 31 including a first portion of the crop row 12. The first position is relatively close to the front end of the agricultural machine 100. The second imager 121 is attached to the second position on the agricultural machine 100 while being directed obliquely downward so as to capture an image of a second region 32 including a second portion of the crop row 12. The second position is relatively close to the rear end of the agricultural machine 100. Therefore, the second region 32 is shifted rearward with respect to the first region 31. The first region 31 and the second region 32 partially overlap each other. The first imager 120 captures an image of the first region 31 of the ground surface to generate the first image. The second imager 121 captures an image of the second region 32 of the ground surface to generate the second image. The first image and the second image may each be, for example, a color image. The crop row 12 is detectable based on a color distribution of such a color image. The first imager 120 and the second imager 121 may each be configured to generate time-series color images. For example, the first imager 120 and the second imager 121 may each be configured to generate time-series color images at a predetermined frame rate during travel of the agricultural machine 1000.

The processor 122 is configured or programmed to execute a process including planar panorama image synthesis based on the first image and the second image to generate the synthesized image. FIG. 3B shows an example of region 33 on the ground surface that appears in the synthesized image. The processor 122 may be configured or programmed, for example, to transform the first image into a first plan view image as seen from above the ground, to transform the second image into a second plan view image as seen from above the ground, and to synthesize the first plan view image and the second plan view image to generate the synthesized image. The first image and the second image are transformed into the first plan view image and the second plan view image by use of homography transformation (planar perspective projection) described below.

Upon generating the synthesized image, the processor 122 detects the crop row 12 based on the synthesized image. In the case where, for example, the first image and the second image are each a color image, the processor 122 generates, from the synthesized image, a synthesized enhanced image in which a color of the crop row (e.g., green color) is enhanced, and thus can detect the crop row 12 on the ground surface based on the synthesized enhanced image. A more detailed example of method for detecting the crop row 12 will described below.

After detecting the crop row 12, the processor 122 determines an approximation line (straight line or curved line) of the crop row 12, and determines a target path of the agricultural machine 100 along the approximation line. The processor 122 outputs information on the determined target path to the automatic steering device 124 of the agricultural machine 100. The automatic steering device 124 performs steering control on the agricultural machine 100 so that the agricultural machine 100 travels along the target path. As a result, the agricultural machine 100 is allowed to travel along the crop row 12.

As described above, according to the present example embodiment, the crop row 12 is detected based on the synthesized image of the first image generated by the first imager 120 and the second image generated by the second imager 121. The synthesized image includes information on an area broader than each of the first image and the second image. Therefore, the approximation line of the crop row 12 can be determined more accurately than in a case where the crop row 12 is detected based on only one of the first image and the second image. Especially in the case where the crop row 12 of seedling having a relatively small size is to be detected, a decrease in the detection precision due to missing plants can be reduced or prevented.

FIG. 3A shows, as examples, an approximation line 51 of the crop row 12 determined only based on the first image and an approximation line 52 of the crop row 12 determined only based on the second image. Due to the influence of the missing plants, both of the approximation line 51 and the approximation line 52 are shifted from the direction of the approximation line that should be determined for the crop row 12. Therefore, if a target path is set based on such an approximation line, the agricultural machine 100 may possibly tread on a portion of the crop row 12. By contrast, according to the present example embodiment, the approximation line of the crop row 12 is determined based on the synthesized image. Therefore, as shown in FIG. 3B, the approximation line of the crop row 12 can be determined to be an approximation line 53, which is more accurate.

In the above-described example, the processor 122 detects the crop row 12. The processor 122 may be configured or programmed to detect a ridge, instead of, or in addition to, the crop row 12. An example of method for detecting a ridge will be described below.

In the above-described example, the row detection system 1000 includes the two imagers 120 and 121. The row detection system 1000 may include three or more imagers. In the case where the crop row or the ridge is detected based on a synthesized image generated from three or more images acquired by such three or more imagers, the approximation line of the crop row or the ridge can be determined more accurately.

Now, a more specific example of the row detection system according to the present example embodiment will be described. In the present example embodiment, detection of a crop row is performed as the “row detection”.

As shown in FIG. 1, the row detection system 1000 according to the present example embodiment includes the first imager 120, the second imager 121 and the processor 122. The first imager 120 and the second imager 121 are each secured to the agricultural machine so as to acquire time-series color images including at least a portion of the ground surface.

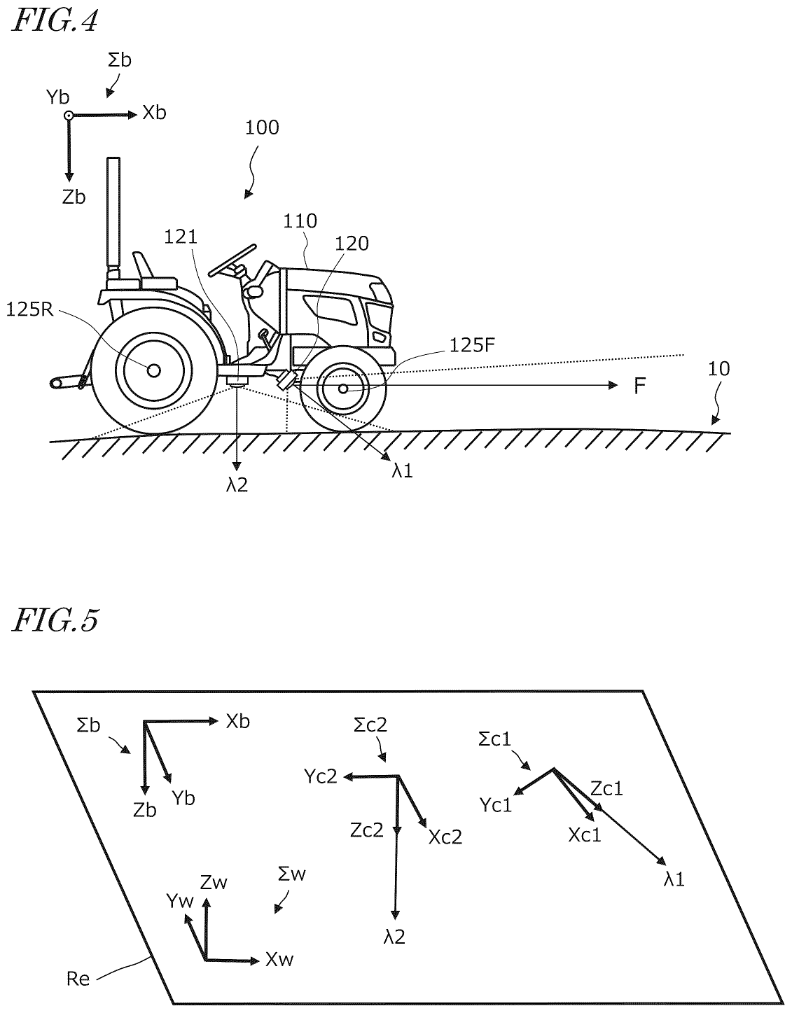

FIG. 4 schematically shows how the first imager 120 and the second imager 121 attached to the agricultural machine 100 each capture an image of a ground surface 10. In the example of FIG. 4, the agricultural machine 100 includes a vehicle body 110 capable of traveling. The first imager 120 and the second imager 121 are secured to the vehicle body 110. For referencing sake, FIG. 4 shows a vehicle coordinate system Σb having an Xb axis, a Yb axis, and a Zb axis that are orthogonal to one another. The vehicle coordinate system Σb is a coordinate system that is fixed to the agricultural machine 100. The origin of the vehicle coordinate system Σb may be set, for example, to the center of gravity or in the vicinity thereof of the agricultural machine 100. In FIG. 4, for ease of viewing, the origin of the vehicle coordinate system Σb is illustrated as lying external to the agricultural machine 100. In the vehicle coordinate system Σb according to an example embodiment of the present disclosure, the Xb axis coincides with a traveling direction (direction of arrow F) while the agricultural machine 100 is traveling straight. As viewed from the coordinate origin in a positive direction along the Xb axis, the Yb axis coincides with the directly right direction, and the Zb axis coincides with the vertically downward direction.

The first imager 120 and the second imager 121 are each, for example, an onboard camera that includes a CCD (Charge Coupled Device) or a CMOS (Complementary Metal Oxide Semiconductor) image sensor. The first and second imagers 120 and 121 according to the present example embodiment are each a monocular camera that is capable of capturing motion pictures at a frame rate of, for example, 3 frames/second (fps: frames per second) or above.

The image sensor in each of the imagers 120 and 121 includes a large number of photodetection cells that are arranged in rows and columns. Each of the photodetection cells corresponds to one of pixels included in an image, and includes an R subpixel to detect the intensity of red light, a G subpixel to detect the intensity of green light, and a B subpixel to detect the intensity of blue light. Optical outputs to be detected by the R subpixel, the G subpixel, and the B subpixel of each photodetection cell will be referred to as an R value, a G value and a B value, respectively. Hereinafter, the R value, the G value and the B value may be collectively referred to as “pixel values” or “RGB values”. By using the R value, the G value and the B value, it is possible to define a color based on coordinate values within an RGB color space.

FIG. 5 is a perspective view schematically showing the relationship among the aforementioned vehicle coordinate system Σb, a camera coordinate system Σc1 of the first imager 120, a camera coordinate system Σc2 of the second imager 121, and a world coordinate system Σw that is fixed to the ground surface 10. The camera coordinate system Σc1 of the first imager 120 has an Xc1 axis, a Yc1 axis, and a Zc1 axis that are orthogonal to one another. The camera coordinate system Σc2 of the second imager 121 has an Xc2 axis, a Yc2 axis, and a Zc2 axis that are orthogonal to one another. The world coordinate system Σw has an Xw axis, a Yw axis, and a Zw axis that are orthogonal to one another. In the example of FIG. 5, the Xw axis and the Yw axis of the world coordinate system Σw are on a reference plane Re that expands along the ground surface 10.

The first imager 120 is attached to the first position on the agricultural machine 100 so as to face in a first direction. The second imager 121 is attached to the second position, rearward of the first position, of the agricultural machine 100 so as to face in a second direction. Therefore, the position and orientation of each of the camera coordinate systems Σc1 and Σc2 with respect to the vehicle coordinate system Σb are fixed in a known state. The Zc1 axis of the camera coordinate system Σc1 of the first imager 120 is on a camera optical axis λ1 of the first imager 120. The Zc2 axis of the camera coordinate system Σc2 of the second imager 121 is on a camera optical axis λ2 of the second imager 121. The direction of the camera optical axis λ1 is the first direction, and the direction of the camera optical axis λ2 is the second direction. In the illustrated example, the camera optical axes λ1 and λ2 are inclined with respect to the traveling direction F of the agricultural machine 100 toward the ground surface 10, with an angle of depression that is greater than 0°. The traveling direction F of the agricultural machine 100 is generally parallel to the ground surface 10, along which the agricultural machine 100 travels. The angle of depression of the camera optical axis λ1 of the first imager 120 (i.e., an angle made by the traveling direction F and the camera optical axis λ1) may be set to a range of, for example, not less than 0° and not more than 90°. The angle of depression of the camera optical axis λ2 of the second imager 121 (i.e., an angle made by the traveling direction F and the camera optical axis λ2) may be set to a range of, for example, not less than 45° and not more than 135°. In the example shown in FIG. 4, the angle of depression of the camera optical axis λ1 of the first imager 120 is about 40°, and the angle of depression of the camera optical axis λ2 of the second imager 121 is about 90°. As in this example, the first imager 120 may be attached to the first position on the agricultural machine 100 so as to face in an obliquely forward and downward direction. The second imager 121 may be attached to the second position on the agricultural machine 100 so as to face in a downward direction. Herein, the expression “face in an obliquely forward and downward direction” refers to that the angle of depression of the camera optical axis is in a range of not less than 10° and not more than 80°, for example. The expression “face in a downward direction” refers to that the angle of depression of the camera optical axis is in a range of not less than 80° and not more than 100°, for example.

In the example shown in FIG. 4, the first imager 120 and the second imager 121 are both attached to a bottom portion of the vehicle body 110. The second imager 121 is attached rearward of the first imager 120. That is, in the vehicle coordinate system Σb, the coordinate value of the second imager 121 along the Xb axis is smaller than the coordinate value of the first imager 120 along the Xb axis. In the example shown in FIG. 4, the imagers 120 and 121 are both located at the center or in the vicinity thereof of the vehicle body 110 in a width direction (Yb direction) thereof. Each of the imagers 120 and 121 is not limited to being located in the bottom portion of the vehicle body 110, and may be attached to any other position, for example, in a side portion, in a front portion, or in a rear portion of the vehicle body 110. In the case where, as in the present example embodiment, the imagers 120 and 121 are provided in the bottom portion of the vehicle body 110, a crop row or a ridge below the agricultural machine 100 can be detected.

FIG. 4 shows an image capturing area of the first imager 120 and an image capturing area of the second imager 121 with dotted lines expanding radially. The image capturing area of each of the first imager 120 and the second imager 121 includes a portion, of the ground surface 10, that is below the agricultural machine 100. The image capturing area of each of the first imager 120 and the second imager 121 includes at least a portion of wheels of the agricultural machine 100. Like in the example shown in FIGS. 3A and 3B, the image capturing area of each of the first imager 120 and the second imager 121 may have a size that is longer in a front-rear direction than in a left-right direction of the agricultural machine 100. The image capturing area of the first imager 120 and the image capturing area of the second imager 121 partially overlap each other. Therefore, the first image generated by the first imager 120 and the second image generated by the second imager 121 have overlapping portions. In the present example embodiment, the image capturing area of the first imager 120 includes a portion, of the ground surface 10, that is right below the front axle 125F of the agricultural machine 100. By contrast, the image capturing area of the second imager 121 includes a portion, of the ground surface 10, that is right below the rear axle 125R of the agricultural machine 100. Therefore, the crop row or the ridge in the vicinity of front wheels and rear wheels can be detected at high precision.

While the agricultural machine 100 is traveling on the ground surface 10, the vehicle coordinate systems Σb and the camera coordinate systems Σc1 and Σb2 translate relative to the world coordinate system Σw. When the agricultural machine 100 rotates or swings in the direction of pitch, roll, or yaw during travel, the vehicle coordinate system Σb and the camera coordinate systems Σc rotate relative to the world coordinate system Σw. In the following description, for simplicity, it is assumed that the agricultural machine 100 does not rotate in the pitch or roll direction and that the agricultural machine 100 moves essentially parallel to the ground surface 10.

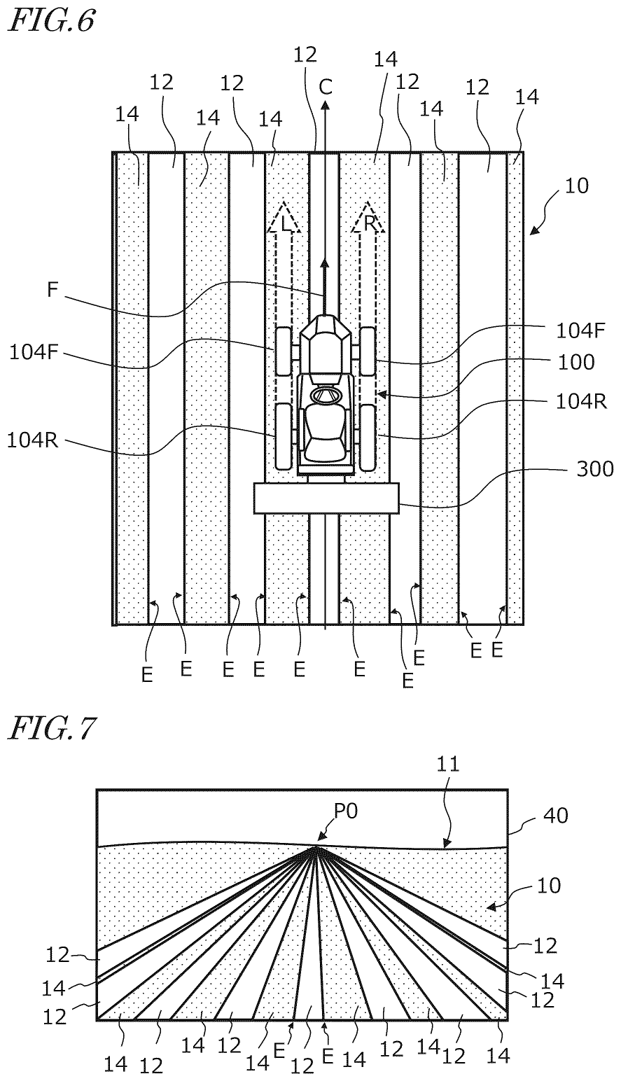

FIG. 6 is a plan view schematically showing a portion of a field in which a plurality of crop rows 12 are provided on the ground surface 10. The crop rows 12 are each a row that is formed by crops being continuously planted on the ground surface 10 of the field in one direction. For example, each crop row 12 may be an aggregation of crops that are planted in a ridge of the field. As described above, each crop row 12 is a row that is formed by an aggregation of crops planted in the field. Therefore, strictly describing, the shape of such a crop row may be complex depending on the shapes of crops and the positional arrangement of crops. The width of each crop row 12 changes as the crops grows. Between each two crop rows 12 adjacent to each other, a belt-shaped intermediate region 14, in which no crops have been planted, exists. Such intermediate regions 14 are each a region that is interposed between two edge lines E facing each other between two adjacent crop rows 12. In the case where a plurality of crops are planted for one ridge in a width direction of the ridge, a plurality of crop rows 12 are formed on the one ridge. In such a case, among the plurality of crop rows 12 that are formed on the ridge, an edge line E of the crop row 12 that is located at an end in the width direction of the ridge serves as a delineator of the intermediate region 14. In other words, the intermediate region 14 lies between the edge lines E of crop rows 12 that are located at ends of the ridge in the width direction, among the edge lines E of the plurality of crop rows 12. Since such an intermediate region 14 functions as a region (work path) along which the wheels of the agricultural machine 100 may pass, the “intermediate region” may be referred to as a “work path”.

In the present disclosure, an “edge line” of a crop row means a reference line segment (which may also include a curve) defining a target path for travel of an agricultural machine. Such reference line segments may be defined as both of two ends of a belt-like region (work path) along which the wheels of the agricultural machine are allowed to pass. A specific method for determining the “edge lines” of a crop row will be described below.

FIG. 6 schematically shows one agricultural machine 100 traveling in a field in which the crop rows 12 are formed. The agricultural machine 100 includes left and right front wheels 104F and left and right rear wheels 104R as traveling devices, and tows an implement 300. The front wheels 104F are wheels responsible for steering.

In the example shown in FIG. 6, thick broken-lined arrows L and R are respectively indicated for the work paths 14 that are located on opposite sides of one crop row 12 in the middle. While the agricultural machine 100 is traveling on a target path that is indicated by solid-lined arrow C, the front wheels 104F and the rear wheels 104R of the agricultural machine 100 are required to move on the work paths 14 along arrows L and R, so as not to step on the crop row 12. In the present example embodiment, the first and second imagers 120 and 121 attached to the agricultural machine 100 are usable to detect the edge lines E of the crop row 12. Therefore, it is possible to control the steering and the travel of the agricultural machine 100 so that the front wheels 104F and the rear wheels 104R move on the work paths 14 along arrows L and R. Controlling the steering and the travel of the agricultural machine 100 based on the edge lines E of the crop row 12 in this manner may be referred to as “row-following travel control”.

FIG. 7 schematically shows an example of image 40 acquired by the first imager 120 of the agricultural machine 100 shown in FIG. 6. For easer understanding, FIG. 7 does not show the front wheels 104F, of the agricultural machine 100, that may be included in the image 40. The plurality of crop rows 12 and the intermediate regions (work paths) 14 extending in parallel to each other on the ground surface 10 theoretically cross each other at a vanishing point P0 on a horizon 11. The vanishing point P0 is located in a central region of the image 40.

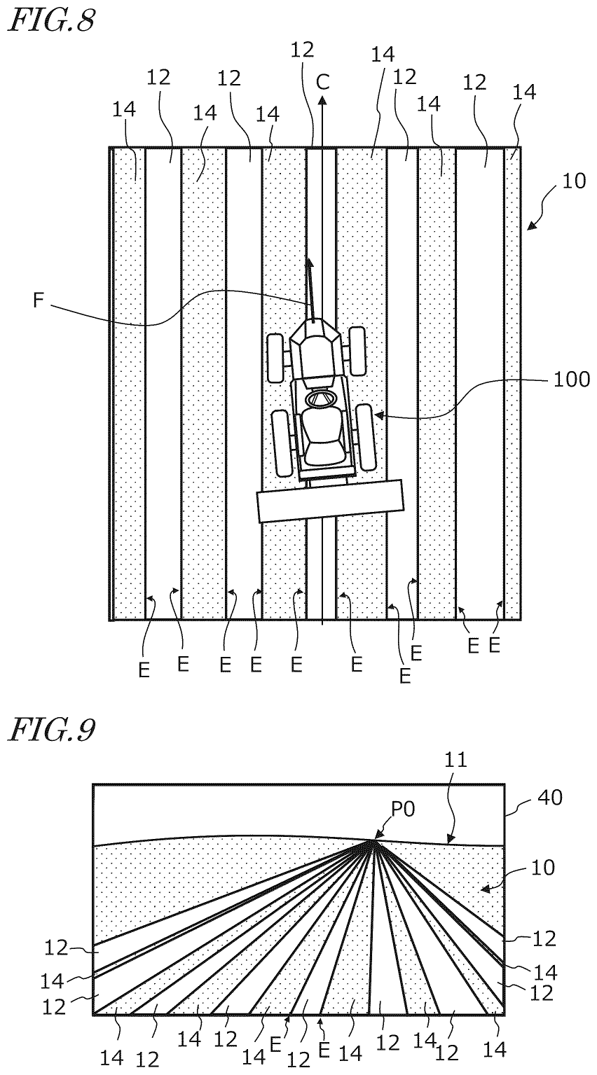

FIG. 8 is a plan view schematically showing a state where the traveling direction F of the agricultural machine 100 is inclined with respect to the direction in which the crop rows 12 extend. FIG. 9 schematically shows an example of the image 40 acquired by the first imager 120 of the agricultural machine 100 shown in FIG. 8. In the case where the traveling direction F of the agricultural machine 100 is inclined with respect to the direction in which the crop rows 12 extend (direction parallel to arrow C), the vanishing point P0 is located in a right or left region of the image 40. In the example shown in FIG. 9, the vanishing point P0 is located in the right region of the image 40.

The agricultural machine 100 includes the row detection system 1000 and the automatic steering device 124 shown in FIG. 1. The processor 122 in the row detection system 1000 executes a process including panorama image synthesis based on the first image generated by the first imager 120 and the second image generated by the second imager 121 to generate a synthesized image. The processor 122 detects the crop row 12 included in the synthesized image and linearly approximates the detected crop row 12 to determine an approximation line. The processor 122 determines a target path of the agricultural machine 100 along the approximation line. The automatic steering device 124 performs steering control so that the agricultural machine 100 travels along the target path.

The automatic steering device 124 performs the steering control on the agricultural machine 100 so as to reduce a positional deviation and a directional deviation of the agricultural machine 100 with respect to the target path (arrow C shown in FIG. 8). As a result, the agricultural machine 100 in the state shown in, for example, FIG. 8 has the position and the orientation (angle in the yaw direction) thereof adjusted, and thus becomes closer to the state shown in FIG. 6. The left and right wheels of the agricultural machine 100 in the state of FIG. 6 are respectively located on lines indicated by arrows L and R on the work paths 14. While the agricultural machine 100 is traveling along the target path indicated by central arrow C, the automatic steering device 124 of the agricultural machine 100 controls the steering angles of the wheels responsible for steering so that neither the front wheels 104F nor the rear wheels 104R deviate from the work paths 14.

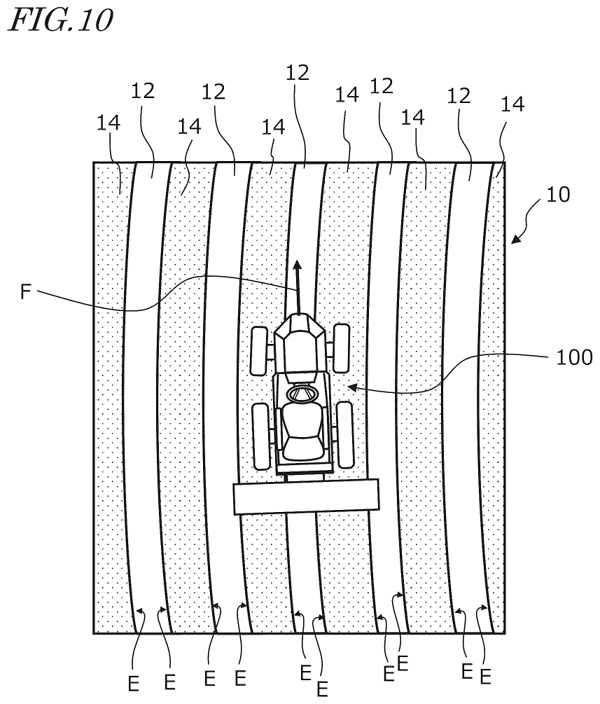

FIG. 10 is a plan view schematically showing a portion of a field in which a plurality of curved crop rows 12 are provided on the ground surface 10. According to an example embodiment of the present disclosure, even in a field in which such curved crop rows 12 are formed, it is made possible to accurately detect the positions of the crop rows 12 from two images acquired by the two imagers 120 and 121 and to precisely control the steering and the travel of the agricultural machine 100 along the crop rows 12.

Now, a configuration and an operation of the processor 122 in the row detection system 1000 will be described in more detail.

The processor 122 according to the present example embodiment executes image processing on time-series color images acquired by the imagers 120 and 121. The processor 122 is connected to the automatic steering device 124 included in the agricultural machine 100. The automatic steering device 124 may included in, for example, a controller configured or programmed to control the travel of the agricultural machine 100.

The processor 122 may be implemented by an electronic control unit (ECU) for image recognition. The ECU is an onboard computer. The processor 122 is connected to the imagers 120 and 121 via serial signal lines, e.g., wire harnesses or the like, so as to receive image data that is output from the imagers 120 and 121. A portion of the image recognition processing to be executed by the processor 122 may be executed inside each of the imagers 120 and 121 (inside each of camera modules).

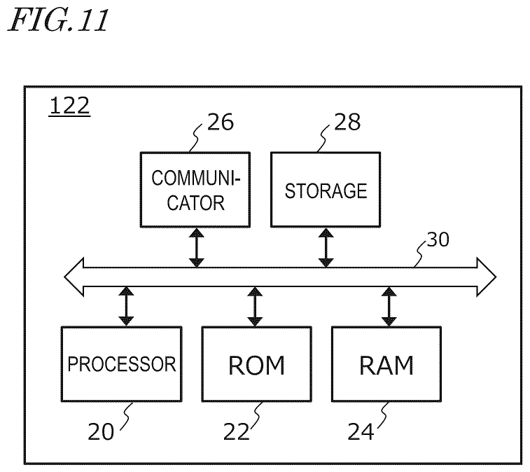

FIG. 11 is a block diagram showing an example hardware configuration of the processor 122. The processor 122 includes a processor 20, a ROM (Read Only Memory) 22, a RAM (Random Access Memory) 24, a communicator 26, and a storage 28. These component elements are connected to one another via buses 30.

The processor 20 is a semiconductor integrated circuit, and is referred to also as a central processing unit (CPU) or a microprocessor. The processor 20 may include an image processing unit (GPU). The processor 20 consecutively executes a computer program describing a group of predetermined instructions stored on the ROM 22 to realize processing that is needed for the row detection according to an example embodiment of the present disclosure. A portion of or an entirety of the processor 20 may be an FPGA (Field Programmable Gate Array), an ASIC (Application Specific Integrated Circuit), or an ASSP (Application Specific Standard Product) each having a CPU mounted thereon.

The communicator 26 is an interface configured or programmed to perform data communication between the processor 122 and an external computer. The communicator 26 can perform wired communication based on a CAN (Controller Area Network) or the like, or wireless communication complying with the Bluetooth (registered trademark) protocols and/or the Wi-Fi (registered trademark) standards.

The storage 28 can store data on images acquired from the imager 120 or images which are under processing. Examples of the storage 28 include a hard disc drive and a non-volatile semiconductor memory.

The hardware configuration of the processor 122 is not limited to the one described in the above example. It is not required that a portion of or an entirety of the processor 122 is mounted on the agricultural machine 100. By utilizing the communicator 26, one or more computers located outside the agricultural machine 100 may be allowed to function as a portion of or an entirety of the processor 122. For example, a server computer that is connected to a network may function as a portion of or an entirety of the processor 122. By contrast, a computer mounted on the agricultural machine 100 may perform all the functions that are required of the processor 122.

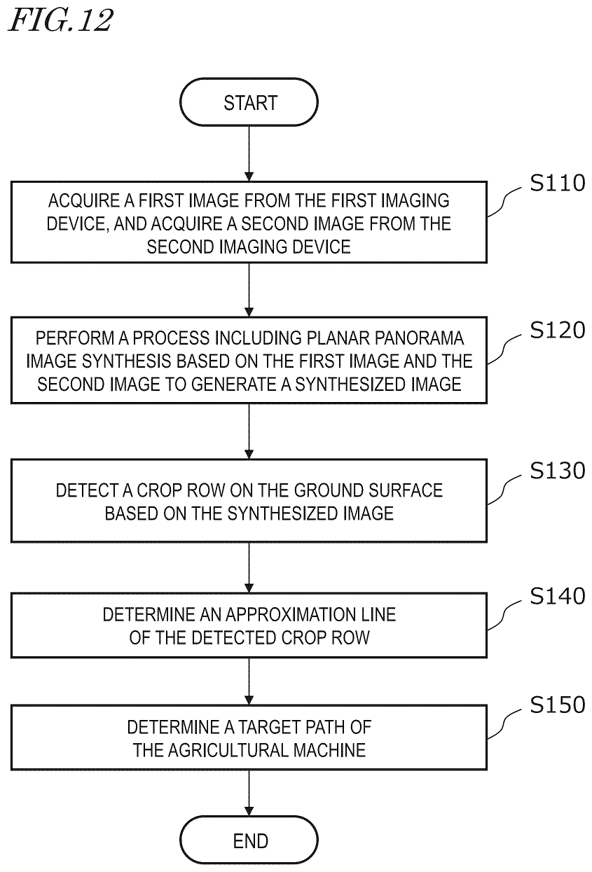

FIG. 12 is a flowchart showing an example operation of the processor 122 according to the present example embodiment. The processor 122 executes operations of steps S110 through S150 shown in FIG. 12 to detect a crop row on the ground surface and determine a target path of the agricultural machine 100 along the crop row.

In step S110, the processor 122 acquires the first image from the first imager 120 and acquires the second image from the second imager 121. The first image and the second image according to the present example embodiment each include time-series color images. The time-series color images form an aggregation of images that are chronologically generated by the imagers 120 and 121 through image capturing. Each of the images is formed of a frame-by-frame group of pixels. For example, in the case where the imagers 120 and 121 each output images at a frame rate of 30 frames/second, the processor 122 can acquire new images with a period of about 33 milliseconds. As compared with a common automobile that travels on public roads, the agricultural machine 100, such as a tractor or the like, travels in a field at a speed which is relatively low, e.g., about 10 kilometers per hour or lower. In the case where the speed is 10 kilometers per hour, a distance of about 6 centimeters is travelled in about 33 milliseconds, for example. Therefore, the processor 122 may acquire images with a period of, for example, about 100 to 300 milliseconds, and does not need to process all the frames of images captured by the imagers 120 and 121. The period with which the images to be processed by the processor 122 are acquired may be automatically changed by the processor 122 in accordance with the traveling speed of the agricultural machine 100.

In step S120, the processor 122 executes a process including planar panorama image synthesis based on the first image and the second image captured at substantially the same time to generate a synthesized image. The planar panorama image synthesis may include, for example, a process of performing homography transformation on the first image and the second image to generate a first plan view image and a second plan view image, and a process of synthesizing the first plan view image and the second plan view image. Hereinafter, an example of process of the planar panorama image synthesis will be described.

A plan view image is an overhead-view image as seen from right above a reference plane, which is parallel to the ground surface, in a direction normal to the reference plane. The overhead-view image can be generated by homography transformation of the first image and the second image. Homography transformation is a type of geometrical transformation, and allows a point on a given plane in a three-dimensional space to be transformed into a point on another optional plane. Hereinafter, an example of process of transforming the first image acquired by the first imager 120 into the first plan view image will be described. A process of transforming the second image acquired by the second imager 121 into the second plan view image is executed by substantially the same method.

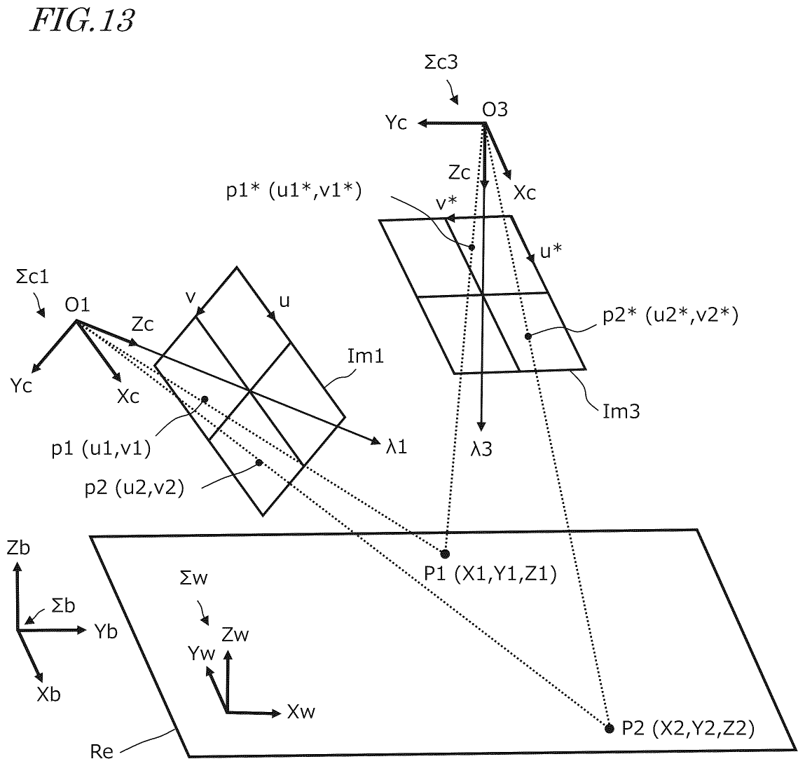

FIG. 13 is a perspective view schematically showing positions of each of the camera coordinate system Σc1 of the imager 120 at a first pose (position and orientation) and a camera coordinate system Σc3 of an imaginary imager at a second pose, with respect to the reference plane Re. FIG. 13 also shows the vehicle coordinate system Σb. In the example shown in FIG. 13, the camera coordinate system Σc1 is inclined so that a Ze axis thereof obliquely crosses the reference plane Re. By contrast, the camera coordinate system Σc3 has a Zc axis thereof orthogonal to the reference plane Re. In the case where the agricultural machine 100 does not rotate in the pitch direction or the roll direction, a plane including the Xb axis and the Yb axis of the vehicle coordinate system Σb (hereinafter, referred to as a “vehicle coordinate system plane”) is parallel to the reference plane Re. In this case, the Zc axis of the camera coordinate system Σc3 is also orthogonal to the vehicle coordinate system plane. That is, the camera coordinate system Σc3 is located so that an overhead-view image as seen from right above the reference plane Re and the vehicle coordinate system plane along a direction normal thereto can be acquired.

At a position that is distant from the origin O1 of the camera coordinate system Σc1 by the focal length of the camera in the direction of the Zc axis, an imaginary image plane Im1 exists. The image plane Im1 is orthogonal to the Zc axis and the camera optical axis λ1. A pixel position on the image plane Im1 is defined by an image coordinate system having a u axis and a v axis that are orthogonal to each other. For example, it is assumed that a point P1 and a point P2 located on the reference plane Re have coordinates (X1,Y1,Z1) and (X2,Y2,Z2) respectively in the world coordinate system Σw. In the example of FIG. 13, the Xw axis and the Yw axis of the world coordinate system Σw are on the reference plane Re. Therefore, Z1=Z2=0. The reference plane Re is set so as to expand along the ground surface.

Through perspective projection based on a pinhole camera model, the point P1 and the point P2 on the reference plane Re are transformed, respectively, into a point p1 and a point p2 on the image plane Im1 of the imager 120 at the first pose. On the image plane Im1, the point p1 and the point p2 are at pixel positions indicated by coordinates (u1,v1) and (u2,v2), respectively.

In the case where it is assumed that the imager is at the second pose, an imaginary image plane Im3 exists at a position that is distant from the origin O3 of the camera coordinate system Σc3 by the focal length of the camera in the direction of the Zc axis. In this example, the image plane Im3 is parallel to the reference plane Re and the vehicle coordinate system plane. A pixel position on the image plane Im3 is defined by the image coordinate system having a u′ axis and a v′ axis that are orthogonal to each other. This image coordinate system moves together with the vehicle coordinate system Σb with respect to the world coordinate system Σw. Therefore, the pixel position on the image plane Im3 may also be defined by the vehicle coordinate system Σb. The point P1 and the point P2 on the reference plane Re are transformed, respectively, into a point p1* and a point p2′ on the image plane Im3 through perspective projection. On the image plane Im3, the point p1′ and point p2* are at pixel positions indicated by coordinates (u1*,v1′) and (u2, v2*), respectively.

Once the relative positions of the camera coordinate systems Σc1 and Σc3 with respect to the reference plane Re in the world coordinate system Σw are given, from a given point (u,v) on the image plane Im1, a point (u′,v′) corresponding thereto on the image plane Im3 can be determined through homography transformation. In the case where the point coordinates are expressed by a homogeneous coordinate system, such homography transformation is defined by a transformation matrix H of 3 rows×3 columns.

$$( \begin{matrix}u * \\ v * \\ 1\end{matrix} ) = H ( \begin{matrix}u \\ v \\ 1\end{matrix} ) \qquad [ eq . 1 ]$$

The contents of the transformation matrix H are defined by numerical values of h₁₁, h₁₂, . . . , h₃₂, as indicated below.

$$( \begin{matrix}u * \\ v * \\ 1\end{matrix} ) = ( \begin{matrix}h 11 & h 12 & h 13 \\ h 21 & h 22 & h 23 \\ h 31 & h 32 & 1\end{matrix} ) ( \begin{matrix}u \\ v \\ 1\end{matrix} ) \qquad [ eq . 2 ]$$

The eight numerical values (h₁₁, h₁₂, . . . , h₃₂) can be calculated by a known algorithm once an image of a calibration board that is placed on the reference plane Re is captured by the imager 120 attached to the agricultural machine 100.

In the case where a point on the reference plane Re has coordinates (X,Y,0), the coordinates of the corresponding points on the camera image planes Im1 and Im3 are associated with the point (X,Y,0) by respective homography transformation matrices H1 and H2, as indicated by equation 3 and equation 4 below.

$$( \begin{matrix}u \\ v \\ 1\end{matrix} ) = H 1 ( \begin{matrix}X \\ Y \\ 1\end{matrix} ) \qquad [ eq . 3 ]$$

$$( \begin{matrix}u * \\ v * \\ 1\end{matrix} ) = H 2 ( \begin{matrix}X \\ Y \\ 1\end{matrix} ) \qquad [ eq . 4 ]$$

From the above two equations, the following equation is derived. As is clear from this equation, the transformation matrix H is equal to H2H1⁻¹. H1⁻¹ is an inverse of H1.

$$( \begin{matrix}u * \\ v * \\ 1\end{matrix} ) = H 2 H {1}^{- 1} ( \begin{matrix}u \\ v \\ 1\end{matrix} ) \qquad [ eq . 5 ]$$

The contents of the transformation matrices H1 and H2 depend on the reference plane Re. Therefore, when the position of the reference plane Re changes, the contents of the transformation matrix H also change.

By utilizing such homography transformation, a plan view image of the ground surface can be generated from an image of the ground surface acquired by the imager 120 at the first pose. In other words, through the homography transformation, coordinates of a given point on the image plane Im1 of the imager 120 can be transformed into coordinates of a point that is on the image plane Im3 of the imaginary imager at a predetermined pose with respect to the reference plane Re.

After calculating the contents of the transformation matrix H, the processor 122 executes a software program based on the aforementioned algorithm to generate, from the time-series images output from the imager 120, an overhead-view image of the ground surface 10 as seen from above the ground 10. Before the processing of generating the overhead-view image, pre-processing such as white balancing, noise reduction or the like may be applied to the time-series images.

In the above description, it is assumed that the points in the three-dimensional space (e.g., P1, P2) are all located on the reference plane Re (e.g., Z1=Z2-0). In the case where the height of a crop with respect to the reference plane Re is non-zero, in the post-homography transformation plan view image, the positions of points respectively corresponding to the points on the reference plane Re are shifted from proper positions thereof. In order to suppress an increase in the amount of shift, it is desirable that the height of the reference plane Re is close to the height of the crop as a target of detection. On the ground surface 10, bumps and dents, e.g., ridges, furrows, trenches or the like, may exist. In such a case, the reference plane Re may be offset upward from the bottoms of such bumps and dents. The offset distance may be appropriately set depending on the bumps and dents of the ground surface 10 on which crops are planted.

When the vehicle body 110 (see FIG. 4) makes a motion of roll or pitch while the agricultural machine 100 is traveling on the ground surface 10, the pose of the imager 120 is changed. Therefore, the contents of the transformation matrix H1 may change. In such a case, the rotation angle of the roll and the pitch of the vehicle body 110 can be measured by an inertial measurement unit (IMU), so that the transformation matrix H1 and the transformation matrix H are corrected in accordance with the change in the pose of the imager 120.

The processor 122 can transform the second image acquired by the second imager 121 into the second plan view image by a method substantially the same as the method for transforming the first image acquired by the first imager 120 into the first plan view image. The first plan view image and the second plan view image are each generated as an image on the imaginary image plane Im3. The first plan view image and the second plan view image may be represented by an xb coordinate and a yb coordinate in the vehicle coordinate system Σb. As shown in FIG. 4, the image capturing area of the first imager 120 and the image capturing area of the second imager 121 partially overlap each other. Therefore, the first plan view image and the second plan view image include overlapping areas.

Upon generating the first plan view image and the second plan view image, the processor 122 synthesizes these images to generate a synthesized image. For example, the processor 122 generates the synthesized image by a synthesis process including a process of determining a weighted average of a pixel value of each of pixels in a first overlapping region and a pixel value of each of pixels in a second overlapping region respectively corresponding to the each of the pixels in the first overlapping region, the weighted average being determined in accordance with the position of each of the pixels. The first overlapping region is a region of the first plan view image that overlaps the second plan view image. The second overlapping region is a region of in the second plan view image that overlaps the first plan view image.

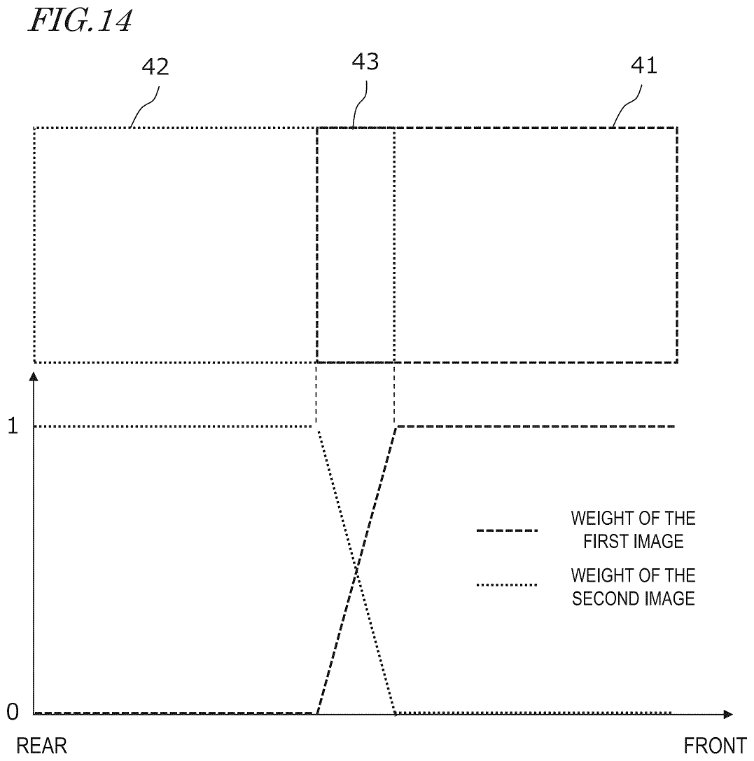

FIG. 14 is a view provided to describe the synthesis process performed on the first plan view image and the second plan view image. In FIG. 14, a region of a first plan view image 41 is represented with a broken line, and a region of a second plan view image 42 is represented with a dotted line. The first plan view image 41 and the second plan view image 42 include an overlapping region 43. The pixel value of each of the pixels in the synthesized image may be determined by a weighted average determined as follows: the pixel value in the first plan view image 41 is multiplied by a first weight, and the pixel value in the second plan view image 42 is multiplied by a second weight, and then the two products are added together. In the example of FIG. 14, the first weight is 0 in a region of the second plan view image 42 excluding the overlapping region 43. In the overlapping region 43, the first weight linearly increases from 0 to 1 in a forward direction of the vehicle (rightward in FIG. 14). In a region of the first plan view image 41 excluding the overlapping region 43, the first weight is 1. By contrast, the second weight is 1 in the region of the second plan view image 42 excluding the overlapping region 43. In the overlapping region 43, the second weight linearly decreases from 1 to 0 in the forward direction of the vehicle. In the region of the first plan view image 41 excluding the overlapping region 43, the second weight is 0. The processor 122 may be configured or programmed to, in this manner, perform a weighted average process on the pixel value of each pixel in the overlapping region 43 in the first plan view image 41 and the pixel value of each corresponding pixel in the overlapping region 43 in the second plan view image 42 so that the weight of the pixel value in the first plan view image 41 increases in the forward direction of the vehicle and so that the weight of the pixel value in the second plan view image 42 increases in a rearward direction of the vehicle. With such a process, the pixel values in the overlapping region in the synthesized image can be appropriately determined, and thus a preferred synthesized image can be generated. The method for determining the pixel values in the overlapping region in the synthesized image is not limited to the one described in the above example. For example, the weight of each image in the overlapping region may be increased or decreased in a cubic function manner instead of linearly (in a linear function manner). Even in such a case, the weight of each image value in the overlapping region may be determined so as to monotonously increase or decrease in a direction corresponding to the forward direction of the vehicle.

The process of the planar panorama image synthesis based on the first image and the second image is not limited to the one described in the above example, and any of various algorithms is usable to generate a synthesized image.

In the case where the imagers 120 and 121 are provided relatively close to the ground surface 10 as shown in FIG. 4, the imagers 120 and 121 may each be a camera generating a wide-angle image such as, for example, a fisheye camera or the like. Even in the case where the image is largely distorted, the internal parameters of the camera can be appropriately set, so that the image acquired by image capturing is transformed into a plan view image.

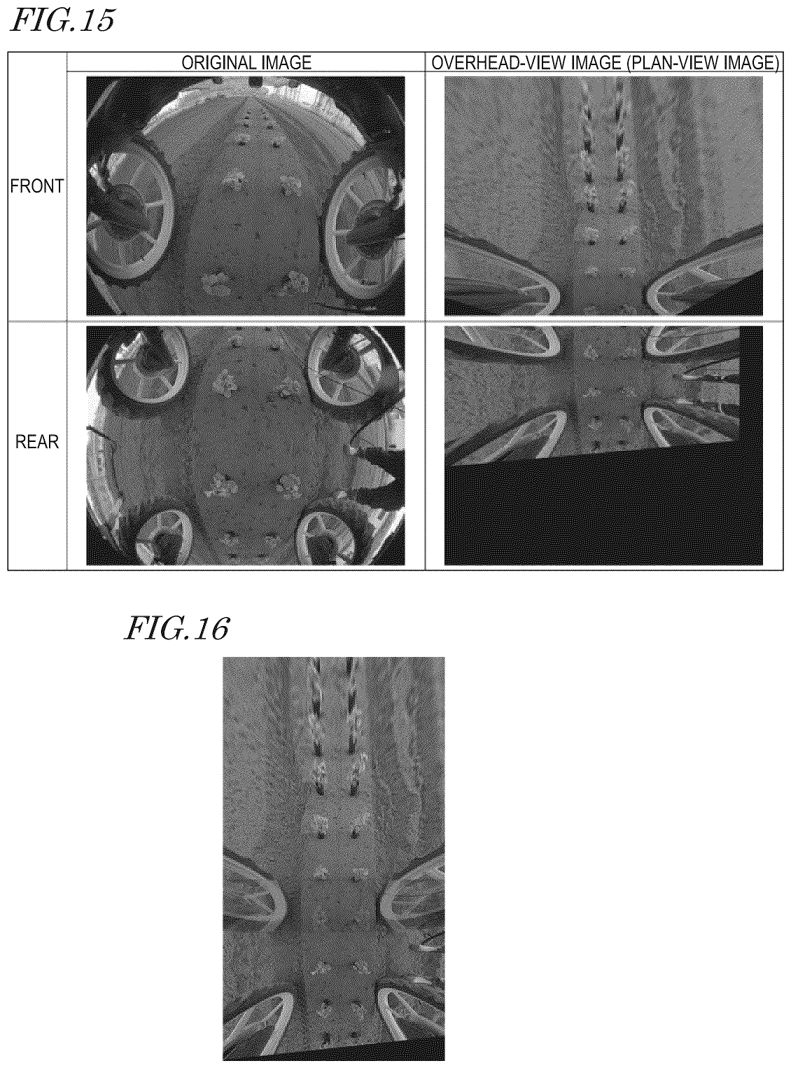

FIG. 15 shows an example of the first image, the second image, the first plan view image and the second plan view image. In FIG. 15, the top left area shows the first image, the bottom left area shows the second image, the top right area shows the first plan view image, and the bottom right area shows the second plan view image. In this example, the first image shows the front wheels of the agricultural machine 100 and a region of the ground surface that is between the front wheels. The second image shows the front wheels and the rear wheels of the agricultural machine 100 and a region of the ground surface that is between the front wheels and the rear wheels. The processor 122 transforms the first image and the second image respectively into the first plan view image and the second plan view image shown in the right areas of FIG. 15. A bottom portion of the first plan view image and a top portion of the second plan view image include a common subject (front wheels, and the ground surface and the crops between the front wheels). This portion corresponds to the overlapping region. The processor 122 interpolates pixel values into the overlapping region based on the first plan view image and the second plan view image by the above-described synthesis process to generate a synthesized image.

FIG. 16 shows an example of the synthesized image generated in the example of FIG. 15. In this example, the above-described weighted average process is applied to the overlapping region corresponding to the bottom portion of the first plan view image and the top portion of the second plan view image. As a result, a synthesized image that is more natural in terms of the shape and the color of the crops in the overlapping region is generated. The crop row can be detected based on such a synthesized image, so that the detection precision is improved as compared with a case where the crop row is detected based on a single image. For example, even in the case where there is a missing plant, the approximation line of the crop row can be calculated more accurately.

Now, an example of calibration operation of determining the transformation matrix used for the planar panorama image synthesis process, by which a synthesized image is generated from the first image and the second image, will be described. The calibration is performed based on two images acquired by the imagers 120 and 121 capturing images of a specific subject on the ground surface. The calibration may be performed before the use of the agricultural machine 100 is started, or when the position or the orientation of the imager 120 or 121 is shifted from the initial state. In the calibration, the processor 122 executes the following operations S1, S2 and S3.
(S1) Acquires a first reference image generated by the first imager 120 capturing an image of the specific subject on the ground surface, and acquires a second reference image generated by the second imager 121 capturing an image of the subject.
(S2) Extracts a plurality of feature points of the subject from each of the first reference image and the second reference image.
(S3) Generates or updates the transformation matrix usable for the planar panorama image synthesis based on the relationship between the positions of the plurality of feature points in the first reference image and the positions of the plurality of corresponding feature points in the second reference image.

The specific subject to be used for the calibration may be, for example, a board on which a characteristic pattern usable as an AR (Augmented Reality) marker is drawn. Alternatively, the specific subject may be the wheels of the agricultural machine 100. In the following description, the specific subject to be used for the calibration will be referred to as a “calibration subject”.

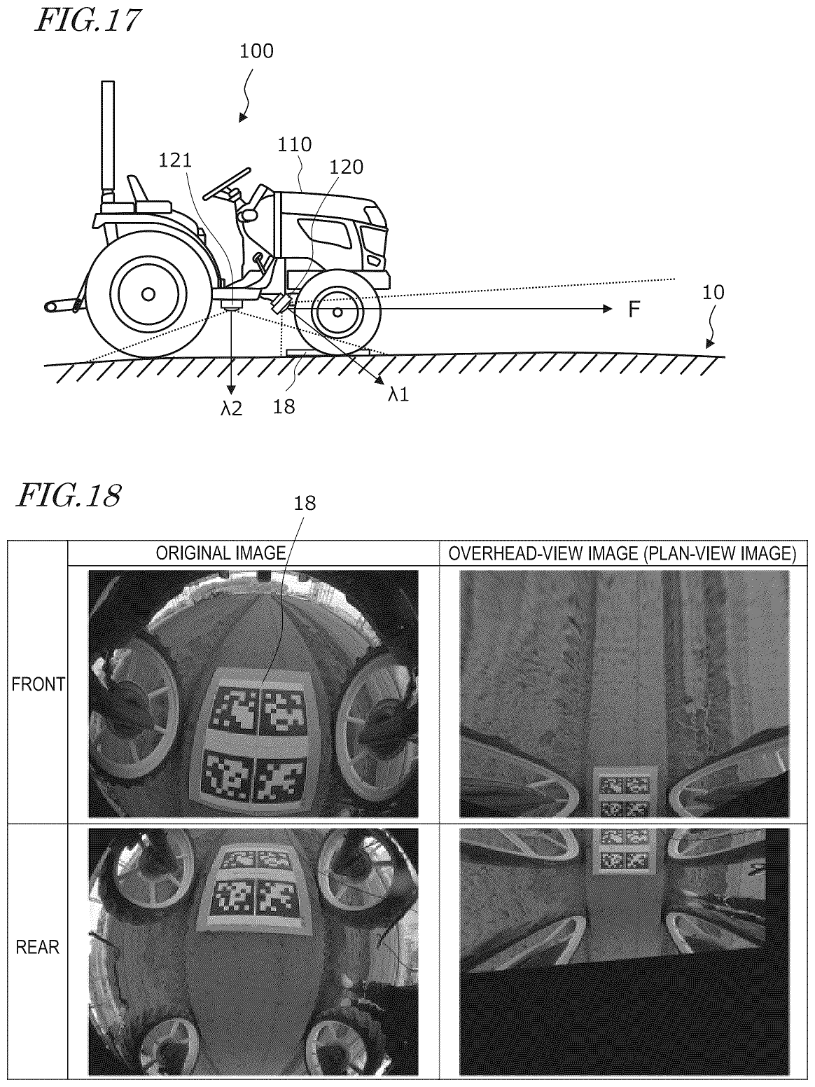

FIG. 17 shows an example of state where an image of a calibration subject 18 placed on the ground surface 10 is captured by the imagers 120 and 121. In this example, the calibration subject 18 is a board on which a plurality of marks each having a characteristic pattern are drawn, and is placed between the two front wheels of the agricultural machine 100. In a state where the agricultural machine 100 is at a pause, the first imager 120 and the second imager 121 capture the ground surface on which the calibration subject 18 is placed, and thus respectively generate the first reference image and the second reference image.

FIG. 18 shows an example of images acquired by image capturing of the calibration subject 18. The first imager 120 captures an image of the calibration subject 18 to generate the first reference image shown in the top left area of FIG. 18. The second imager 121 captures an image of the calibration subject 18 to generate the second reference image shown in the bottom left area of FIG. 18. The processor 122 detects a plurality of feature points (e.g., four corners of the board, corners of each of four marks, etc.) in the calibration subject 18 from the first reference image and the second reference image, and calculates the transformation matrix based on the positions of the plurality of feature points.

The top right area of FIG. 18 shows an example of plan view image obtained as a result of the transformation of the first reference image. The bottom right area of FIG. 18 shows an example of plan view-image obtained as a result of the transformation of the second reference image. The processor 122 stacks the plurality of feature points of the calibration subject 18 in these plan view images to determine a range corresponding to the overlapping region, and records information regarding the range on the storage. Subsequent synthesis processes are executed based on the recorded information.

FIG. 12 is referred to again. In step S130, the processor 122 detects the crop row on the ground surface based on the synthesized image. For example, the processor 122 generates, from the synthesized image, a synthesized enhanced image in which the color of the crop row (e.g., green) is enhanced, and thus can detect the edge lines of the crop row on the ground surface based on the synthesized enhanced image.

In step S140, the processor 122 determines an approximation line of the detected crop row. For example, the processor 122 determines a line passing the center between the edge lines at both of two ends of the detected crop row as the approximation line.

In step S150, the processor 122 determines a target path of the agricultural machine 100 along the approximation line, on the vehicle coordinate system. The target path may be determined so as to, for example, overlap the approximation line of the crop row. Note that in the configuration, as in the examples shown in FIGS. 3A and 3B, in which the imagers 120 and 121 are provided in a side portion of the agricultural machine 100, the target path may be set to be parallel to the approximation line of the crop row or the ridge at a position away from the approximation line by a predetermined distance. The processor 122 outputs information on the determined target path to the automatic steering device 124 of the agricultural machine 100. The automatic steering device 124 performs the steering control on the agricultural machine 100 so that the agricultural machine 100 travels along the target path.

Now, a specific example of method for detecting the crop row in step S130 will be described. Upon generating the synthesized image, the processor 122 can execute the following operations S11, S12 and S13 to detect the crop row from the synthesized image.
(S11) Generates, from the synthesized image, a synthesized enhanced image in which the color of the crop row as a target of detection is enhanced.
(S12) Generates, from the synthesized enhance image, a binary image, in which the pixels are classified into first pixels each having a color index value of the crop row that is equal to, or higher than, a threshold value, and second pixels each having a color index value of the crop row that is lower than the threshold value.
(S13) Determines the positions of the edge lines of the crop row based on the index values of the first pixels.

Hereinafter, specific example of the operations S11, S12 and S13 will be described.

The synthesized image shown in FIG. 16 shows rows of crops (crop rows) planted in rows on the ground surface of a field. In this example, the crop rows are arranged generally parallel to each other and at substantially equal intervals on the ground surface.

In the operation S11, the processor 122 generates a synthesized enhanced image in which the color of the crops as the target of detection is enhanced, based on the synthesized image. The crops receives sunlight (white light) to perform photosynthesis, and therefore, contains chlorophyll. Chlorophyll has a lower absorptivity for green than for red or blue. Therefore, the spectrum of the sunlight reflected by the crops exhibits a higher value in a wavelength range of green than the spectrum of the sunlight reflected by the soil surface. As a result, the color of the crops generally includes a large amount of green components, and the “color of the crops” is typically green. However, as described below, the “color of the crops” is not limited to green.

In the case where the color of the crops as the target of detection is green, the enhanced image in which the color of the crops is enhanced is an image obtained as a result of the RGB values of each of pixels in the color image being transformed into pixel values having a relatively high ratio of the G value. Such transformation of the pixel values, which is performed to generate an enhanced image, is defined by, for example, “(2×G value-R value-B value)/(R value+G value+B value)”. Herein, (R value+G value+B value), which is the denominator, is a factor for normalization. Hereinafter, the normalized RGB values will be referred to as “rgb values”, and r, g and b are defined as r=R value/(R value+G value+B value), g=G value/(R value+G value+B value), and b=B value/(R value+G value+B value). “2×g−r−b” is referred to as an excess green index (E×G).

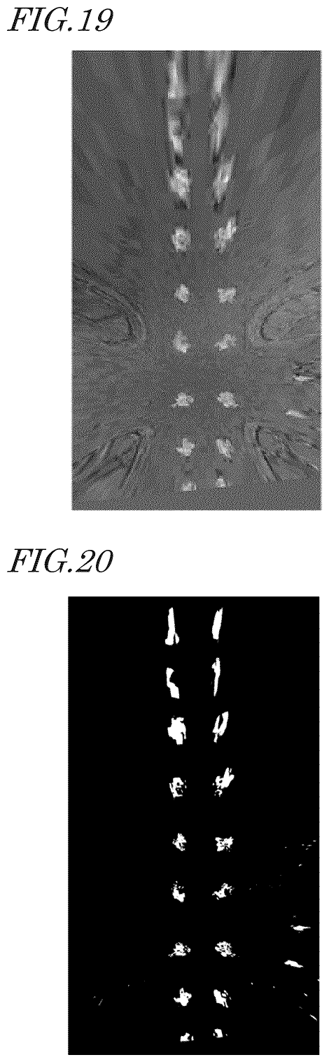

FIG. 19 shows a synthesized enhanced image obtained as a result of the RGB values in the synthesized image shown in FIG. 16 being transformed into “2×g−r−b”. As a result of this transformation, in the synthesized image shown in FIG. 16, a pixel having “r+b” smaller than g is displayed bright, and a pixel having “r+b” larger than g is displayed dark. As a result of this transformation, an image in which the color of the crops as the target of detection (in this example, “green”) is enhanced is provided (a synthesized enhanced image is provided). In the image shown in FIG. 19, a relatively bright pixel has a relatively large amount of green components, and belongs to a region of the crops.

As the “color index value” enhancing the color of the crops, another index such as, for example, a green red vegetation index (G value-R value)/(G value+R value) or the like may be used instead of the excess green index (E×G). In the case where the imager may function also as an infrared camera, an NDVI (Normalized Difference Vegetation Index) may be used as the “color index value of the crops”.

There are cases where each of rows of crops is covered with a sheet called a “mulching sheet”. In such a case, the “color of the crop rows” is the “color of objects located in rows while covering the crops”. Specifically, in the case where the color of the sheet is black, which is an achromatic color, the “color of the crop rows” signifies “black”. In the case where the color of the sheet is red, the “color of the crop rows” signifies “red”. In this manner, the “color of the crop rows” is not limited to signifying the color of the crops themselves, but also signifies the color of the region defining the crop rows (color recognizable from the color the soil surface).

In order to generate an enhanced image in which the “color of the crop rows” is enhanced, transformation of an RGB color space into an HSV color space may be used. An HSV color space is a color space that is formed of the three components of hue, saturation, and value. By using color information obtained by transformation of an RGB color space into an HSV color space, it is made possible to detect a “color” with low saturation, such as black or white. In order to detect “black” utilizing an OpenCV library, the hue may be set to the maximum range (0-179), the saturation may be set to the maximum range (0-255), and the value range may be set to 0-30. In order to detect “white”, the hue may be set to the maximum range (0-179), the saturation may be set to the maximum range (0-255), and the value range may be set to 200-255. Any pixel that has a hue, a saturation, and a value falling within such setting ranges is a pixel having the color to be detected. In order to detect, for example, a green pixel, the hue range may be set to a range of e.g. 30-90.

Such a synthesized enhanced image in which the color of the crops as the target of detection is enhanced is generated, so that the region of the crops is easily distinguished (extracted) from the remaining background region (so that segmentation is made easily).

Now, the operation S12 will be described.

In the operation S12, the processor 122 generates, from the synthesized enhanced image, a binary image, in which the pixels are classified into first pixels each having a color index value of the crop rows that is equal to, or higher than, a threshold value, and second pixels each having a color index value of the crop rows that is lower than the threshold value. FIG. 20 shows an example of such a binary image.

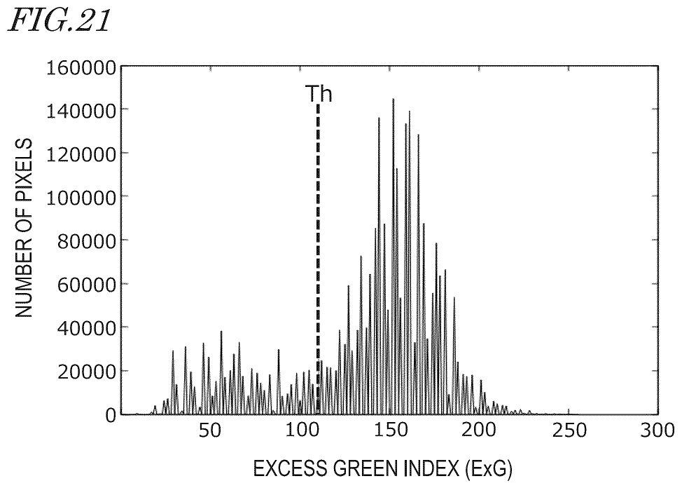

In the present example embodiment, the aforementioned excess green index (E×G) is adopted as the color index value of the crop rows, and a discriminant analysis method (Otsu's binarization) is used to determine a discrimination threshold. FIG. 21 shows a histogram of the excess green index (E×G) in the synthesized enhanced image shown in FIG. 19. In the histogram, the horizontal axis represents the excess green index (E×G), and the vertical axis represents the number of pixels in the image (corresponding to frequency of occurrence). In FIG. 21, a broken line is shown indicating a threshold value Th that is calculated by a discriminant analysis algorithm. The pixels in the synthesized enhanced image are classified into two classes by the threshold value Th. The right side of the broken line indicating the threshold value Th shows the frequency of occurrence of pixels each having an excess green index (E×G) that is equal to, or higher than, the threshold value. These pixels are estimated as belonging to a crop class. By contrast, the left side of the broken line indicating the threshold value Th shows the frequency of occurrence of pixels each having an excess green index (E×G) that is lower than the threshold value. These pixels are estimated as belonging to a non-crop class, e.g., the soil. In this example, the first pixels each having an index value that is equal to, or higher than, the threshold value correspond to “crop pixels”. By contrast, the second pixels each having an index value that is lower than the threshold value correspond to “background pixels”. The background pixels correspond to objects other than the target of detection, e.g., the soil surface. The aforementioned intermediate regions (work paths) 14 may be formed of the background pixels. Note that the method for determining the threshold value is not limited to the one described in the above example. For example, other methods utilizing machine learning may be used to determine the threshold value.

By assigning each of the pixels forming the synthesized enhanced image as either a “first pixel” or a “second pixel”, it becomes possible to extract a region that is the target of detection from the synthesized enhanced image. Also, by giving “zero” as the pixel value of each “second pixel”, or by removing data on the second pixel from the image data, it becomes possible to mask a region other than regions that are the target of detection. When finalizing the regions to be masked, a process of incorporating a pixel having an excess green index (E×G) exhibiting a locally high value, as a noise, into the masked regions. As a result of such a process, the binary image shown in FIG. 20, in which the pixels are classified into the first pixels and the second pixels can be generated.

Now the operation S13 will be described.

In the operation S13, the processor 122 determines the positions of the edge lines of the crop rows 12 based on the index values of the first pixels in the binary image.

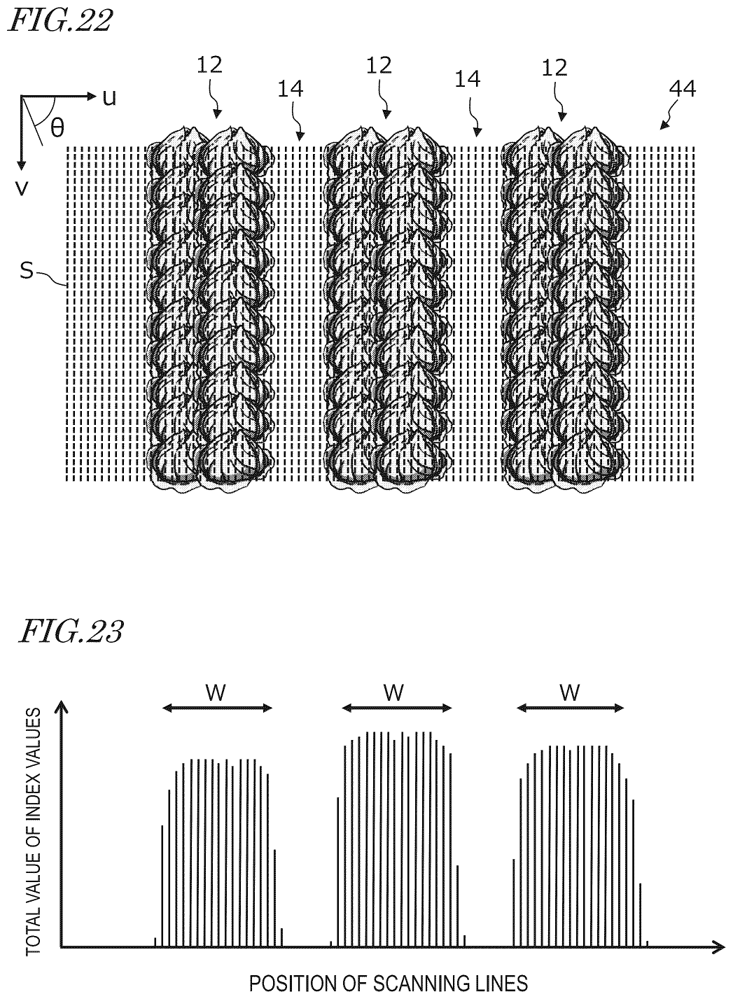

FIG. 22 schematically shows an example of plan view image 44 showing three crop rows 12. In this example, the direction of the crop rows 12 is parallel to the image vertical direction (v-axis direction). FIG. 22 shows a large number of scanning lines (broken lines) S that are parallel to the image vertical direction (v-axis direction). The processor 122 totals the index values of pixels that are located on the plurality of scanning lines S, for each scanning line, to obtain a total value.

FIG. 23 schematically shows the relationship between the position of the scanning lines S and the total value of the index values, obtained for the image 44 shown in FIG. 22. In FIG. 23, the horizontal axis represents the position of the scanning lines S along the image horizontal direction (u-axis direction). In the image 44, in the case where many of the pixels that are crossed by the scanning lines S are the first pixels belonging to the crop rows 12, such scanning lines S each have a large total value. By contrast, in the case where many of the pixels that are crossed by the scanning lines S are the second pixels (background pixels) belonging to the intermediate regions (work paths) 14 located between the crop rows 12, such scanning line S each have a small total value. Note that, according to the present example embodiment, the intermediate regions (work paths) 14 are masked, so that the second pixels have an index value of zero.

In the example in FIG. 22, there exist concave regions where the total values are zero or near-zero, and convex regions that are distinguished from the concave regions. The concave regions correspond to the intermediate regions (work paths) 14, whereas the convex regions correspond to the crop rows 12. In the present example embodiment, predetermined positions on opposite sides sandwiching a peak of the total values in each of the convex regions, specifically, the positions of the scanning lines S having total values of a predetermined ratio (e.g., a value selected from a range of 60% or higher and 90% or lower) with respect to the peak of the total values, are determined as the positions of the edge lines of each of the crop rows 12. In FIG. 23, two ends of each of arrows W represent the positions of the edge lines of each crop row 12. In the example of FIG. 23, the positions of the edge lines of each crop row 12 are positions of the scanning lines S having a 80% value with respect to the peak of the total values of the respective crop row 12.

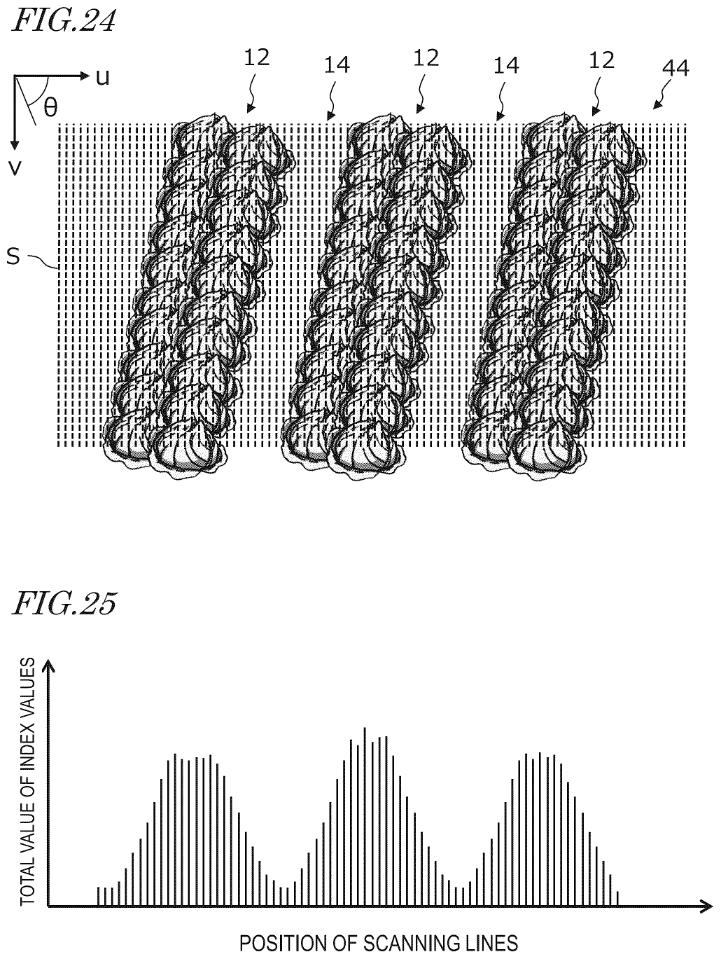

FIG. 24 shows an example of binary image 44, in which the crop rows 12 extend obliquely. In the images acquired by the imagers 120 and 121, the crop rows 12 may extend in directions that are inclined right or left, depending on the orientation of the agricultural machine 100. In the case where a plan view image is generated from such images through homography transformation, as in the example of FIG. 24, the direction of the crop rows 12 is inclined with respect to the image vertical direction (v-axis direction).

FIG. 24 also shows a large number of scanning lines (broken lines) S that are parallel to the image vertical direction (v-axis direction). The processor 122 totals the index values of the pixels that are located on such a plurality of scanning lines S, for each scanning line S, to obtain a total value of each scanning line S. FIG. 25 schematically shows the relationship between the position of the scanning lines S and the total value of the index values, obtained for the image shown in FIG. 24.

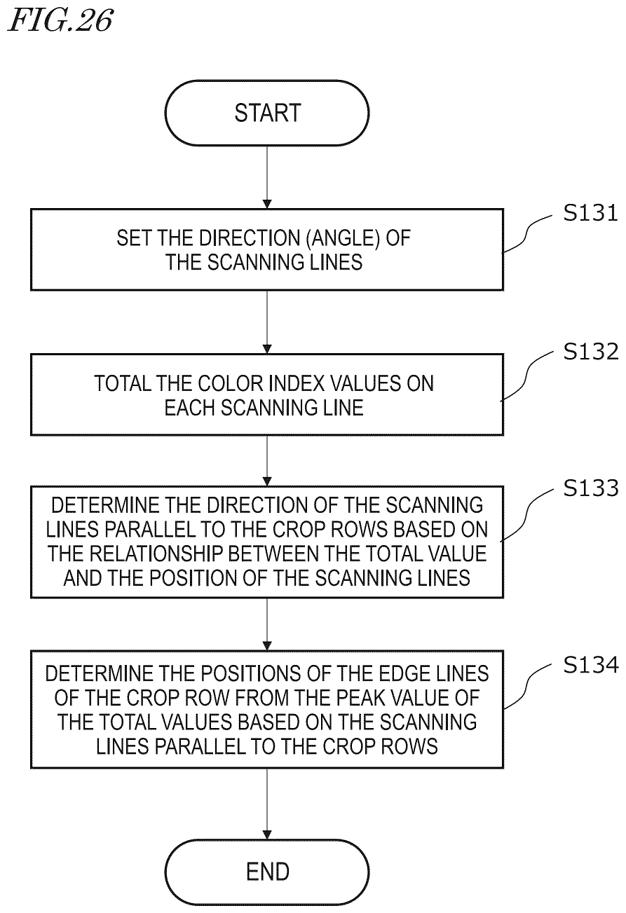

The processor 122 changes the direction (angle) of the scanning lines S to search for the direction, of the scanning lines S, that is parallel to the direction of the crop rows 12. FIG. 26 is a flowchart showing an example of method for searching for the direction, of the scanning lines S, that is parallel to the direction of the crop rows 12.

In step S131, the processor 122 sets the direction (angle) of the scanning lines S. Herein, an angle in the clockwise direction with respect to the u axis in the image coordinate system is set as the angle θ (see FIG. 22 and FIG. 24). The search for the angle θ may be done by, for example, setting a range of e.g., 60 to 120° and changing the angle by, for example, 1 degree. In this case, in step S131, 60°, 61°, 62°, . . . , 119° and 120° are set as the angle θ of scanning lines S.

In step S132, the processor 122 totals the index values of the pixels on the scanning line S extending in the direction of each angle θ to obtain data on a distribution of the total values in a direction vertical to the scanning lines. This data shows different distributions for different angles θ.

In step S133, the processor 122 selects, from the data on the distribution of the total values in the plurality of directions obtained as described above, a distribution in which the boundaries between the concave regions and the convex regions are clear as shown in FIG. 23 and the crop rows 12 are distinguished from the intermediate regions 14 most clearly, and determines the angle θ of the scanning lines S generating the distribution.

In step S134, the processor 122 determines the edge lines of each of the crop rows 12 from the peak value of the distribution corresponding to the angle θ determined in step S133. As described above, the positions of the scanning lines S each having a total value that is, for example, 0.8 times the peak value may be adopted as the edge lines.

Note that, when searching for the direction (angle) of the scanning lines S, each time the angle θ is changed by 1 degree within the range of search, the processor 122 may determine the distribution of the total values on the scanning line S at the angle θ. The processor 122 may calculate a feature amount (e.g., depth of the concave region/height of the convex region, differential value of the envelope, etc.) from the waveform of the distribution of the total values, and determine whether or not the direction of the crop rows 12 is parallel to the direction of the scanning lines S based on the feature amount.

Note that the method for determining the angle θ is not limited to the one described in the above example. In the case where the direction in which the crop rows extend is known through measurements, the orientation of the agricultural machine 100 may be measured with an IMU thereon, and the angle θ of the orientation of the agricultural machine 100 with respect to the direction in which the crop rows extend may be determined.

With the above-described method, influences of daylighting conditions that vary depending on the weather conditions such as forward light, backlight, sunny weather, cloudy weather, fog or the like or on the time of work can be reduced or prevented, and thus the crop rows can be detected at high precision. Even if there is a change in the type of crops (cabbage, broccoli, radish, carrot, lettuce, Chinese cabbage, etc.), growth state (from seedling to a fully grown state), presence/absence of diseases, presence/absence of fallen leaves or weeds, or soil color, the crop rows can be detected with high robustness.

In the above example embodiment, after generating the synthesized image of the first plan view image and the second plan view image generated by homography transformation of the first image and the second image, the processor 122 determines the threshold value for the binarization in the synthesized image and extracts a crop row region by use of the pixels each having a pixel value equal to, or higher than, the threshold value. Instead of using this method, the processor 122 may detect the crop rows by executing the following steps S21 through S26.
(S21) Generates, from the first image, a first enhanced image in which the color of the crop rows is enhanced.
(S22) Generates, from the second image, a second enhanced image in which the color of the crop rows is enhanced.
(S23) Generates, from the first enhanced image, a first plan view image, as seen from above the ground, in which the pixels are classified into pixels each having a color index value of the crop rows that is equal to, or higher than, the threshold value and pixels each having a color index value of the crop rows that is lower than the threshold value.
(S24) Generates, from the second enhanced image, a second plan view image, as seen from above the ground, in which the pixels are classified into pixels each having a color index value of the crop rows that is equal to, or higher than, the threshold value and pixels each having a color index value of the crop rows that is lower than the threshold value.
(S25) Synthesizes the first plan view image and the second plan view image to generate a synthesized image.
(S26) Detects the crop rows on the ground surface based on the synthesized image.

With such a method, the first plan view image and the second plan view image in which the crop row region is enhanced are generated, and the synthesized image in which the crop row region is enhanced is generated based on these images. The synthesized image is a binary image as shown in FIG. 20. With such a method also, the crop rows can be detected at high precision like by the method described above.

In the above-described example, the crop rows are detected from the synthesized image. It is also possible to detect ridges from the synthesized image. Hereinafter, an example of method for detecting a ridge on the ground surface will be described.

The processor 122 acquires the first image and the second image, which are each time-series images, from the imagers 120 and 121, and generates a synthesized image by the above-described method on a frame-by-frame basis. The synthesized image is generated at a predetermined frame rate. As a result, time-series synthesized images are obtained. Next, the processor 122 executes the following operations S31, S32 and S33.
(S31) From a plurality of synthesized images generated at different times, determines a first amount of movement, in the image plane, of each of a plurality of feature points by feature point matching.
(S32) Performs perspective projection of each of the plurality of feature points from the image plane onto a reference plane corresponding to the ground surface, and determines a second amount of movement of each of the projection points in the reference plane, based on the first amount of movement.
(S33) Estimates the height of each of the plurality of feature points from the reference plane based on the second amount of movement, to detect a ridge on the ground surface.

As a result of the above-described operations, the processor 122 can detect edge lines of the ridge. Based on the positions of the edge lines of the ridge, the processor 122 can determine an approximation line linearly approximating the ridge.

The above-described example of method for detecting the crop row or the ridge is described in detail in International Publication WO2023/276227 of an international application filed by the present Applicant. The entirety of the disclosure of International Publication WO2023/276227 is incorporated herein by reference.

The method for detecting the crop row or the ridge formed in a field is not limited to the one described in the above example, and may be any of a wide variety of methods using known algorithms. For example, a method for linearly approximating a crop row is described in detail in Japanese Patent No. 2624390 granted to the present Applicant. The entirety of the disclosure of Japanese Patent No. 2624390 is incorporated herein by reference. Japanese Laid-Open Patent Publication No. 2016-146061 describes a method for detecting a line formed by steps or trenches of a ridge or grooves. The entirety of the disclosure of Japanese Laid-Open Patent Publication No. 2016-146061 is incorporated herein by reference.

Now, an example configuration of the agricultural machine will be described.

The agricultural machine includes the above-described row detection system, and a control system executing controls to realize automatic steering driving. The control system is a computer system that includes a storage and a controller, and is configured or programmed to control the steering, the travel, and other operations of the agricultural machine.

In a usual automatic steering operation mode, the controller may be configured or programmed to specify the position of the agricultural machine by using a positioning device, and, based on a target path generated in advance, control the steering of the agricultural machine so that the agricultural machine travels along the target path. Specifically, the controller may be configured or programmed to control the steering angle of the wheels responsible for steering (e.g., front wheels) of the agricultural machine so that the agricultural machine travels along the target path within a field. The agricultural machine according to the present example embodiment includes an automatic steering device configured or programmed to control the agricultural machine to travel not only in such a usual automatic steering mode but also under the “row-following travel control” within the field in which rows of crops or ridges are provided.

The positioning device includes a GNSS receiver, for example. Such a positioning device is able to specify the position of the agricultural machine based on signals from GNSS satellites. However, in the case where the rows are in the field, even if the positioning device is able to measure the position of the agricultural machine with high precision, the interspaces between the rows are narrow, such that it is highly possible that the traveling device, e.g., wheels, of the agricultural machine deviates into the rows depending on how the crops are planted or on the state of growth. In the present example embodiment, however, the aforementioned row detection system can be used to detect the rows actually existing and perform appropriate automatic steering. In other words, the automatic steering device included in the agricultural machine according to an example embodiment of the present disclosure is configured or programmed to control the steering angle of the wheels responsible for steering, based on the positions of the edge lines of the row that are determined by the row detection system.

Moreover, in the agricultural machine according to the present example embodiment, the processor of the row detection system can monitor the positional relationship between the edge lines of the rows and the wheels responsible for steering based on the time-series color images. By generating a positional error signal from this positional relationship, it becomes possible for the automatic steering device of the agricultural machine to appropriately adjust the steering angle so as to reduce the positional error.

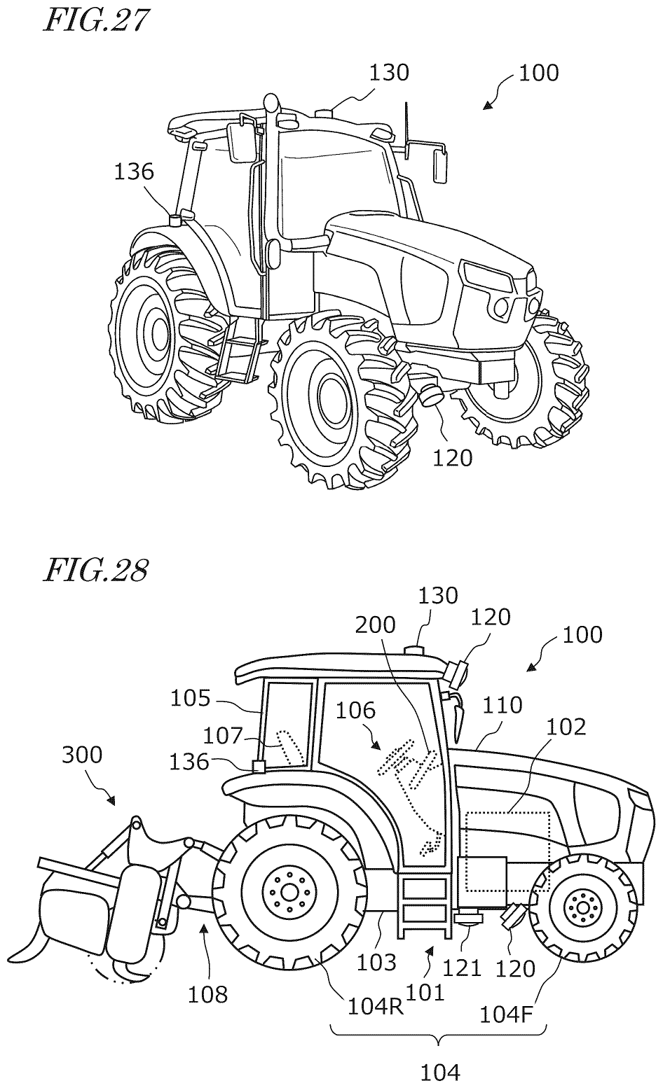

FIG. 27 is a perspective view showing an example of external appearance of the agricultural machine 100 according to the present example embodiment. FIG. 28 is a side view schematically showing an example of the agricultural machine 100 in a state where the implement 300 is attached thereto. The agricultural machine 100 according to the present example embodiment is an agricultural tractor (work vehicle) having the implement 300 attached thereto. The agricultural machine 100 is not limited to a tractor, or does not need to have the implement 300 attached thereto. The row detection technique according to an example embodiment of the present disclosure can exhibit excellent effects when being used in small-sized crop management machines and vegetable transplanters that may be used for tasks associated with the interridge land, such as, for example, ridge making, intertillage, ridging, weeding, side dressing, and preventive pest control.

The agricultural machine 100 according to the present example embodiment includes the imagers 120 and 121, a positioning device 130, and an obstacle sensor(s) 136. Although one obstacle sensor 136 is illustrated in FIG. 27, the obstacle sensors 136 may be provided at a plurality of positions of the agricultural machine 100.

As shown in FIG. 28, the agricultural machine 100 includes the vehicle body 110, a prime mover (engine) 102, and a transmission 103. The wheels 104 with tires and a cabin 105 are provided on the vehicle body 110. The wheels 104 include the pair of front wheels 104F and the pair of rear wheels 104R. Inside the cabin 105, a driver's seat 107, a steering device 106, an operational terminal 200, and switches for manipulation are provided. The front wheels 104F or the rear wheels 104R may be replaced by a plurality of wheels with caterpillar tracks attached thereon (may be replaced with crawlers), instead of being wheels with tires. The agricultural machine 100 may be a four-wheel drive vehicle including the four wheels 104 as driving wheels, or a two-wheel drive vehicle including the pair of front wheels 104F or the pair of rear wheels 104R as driving wheels.

The positioning device 130 in the present example embodiment includes a GNSS receiver. The GNSS receiver includes an antenna to receive a signal(s) from a GNSS satellite(s) and a processing circuit to determine the position of the agricultural machine 100 based on the signal(s) received by the antenna. The positioning device 130 receives a GNSS signal(s) transmitted from a GNSS satellite(s), and performs positioning based on the GNSS signal(s). GNSS is a general term for satellite positioning systems, such as GPS (Global Positioning System), QZSS (Quasi-Zenith Satellite System, e.g., MICHIBIKI), GLONASS, Galileo, BeiDou, and the like. Although the positioning device 130 according to the present example embodiment is disposed above the cabin 105, it may be disposed at any other position.

Furthermore, the positioning device 130 may complement the position data by using a signal from an IMU. The IMU can measure tilts and minute motions of the agricultural machine 100. The position data based on the GNSS signal can be complemented using the data acquired by the IMU, so that the positioning performance is improved.

In the example shown in FIGS. 27 and 28, the obstacle sensor(s) 136 is provided at the rear of the vehicle body 110. The obstacle sensor(s) 136 may be disposed at any other position than the rear of the vehicle body 110. For example, one or more obstacle sensors 136 may be disposed at any position at the sides of the vehicle body 110, the front of the vehicle body 110, and the cabin 105. The obstacle sensor(s) 136 detects objects around the agricultural machine 100. Each obstacle sensor 136 may include a laser scanner and/or an ultrasonic sonar, for example. In the case where an obstacle exists in a detection area (search area) present in a predetermined distance from the obstacle sensor 136, the obstacle sensor 136 outputs a signal indicating the presence of the obstacle. A plurality of obstacle sensors 136 may be provided at different positions of the body of the agricultural machine 100. For example, a plurality of laser scanners and a plurality of ultrasonic sonars may be disposed at different positions of the body. Providing such a large number of obstacle sensors 136 can reduce blind spots in monitoring obstacles around the agricultural machine 100.

The prime mover 102 may be a diesel engine, for example. Instead of a diesel engine, an electric motor may be used. The transmission 103 can change the propulsion and moving speed of the agricultural machine 100 through a speed changing mechanism. The transmission 103 can also switch between forward travel and backward travel of the agricultural machine 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as a “steering angle”) can cause a change in the traveling direction of the agricultural machine 100. During manual steering, the steering angle of the front wheels 104F can be changed by the operator manipulating the steering wheel. The power steering device includes a hydraulic device or an electric motor to supply an assisting force for changing the steering angle of the front wheels 104F. When automatic steering is performed, the steering angle is automatically adjusted by the power of the hydraulic device or the electric motor (steering motor) under the control of a controller disposed in the agricultural machine 100.

A linkage device 108 is provided at the rear of the vehicle body 110. The linkage device 108 may include, e.g., a three-point linkage (also referred to as a “three-point link” or a “three-point hitch”), a PTO (Power Take Off) shaft, a universal joint, and a communication cable. The linkage device 108 causes the implement 300 to be attached to, or detached from, the agricultural machine 100. The linkage device 108 is able to raise or lower the three-point linkage device with, for example, a hydraulic device, thus controlling the position or pose of the implement 300. Moreover, motive power can be sent from the agricultural machine 100 to the implement 300 via the universal joint. While towing the implement 300, the agricultural machine 100 causes the implement 300 to perform a predetermined task. The linkage device may be provided frontward of the vehicle body 110. In that case, the implement may be connected frontward of the agricultural machine 100.

The implement 300 shown in FIG. 28 is a rotary cultivator, for example. The implement 300 to be towed by, or attached to, a tractor or any of other work vehicles when traveling in a manner of following rows may be of any kind, so long as it is used in operations associated with the interridge land, such as ridge making, intertillage, ridging, weeding, side dressing, and preventive pest control.

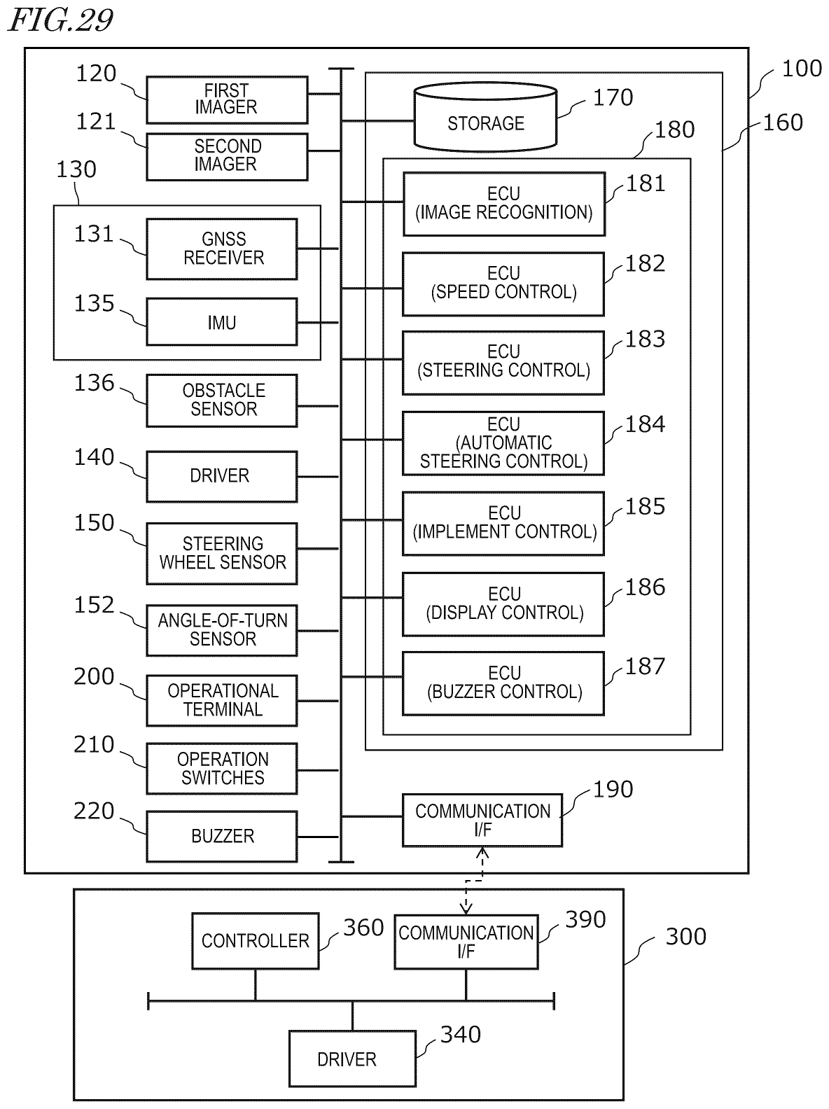

FIG. 29 is a block diagram showing an example general configuration of the agricultural machine 100 and the implement 300. The agricultural machine 100 and the implement 300 can communicate with each other via a communication cable that is included in the linkage device 108.

In addition to the first imager 120, the second imager 121, the positioning device 130, the obstacle sensor 136 and the operational terminal 200, the agricultural machine 100 in the example of FIG. 29 includes a drive device 140, a steering wheel sensor 150, an angle-of-turn sensor 152, a control system 160, a communication interface (I/F) 190, operation switches 210, and a buzzer 220. The positioning device 130 includes a GNSS receiver 131 and an IMU 135. The control system 160 includes a storage 170 and a controller 180. The controller 180 includes a plurality of electronic control units (ECU) 181 to 186. The implement 300 includes a drive device 340, a controller 380, and a communication interface (I/F) 390. Note that FIG. 29 shows component elements which are relatively closely related to the operation of automatic steering or self-driving by the agricultural machine 100, while other component elements are omitted from illustration.

The positioning device 130 performs positioning of the agricultural machine 100 by utilizing GNSS. In the case where the positioning device 130 includes an RTK receiver, not only GNSS signals transmitted from multiple GNSS satellites, but also a correction signal that is transmitted from a reference station is used. The reference station may be disposed around the field that is traveled by the agricultural machine 100 (e.g., at a position within 10 km of the agricultural machine 100). The reference station generates a correction signal based on the GNSS signals received from the multiple GNSS satellites, and transmits the correction signal to the positioning device 130. The GNSS receiver 131 in the positioning device 130 receives the GNSS signals transmitted from the multiple GNSS satellites. Based on the GNSS signals and the correction signal, the positioning device 130 calculates the position of the agricultural machine 100, thus achieving positioning. Use of the RTK-GNSS enables positioning with a precision on the order of several centimeters of errors, for example. Positional information, including latitude, longitude and altitude information, is acquired through the highly precise positioning by the RTK-GNSS. Note that the positioning method is not limited to use of the RTK-GNSS, but any arbitrary positioning method (e.g., an interferometric positioning method or a relative positioning method) that provides positional information with the necessary precision can be used. For example, positioning may be performed by utilizing a VRS (Virtual Reference Station) or a DGPS (Differential Global Positioning System).

The IMU 135 includes a 3-axis accelerometer and a 3-axis gyroscope. The IMU 135 may include a direction sensor such as a 3-axis geomagnetic sensor. The IMU 135 functions as a motion sensor which can output signals representing parameters such as acceleration, velocity, displacement, and pose of the agricultural machine 100. Based not only on the GNSS signals and the correction signal but also on a signal that is output from the IMU 135, the positioning device 130 can estimate the position and orientation of the agricultural machine 100 with higher precision. The signal that is output from the IMU 135 may be used for the correction or complementation of the position that is calculated based on the GNSS signals and the correction signal. The IMU 135 outputs a signal more frequently than the GNSS signals. Utilizing this highly frequent signal allows the position and orientation of the agricultural machine 100 to be measured more frequently (e.g., about 10 Hz or above). Instead of the IMU 135, a 3-axis accelerometer and a 3-axis gyroscope may be separately provided. The IMU 135 may be provided as a separate device from the positioning device 130.

In addition to the GNSS receiver 131 and the IMU 135, the positioning device 130 may include other kinds of sensors. Depending on the environment that is traveled by the agricultural machine 100, it is possible to estimate the position and the orientation of the agricultural machine 100 with high precision based on data from such sensors.

The positioning device 130 as described above can be used to create a map of the crop rows and the ridges detected by the above-described row detection system 1000.

For example, the drive device 140 includes various devices that are needed for the travel of the agricultural machine 100 and the driving of the implement 300, e.g., the aforementioned prime mover 102, the transmission 103, a differential including a locking differential mechanism, the steering device 106, and the linkage device 108. The prime mover 102 includes an internal combustion engine such as, for example, a diesel engine. Instead of, or in addition to, the internal combustion engine, the drive device 140 may include an electric motor that is dedicated to traction purposes.

The steering wheel sensor 150 measures the angle of rotation of the steering wheel of the agricultural machine 100. The angle-of-turn sensor 152 measures the angle of turn of the front wheels 104F, which are the wheels responsible for steering. Measurement values provided by the steering wheel sensor 150 and the angle-of-turn sensor 152 are used for the steering control by the controller 180.

The storage 170 includes one or more storage media such as a flash memory or a magnetic disc. The storage 170 stores various data that is generated by the sensors and the controller 180. The data that is stored on the storage 170 may include map data in the environment that is traveled by the agricultural machine 100, and data on a travel path of automatic steering. The storage 170 also stores a computer program(s) to cause the ECUs in the controller 180 to perform various operations described below. Such a computer program(s) may be provided to the agricultural machine 100 via a storage medium (e.g., a semiconductor memory, an optical disc or the like) or through telecommunication lines (e.g., the Internet). Such a computer program(s) may be marketed as commercial software.

The controller 180 includes a plurality of ECUs. The plurality of ECUs include an ECU 181 for image recognition, an ECU 182 for speed control, an ECU 183 for steering control, an ECU 184 for automatic steering control, an ECU 185 for implement control, an ECU 186 for display control, and an ECU 187 for buzzer control. The ECU 181 for image recognition functions as a processor of the row detection system. The ECU 182 controls the prime mover 102, the transmission 103, and brakes included in the drive device 140, thus controlling the speed of the agricultural machine 100. The ECU 183 controls the hydraulic device or the electric motor included in the steering device 106 based on a measurement value of the steering wheel sensor 150, thus controlling the steering of the agricultural machine 100. The ECU 184 executes computations and controls for achieving automatic steering driving, based on signals which are output from the positioning device 130, the steering wheel sensor 150, and the angle-of-turn sensor 152. During the automatic steering driving, the ECU 184 sends the ECU 183 a command to change the steering angle. In response to this command, the ECU 183 controls the steering device 106 to change the steering angle. In order to cause the implement 300 to perform a desired operation, the ECU 185 controls the operation of the linkage device 108. Also, the ECU 185 generates a signal to control the operation of the implement 300, and transmits this signal from the communication I/F 190 to the implement 300. The ECU 186 controls displaying on the operational terminal 200. For example, the ECU 186 causes a display device of the operational terminal 200 to present various indications, e.g., a map of the field, detected crop rows or ridges, the position and the target path of the agricultural machine 100 in the map, pop-up notifications, and setting screens. The ECU 187 controls outputting of alarm sounds by the buzzer 220.

Through the action of these ECUs, the controller 180 realizes driving via manual steering or automatic steering. During usual automatic steering driving, the controller 180 controls the drive device 140 based on the position of the agricultural machine 100 as measured or estimated by the positioning device 130 and the target path stored on the storage 170. As a result, the controller 180 causes the agricultural machine 100 to travel along the target path. By contrast, in a row-following control mode where travel is done along the rows, the ECU 181 for image recognition determines, from a detected crop row or ridge, the edge lines of the detected crop row or ridge, and generates a target path based on the edge lines. The controller 180 performs an operation in accordance with this target path.

The plurality of ECUs included in the controller 180 may communicate with one another according to a vehicle bus standard such as a CAN (Controller Area Network). Although the ECUs 181 to 187 are illustrated as individual corresponding blocks in FIG. 29, each of these functions may be implemented by a plurality of ECUs. Alternatively, an onboard computer that integrates at least a portion of the functions of the ECUs 181 to 187 may be provided. The controller 180 may include ECUs other than the ECUs 181 to 187, and any number of ECUs may be provided in accordance with functionality. Each ECU includes a control circuit including one or more processors.

The communication I/F 190 is a circuit that performs communications with the communication I/F 390 of the implement 300. The communication I/F 190 performs exchanges of signals complying with an ISOBUS standard such as, for example, ISOBUS-TIM between the communication I/F 190 itself and the communication I/F 390 of the implement 300. This causes the implement 300 to perform a desired operation, or allows information to be acquired from the implement 300. The communication I/F 190 may communicate with an external computer via a wired or wireless network. The external computer may be a server computer in a farming support system which centralizes management of information concerning fields by using a cloud, and assists in agriculture by utilizing the data on the cloud, for example.

The operational terminal 200 is a terminal for the operator to perform a manipulation related to the travel of the agricultural machine 100 and the operation of the implement 300, and may also be referred to as an imaginary terminal (VT). The operational terminal 200 may include a display device such as a touch screen panel, and/or one or more buttons. By manipulating the operational terminal 200, the operator can perform various manipulations of, for example, switching ON/OFF the automatic steering mode, switching ON/OFF the cruise control, setting an initial position of the agricultural machine 100, setting a travel path, recording or editing a map, switching between 2WD and 4WD, switching ON/OFF the locking differential, and switching ON/OFF the implement 300. At least a portion of these manipulations can also be realized by manipulating the operation switches 210. Display on the operational terminal 200 is controlled by the ECU 186.

The buzzer 220 is an audio output device to present an alarm sound for alerting the operator of an abnormality. For example, during automatic steering driving, the buzzer 220 presents an alarm sound when the agricultural machine 100 deviates from the travel path by a predetermined distance or more. Instead of the buzzer 220, a loudspeaker of the operational terminal 200 may provide a similar function. The buzzer 220 is controlled by the ECU 186.

The drive device 340 in the implement 300 performs an operation necessary for the implement 300 to perform a predetermined task. The drive device 340 includes devices adapted to the intended use of the implement 300, e.g., a hydraulic device, an electric motor, or a pump. The controller 380 controls the operation of the drive device 340. In response to a signal that is transmitted from the agricultural machine 100 via the communication I/F 390, the controller 380 causes the drive device 340 to perform various operations. Moreover, a signal that is in accordance with the state of the implement 300 may be transmitted from the communication I/F 390 to the agricultural machine 100.

### Example Embodiment 2

Now, an overview of the row detection system according to example embodiment 2 will be described. The row detection system according to the present example embodiment can detect the crop rows or ridges at high precision even in the case where the crop rows or ridges are formed in a curved manner in a field. Hereinafter, differences from example embodiment 1 will be mainly described, and overlapping descriptions will be omitted.

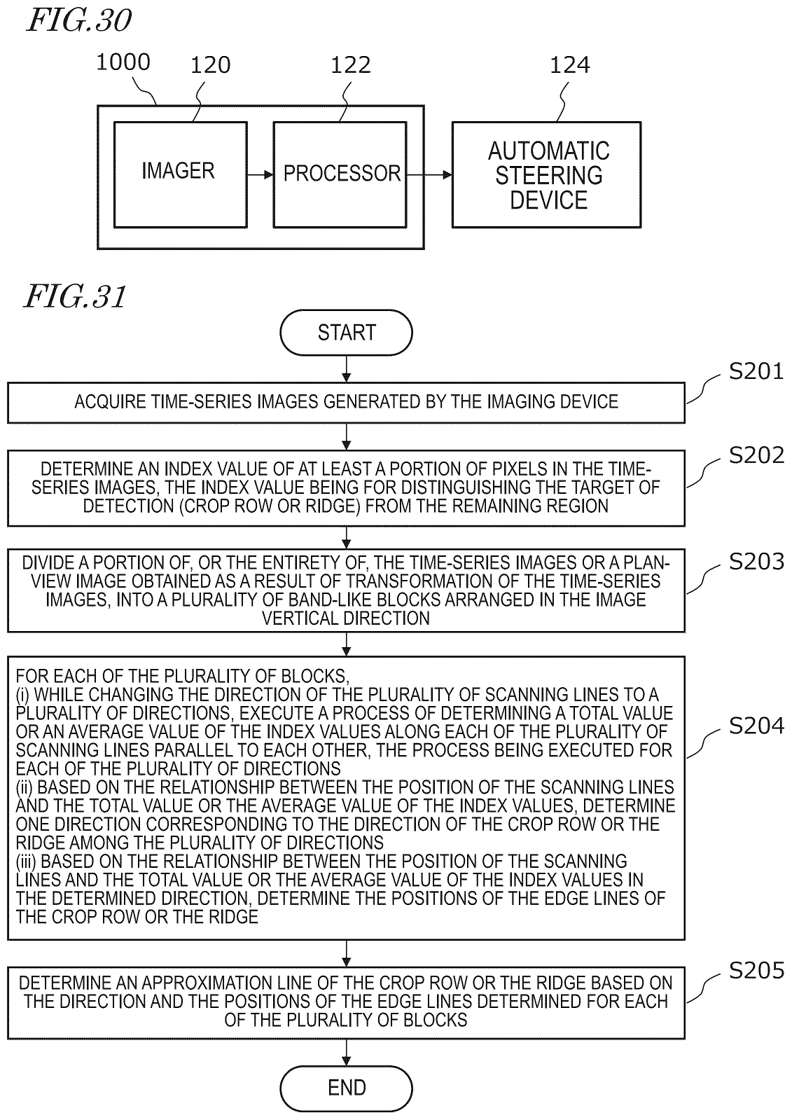

FIG. 30 is a block diagram showing a configuration of the row detection system 1000 according to the present example embodiment. The row detection system 1000 includes the imager 120 used while being attached to the agricultural machine, and the processor 122. The imager 120 is secured to the agricultural machine so as to capture an image of the ground surface on which the agricultural machine performs groundwork and thus to generate time-series images including at least a portion of the ground surface. The processor 122 is configured or programmed to execute image processing on the time-series images generated by the imager 120 to detect a row region such as a crop row or a ridge on the ground surface and to determine an approximation line of the crop row or the ridge. The processor 122 may be configured or programmed to determine a target path of the agricultural machine based on the determined approximation line, and to output information on the target path to the automatic steering device 124 of the agricultural machine. The automatic steering device 124 performs steering control on the agricultural machine so that the agricultural machine moves along the target path. As a result, the agricultural machine is allowed to move along the crop row or the ridge.

FIG. 31 is a flowchart showing a flow of operations of the processor 122. The processor 122 executes operations of steps S201 through S205 to detect the crop row or the ridge existing on the ground surface on which the agricultural machine performs groundwork. The operations shown in FIG. 31 may be performed while the agricultural machine is moving. The operations shown in FIG. 31 make it possible to detect a crop row or a ridge extending in a curved manner and to determine an approximation line thereof.

In step S201, the processor 122 acquires time-series images generated by the imager 120. The time-series images form an aggregation of images chronologically generated by the imager 120. The agricultural machine is not limited to having one imager 120 mounted thereon, and may have a plurality of imagers mounted thereon. The processor 122 may acquire a plurality of sequences of the time-series images generated by the plurality of time-imagers or synthesized time-series images generated by synthesizing the plurality of sequences of the time-series images. In this case, the subsequent processes may be performed on each of the plurality of sequences of the time-series images or the synthesized time-series images. For example, the subsequent processes may be performed on the image synthesized by the above-described method in example embodiment 1.

In step S202, the processor 122 determines an index value of at least a portion of pixels in the acquired time-series images. The index value is for distinguishing the crop row or the ridge as a target of detection from the remaining region. For example, the processor 122 may be configured or programmed to determine a region of interest from which at least one of the crop row and the ridge is to be detected, and to determine an index value of a portion of, or all of, the pixels included in the region of interest. The index value may be, for example, a color index value of the crops. In the case where the target of detection is a green crop row, the index value may be an excess green index (E×G), By contrast, in the case where the target of detection is a ridge, the index may be an index indicating the height thereof from a reference plane (e.g., plane parallel to the surface of the ground). The method for determining E×G as the index value is as described above. A specific example of method for determining the height from the reference plane will be described below.

In step S203, the processor 122 divides a portion of, or the entirety of, the time-series images or a plan view image, obtained as a result of transformation of the time-series images, into a plurality of band-shaped blocks arranged in the image vertical direction. In the case where the imager 120 is attached to the agricultural machine so as to face in an obliquely downward direction, the processor 122 may be configured or programmed to transform the time-series images into a plan view image and then divide the plan view image into a plurality of blocks. The transformation of the time-series images into the plan view image may be performed by homography transformation (planar perspective projection).

In step S204, the processor 122 executes the following operations (i) through (iii) on each of the plurality of blocks.
(i) While changing the direction of the plurality of scanning lines to a plurality of direction, executes a process of determining a total value or an average value of the above-described index values along each of a plurality of scanning lines parallel to each other, the process being executed for each of the plurality of directions.
(ii) Based on the relationship between the position of the scanning lines and the total value or the average value of the index values, determines one direction corresponding to the direction of the crop row or the ridge among the plurality of directions.
(iii) Based on the relationship between the position of the scanning lines and the total value or the average value of the index values in the determined direction, determines the positions of the edge lines of the crop row or the ridge.

A specific example of these operations will be described below.

In step S205, the processor 122 determines an approximation line of the crop row or the ridge based on the directions and the positions of the edge lines determined for each of the plurality of blocks. For example, the processor 122 may determine an approximation line at the center between two edge lines indicating two ends of the crop row or the ridge in each of the blocks.

As a result of the above-described operations, the processor 122 can detect the crop row or the ridge from the time-series images generated by the imager 120 and determine an approximation line thereof. The operation of step S204 is executed for each of the blocks, so that even in the case where the crop row or ridge is provided in a curved manner, an approximation line of the crop row or the ridge can be detected at high precision.

After determining the approximation line of the crop row or the ridge, the processor 122 may output information on the approximation line to the automatic steering device 124. As a result, the automatic steering device 124 can control the traveling direction of the agricultural machine based on the approximation line.

Hereinafter, the row detection system and the row detection method according to the present example embodiment will be described in detail.

Example 1 of the row detection system according to the present example embodiment will be described. In the present example embodiment, a crop row is detected as the “row detection”.

The row detection system according to the present example embodiment includes an imager used while being attached to the agricultural machine. The imager is secured to the agricultural machine so as to capture an image of the ground surface on which the agricultural machine travels and to acquire time-series color images including at least a portion of the ground surface.

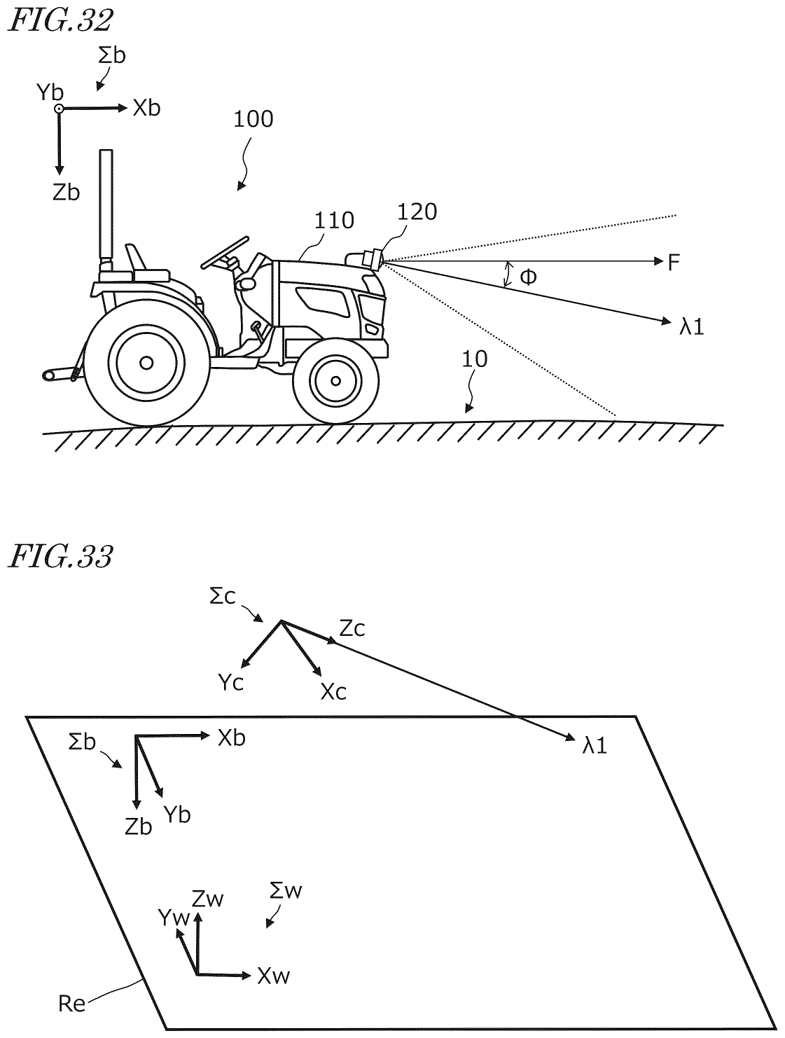

FIG. 32 schematically shows how the imager 120 attached to the agricultural machine 100 such as a tractor, a vehicle for crop management or the like captures an image of the ground surface 10. Unlike the agricultural machine 100 shown in FIG. 4, the agricultural machine 100 shown in FIG. 32 includes one imager 120 instead of two. Except for this, the agricultural machine 100 has the same basic configuration as that in the example of FIG. 4.

FIG. 33 is a perspective view schematically showing the relationship among the vehicle coordinate system Σb, a camera coordinate system Σc of the imager 120, and the world coordinate system Σw that is fixed to the ground surface 10. The camera coordinate system Σc has an Xc axis, a Yc axis, and a Ze axis that are orthogonal to one another. The world coordinate system Σw has an Xw axis, a Yw axis, and a Zw axis that are orthogonal to one another. In the example of FIG. 33, the Xw axis and the Yw axis of the world coordinate system Σw are on a reference plane Re that expands along the ground surface 10.

The imager 120 is attached to the agricultural machine 100 so as to face in a predetermined direction. Therefore, the position and the orientation of the camera coordinate system Σc with respect to the vehicle coordinate system Σb are fixed in a known state. The Zc axis of the camera coordinate system Σc is on a camera optical axis 21. In the illustrated example, the camera optical axis λ1 is inclined with respect to the traveling direction F of the agricultural machine 100 toward the ground surface 10, with an angle of depression that is greater than 0°. The traveling direction F of the agricultural machine 100 is generally parallel to the ground surface 10, along which the agricultural machine 100 travels. The angle of depression may be set to a range of, for example, not less than 0° and not more than 60°. In the case where the position at which the imager is mounted is close to the ground surface 10, the orientation of the camera optical axis λ1 2 may be set so that the angle of depression Φ1 has a negative value, that is, so that the orientation of the camera optical axis λ1 has a positive angle of elevation.

While the agricultural machine 100 is traveling on the ground surface 10, the vehicle coordinate system Σb and the camera coordinate system Σc translate relative to the world coordinate system Σw. When the agricultural machine 100 rotates or swings in a direction of pitch, roll, or yaw during travel, the vehicle coordinate system Σb and the camera coordinate system Σc rotate relative to the world coordinate system Σw. In the following description, for simplicity, it is assumed that the agricultural machine 100 does not rotate in the pitch or roll direction and that the agricultural machine 100 moves essentially parallel to the ground surface 10.

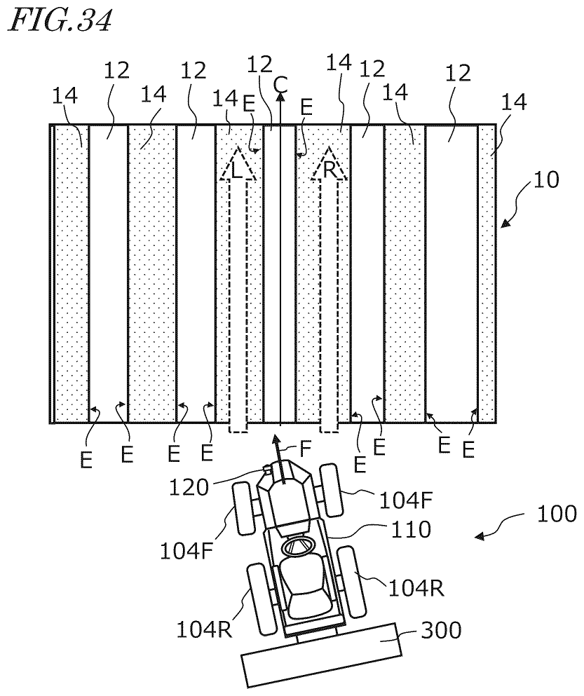

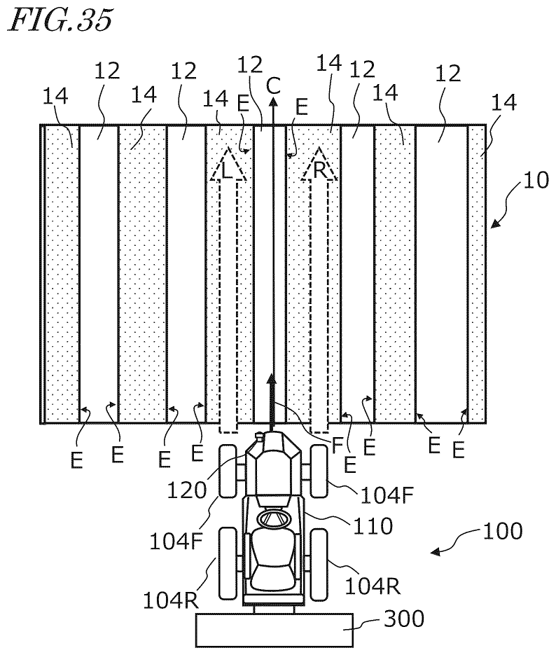

FIG. 34 is a plan view schematically showing a portion of a field in which a plurality of crop rows 12 are provided on the ground surface 10. FIG. 34 schematically shows the agricultural machine 100 about to enter the field where the crop rows 12 are provided.

In the example shown in FIG. 34, thick broken-lined arrows L and R are respectively shown for the work paths 14 that are located on opposite sides of one crop row 12 in the middle. While the agricultural machine 100 is traveling on a target path that is indicated by solid-lined arrow C, the front wheels 104F and the rear wheels 104R of the agricultural machine 100 are required to move on the work paths 14 along arrows L and R, so as not to step on the crop row 12. In the present example embodiment, the imager 120 attached to the agricultural machine 100 is usable to detect the edge lines E of the crop row 12. Therefore, it is possible to control the steering and the travel of the agricultural machine 100 so that the front wheels 104F and the rear wheels 104R move on the work paths 14 along arrows L and R.

The imager 120 of the agricultural machine 100 shown in FIG. 34 acquires an image, for example, substantially the same as the image 40 shown in FIG. 9. As shown in FIG. 34, the traveling direction F of the agricultural machine 100 is inclined with respect to the direction in which the crop rows 12 extend (direction parallel to arrow C). Therefore, as shown in FIG. 9, the vanishing point P0 is located in a right region of the image 40.

In the present example embodiment, even if the daylighting conditions or the growth state of the crops changes, it is possible to accurately detect the crop row 12 from the image 40 and to determine the edge lines E of the crop row 12 by the method described below. Based on the edge lines E, a path along which the agricultural machine 100 is to proceed (target path) can be appropriately generated. As a result, it is made possible to control, by automatic steering, the travel of the agricultural machine 100 so that the front wheels 104F and the rear wheels 104R of the agricultural machine 100 move on the work paths 14 along arrows L and R (row-following travel control is made possible). Such row-following travel control realizes precise automatic steering in accordance with the state of growth of the crops, which is not easily realized by the automatic steering technique using the positioning system such as GNSS or the like.

FIG. 35 is a plan view schematically showing a state where the agricultural machine 100 is steered to adjust the position and the orientation thereof (angle in the yaw direction) so that the positional error thereof with respect to the target path (arrow C) is reduced. The imager 120 of the agricultural machine 100 in this state acquires an image substantially the same as the image 40 shown in FIG. 7. The front wheels 104F and the rear wheels 104F of the agricultural machine 100 in the state of FIG. 35 are located on lines indicated by arrows L and R on the work paths 14. While the agricultural machine 100 is traveling along the target path indicated by central arrow C, the automatic steering device 124 in the agricultural machine 100 controls the steering angles of the wheels responsible for steering so that neither the front wheels 104F nor the rear wheels 104R deviate from the work paths 14.

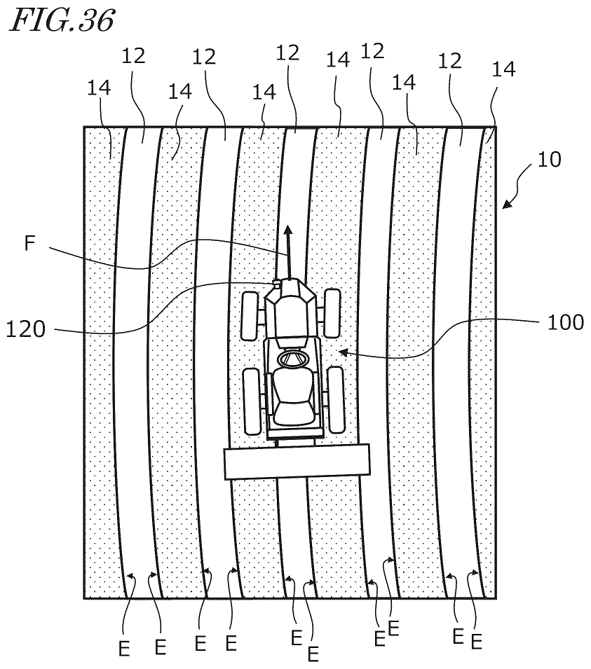

FIG. 36 is a plan view schematically showing a portion of a field in which a plurality of curved crop rows 12 are provided on the ground surface 10. Even in the case where such curved crop rows 12 are formed, it is made possible, by operations described below, to accurately detect the positions of the crop rows 12 from the image acquired by the imager 120 and to precisely control the steering and the travel of the agricultural machine 100 along the crop rows 12.

Now, the configuration and the operation of the processor 122 in the row detection system according to the present example embodiment will be described in more detail.

The agricultural machine 100 according to the present example embodiment includes the row detection system 1000 and the automatic steering device 124 shown in FIG. 30. The row detection system 1000 includes the imager 120, and the processor 122 executing image processing on time-series color images acquired from the imager 120. The processor 120 is connected to the automatic steering device 124. The automatic steering device 124 is included in, for example, a controller configured or programmed to control the travel of the agricultural machine 100.

The processor 122 may be implemented by the electronic control unit (ECU) for image recognition. The ECU is an onboard computer. The processor 122 is connected to the imager 120 via serial signal lines, e.g., wire harnesses or the like, so as to receive image data that is output from the imager 120. A portion of the image recognition processing that is to be executed by the processor 122 may be executed inside the imager 120 (inside a camera module). The hardware configuration of the processor 122 is as described above with reference to FIG. 11. The imager 120 has substantially the same configuration as that of each of the imagers 120 and 121 in example embodiment 1.

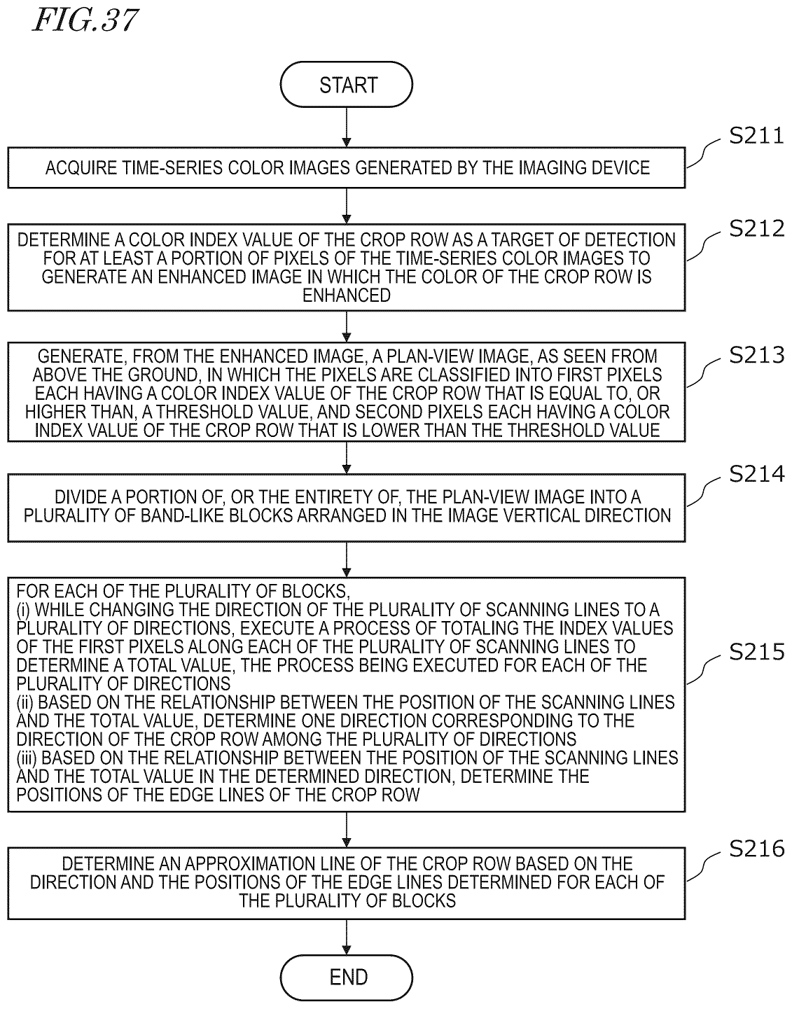

FIG. 37 is a flowchart showing an example operation of the processor 122 according to the present example embodiment. The processor 122 executes operations of steps S211 through S216 shown in FIG. 37. Hereinafter, the operation of each step will be described.

In step S211, the processor 122 acquires the time-series color images generated by the imager 120. The time-series color images form an aggregation of images that are chronologically generated by the imager 120 through image capturing. Each of the images is formed of a frame-by-frame group of pixels. For example, in the case where the imager 120 outputs images at a frame rate of 30 frames/second, the processor 122 can acquire new images with a period of about 33 milliseconds. As compared with a common automobile that travels on public roads, the agricultural machine 100, such as a tractor or the like, travels in a field at a speed which is relatively low, e.g., about 10 kilometers per hour or lower. In the case where the speed is 10 kilometers per hour, a distance of about 6 centimeters is travelled in about 33 milliseconds. Therefore, the processor 122 may acquire images with a period of, for example, about 100 to 300 milliseconds, and does not need to process all the frame of images captured by the imager 120. The period with which the images to be processed by the processor 122 are acquired may be automatically changed by the processor 122 in accordance with the traveling speed of the agricultural machine 100.

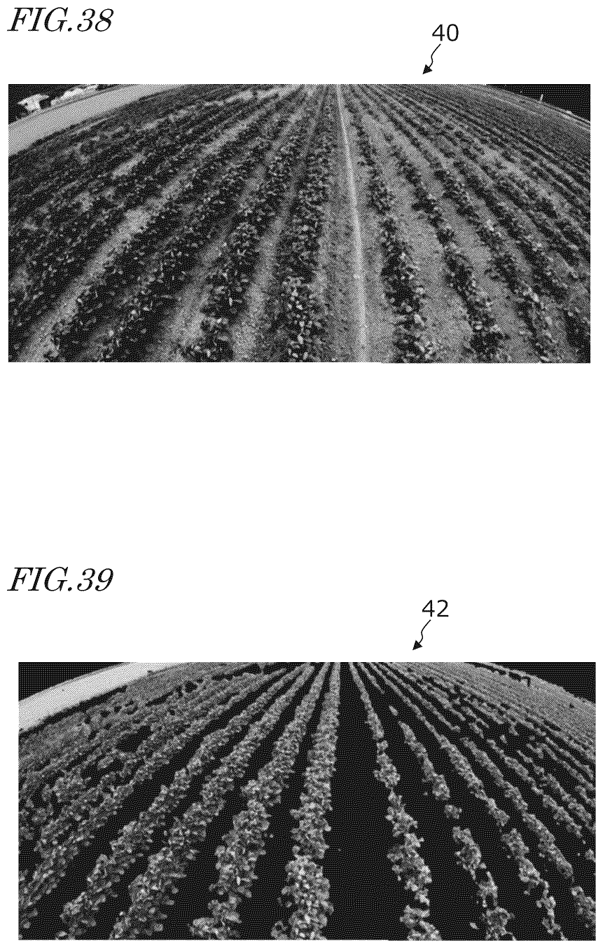

FIG. 38 shows an example of a one-frame image 40, among the time-series color images acquired by the imager 120 mounted on the agricultural machine 100 (in this example, a monocular camera). The image 40 of FIG. 38 shows rows of crops (crop rows) planted in the form of rows on the ground surface of a field. In this example, the crop rows are arranged essentially in parallel and at equal intervals on the ground surface, such that the camera optical axis of the imager 120 is directed in the traveling direction of the agricultural machine 100. As described above, the camera optical axis does not need to be parallel to the traveling direction of the agricultural machine 100, but may be incident on the ground surface frontward of the agricultural machine 100 in the forward traveling direction thereof. The position at which the imager 120 is attached is not limited to the one described in this example. In the case where a plurality of imagers are attached to the agricultural machine 100, some of the imagers may each be attached so that the camera optical axis thereof is directed in a direction opposite to the traveling direction or a direction crossing the traveling direction.

In step S212 in FIG. 37, the processor 122 determines a color index value of the crops as a target of detection for at least a portion of pixels in the time-series color images acquired from the imager 120 to generate an enhanced image in which the color of the crops is enhanced. The color index value may be, for example, an excess green index (E×G) described above.

FIG. 39 shows an enhanced image 42 obtained as a result of the RGB values in the image shown in FIG. 38 being transformed into E×G, that is, “2×g−r−b”. As a result of this transformation, in the image shown in FIG. 39, a pixel having “r+b” smaller than g is displayed bright, and a pixel having “r+b” larger than g is displayed dark. As a result of this transformation, an image 42 in which the color of the crops as the target of detection (in this example, “green”) is enhanced is obtained (the enhanced image 42 is provided). In the image shown in FIG. 39, the relatively bright pixel has a relatively large amount of green components, and belongs to the region of the crops.

As the “color index value” enhancing the color of the crops, another index such as, for example, a green red vegetation index (G value-R value)/(G value+R value) or the like may be used instead of the excess green index (E×G). In the case where the imager may function also as an infrared camera, an NDVI (Normalized Difference Vegetation Index) may be used as the “color index value of the crops”.

There are cases where each of rows of crops is covered with a sheet called a “mulching sheet”. In such a case, the “color of the crop rows” is the “color of objects located in rows while covering the crops”. Specifically, in the case where the color of the sheet is black, which is an achromatic color, the “color of the crop rows” signifies “black”. In the case where the color of the sheet is red, the “color of the crop rows” signifies “red”. In this manner, the “color of the crop rows” is not limited to signifying the color of the crops themselves, but also signifies the color of the region defining the crop rows (color recognizable from the color the soil surface).

In order to generate an enhanced image in which the “color of the crop rows” is enhanced, transformation of an RGB color space into an HSV color space may be used. An HSV color space is a color space that is formed of the three components of hue, saturation, and value. By using color information obtained by transformation of an RGB color space into an HSV color space, it is made possible to detect a “color” with low saturation, such as black or white. In order to detect “black” utilizing an OpenCV library, the hue may be set to the maximum range (0-179), the saturation may be set to the maximum range (0-255), and the value range may be set to 0-30. In order to detect “white”, the hue may be set to the maximum range (0-179), the saturation may be set to the maximum range (0-255), and the value range may be set to 200-255. Any pixel that has a hue, a saturation, and a value falling within such setting ranges is a pixel having the color to be detected. In order to detect, for example, a green pixel, the hue range may be set to a range of e.g. 30-90.

Such an image in which the color of the crops as the target of detection is generated (such an enhanced image is generated), so that the region of the crops is easily distinguished (extracted) from the remaining background region (so that segmentation is made easily).

Note that instead of determining index values of all the pixels in the time-series color images, the processor 122 may determine index values of pixels in a region of the time-series color images to generate an enhanced image for the such a region. For example, the processor 122 may determine a region of interest, in the time-series color images, from which the crop row is detected, and determine an index value of each of the pixels in the region of interest, to generate an enhanced image for the region of interest. As the region of interest, a region including a bottom central portion of an image, for example, may be selected. Information necessary for the row-following travel control is position information on the crop row located near the agricultural machine 100. Therefore, it is not necessary to determine index values of the entirety of the image.

In step S213 in FIG. 37, the processor 122 generates, from the enhanced image 42, a plan view image in which the pixels are classified into first pixels each having a color index value of the crop rows that is equal to, or higher than, a threshold value, and second pixels each having a color index value of the crop rows that is lower than the threshold value. The plan view image is an image as seen from above the ground.

As the color index value of the crop rows, the aforementioned excess green index (E×G), for example, may be adopted, and a discriminant analysis method (Otsu's binarization) may be used to determine a discrimination threshold. As described above with reference to FIG. 21, the pixels of the enhanced image 42 may be classified into pixels each having an index value equal to, or higher than, a threshold value (crop pixels) and pixels each having an index value lower than the threshold value (background pixels) based on a histogram of the excess green index (E×G) in the enhanced image 42.

By assigning each of the pixels forming the enhanced image 42 as either a “first pixel” or a “second pixel”, it becomes possible to extract a region that is the target of detection from the enhanced image 42. Also, by giving “zero” as the pixel value of each “second pixel”, or by removing data on the second pixel from the image data, it becomes possible to mask a region other than regions that are the target of detection. When finalizing the regions to be masked, a process of incorporating a pixel having an excess green index (E×G) exhibiting a locally high value, as a noise, into the masked regions.

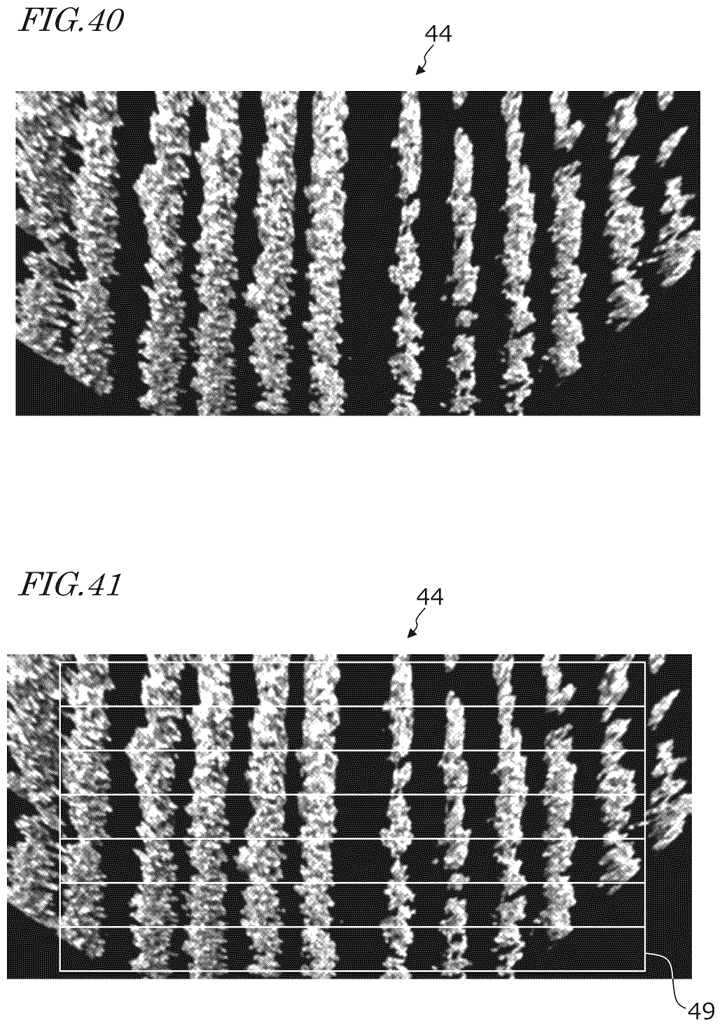

FIG. 40 shows an example of plan view image 44, as seen from above the ground, in which the pixels are classified into first pixels and the second pixels. The plan view image 44 in FIG. 40 is created from the enhanced image 42 in FIG. 39 by use of an image transformation technique described below. In the plan view image 44, black pixels (pixels having a value set to zero) are the second pixels each having a color index value of the crops (in this example, excess green index) that is lower than the threshold value Th. The regions formed of the second pixels are mainly regions where the soil surface of the ground surface are exposed to be seen. In the plan view image 44 in FIG. 40, black triangular regions exist at left and right corners in contact with the bottom side. These black triangular regions correspond to regions that are not shown in the enhanced image 42 in FIG. 39. Note that the image 40 in FIG. 38 and the enhanced image 42 in FIG. 39 each show a phenomenon that a line that is supposed to a straight line is distorted in a peripheral area of the image. Such a distortion of the image is caused by the performance of the lens of the camera, and may be corrected by use of internal parameters of the camera. The processes of enhancing the crop region, masking, correcting the distortion and the like may be referred to as “pre-processes”. The pre-processes may include processes other than these processes.

The plan view image 44 in FIG. 40 is an overhead-view image of the reference plane Re parallel to the ground surface, as seen from right above the reference plane Re in a direction normal to the reference plane Re. Such an overhead-view image can be generated by use of homography transformation (planar perspective projection) of the enhanced image 42 in FIG. 39. The specific process of the homography transformation is as described above with reference to FIG. 13.

The processor 122 according to the present example embodiment generates the plan view image as seen from above the ground, in which the pixels are classified into the first pixels each having a color index value of the crops that is equal to, or higher than, a threshold value, and the second pixels each having a color index value of the crop rows that is lower than the threshold value, by the above-described method. After this, the processor 122 executes the operation of step S214 in FIG. 37.

In step S214, the processor 122 divides a portion of, or the entirety of, the plan view image into a plurality of band-shaped bocks arranged in the image vertical direction. FIG. 41 shows an example in which the plan view image 44 is divided into a plurality of blocks 49. In the example shown in FIG. 41, a region of the plan view image 44 (region of interest) including a central portion is divided into the plurality of blocks 49. The processor 122 may divide the entirety of the plan view image 44 into the plurality of blocks 49. The plurality of blocks 49 are arranged in the image vertical direction. Each of the blocks 49 has a band shape extending in the image horizontal direction. The length of each block 49 in the image vertical direction may be set to correspond to, for example, a distance of 1 to 2 meters on the ground surface.

In this specification, the number of the blocks 49 may be referred to as a “division number”. In the example of FIG. 41, the division number is 7, but the division number is not limited to 7. Where the height of the image (i.e., the number of pixels in the vertical direction) is y pixels, the number (division number) of the blocks 49 may be set to any number of 3 or larger and y or smaller. In the case where, for example, the number of pixels in the image vertical direction is 960, the division number may be set to a value that is 3 or larger and 960 or smaller. Typically, the division number may be set to a value of 5 or larger and 30 or smaller. The processor 122 may be configured or programmed to change the number (division number) of the plurality of blocks 49 and/or the size of each block 49 (number of pixels in the vertical direction and/or the horizontal direction) in response to a manipulation made by the user or a command from an external device. Upon dividing the plan view image 44 into the plurality of blocks 49, the processor 122 executes the operation of step S215 in FIG. 37.

In step S215, the processor 122 executes the following operation on each of the plurality of blocks 49.
(i) While changing the direction of the plurality of scanning lines to a plurality of directions, executes a process of totaling the index values of the first pixels (pixels each having an index of the color that is equal to, or higher than, the threshold value) along each of the plurality of scanning lines to determine a total value, the process being executed for each of the plurality of directions.
(ii) Based on the relationship between the position of the scanning lines and the total value, determines one direction corresponding to the direction of the crop row among the plurality of directions.
(iii) Based on the relationship between the position of the scanning lines and the total value of the index values in the determined direction, determines the positions of the edge lines of the crop row.

FIG. 42 schematically shows an example of one block 49 in the plan view image 44. In this example, the block 49 includes three crop rows 12, and the direction of the crop rows 12 is parallel to the image vertical direction (v-axis direction). FIG. 42 shows a plurality of scanning lines (broken lines) S that are parallel to the image vertical direction. The processor 122 totals the index values of pixels that are located on the plurality of scanning lines S, for each scanning line, to obtain a total value of each scanning line S.

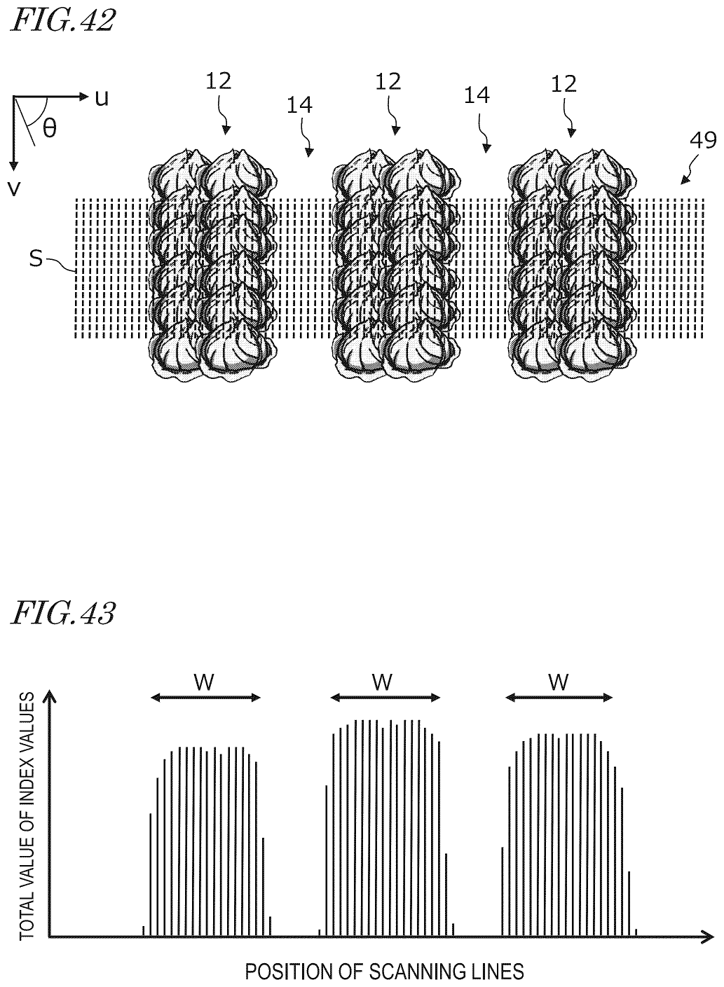

FIG. 43 schematically shows the relationship between the position of the scanning lines S and the total value of the index values, obtained for the block 49 shown in FIG. 42. In FIG. 43, the horizontal axis represents the positions of the scanning lines S along the image horizontal direction (u-axis direction). In the block 49, in the case where many of the pixels that are crossed by the scanning lines S are the first pixels belonging to the crop rows 12, such scanning lines S each have a large total value. By contrast, in the case where many of the pixels that are crossed by the scanning lines S are the second pixels (background pixels) belonging to the intermediate regions (work paths) 14 located between the crop rows 12, such scanning line S each have a small total value. Note that, according to the present example embodiment, the intermediate regions (work paths) 14 are masked, so that the second pixels have an index value of zero.

Regarding the relationship shown in FIG. 43 between the position of the scanning lines and the total value of the index values, there exist a plurality of concave regions where the total values are zero or near-zero, and a plurality of convex regions are distinguished from such concave regions. The concave regions correspond to the intermediate regions (work paths) 14, whereas the convex regions correspond to the crop rows 12. In the present example embodiment, predetermined positions on opposite sides sandwiching a peak of the total values in each of the convex regions, specifically, the positions of the scanning lines S having total values of a predetermined ratio (e.g., a value selected from the range of 60% or higher and 90% or lower) with respect to the peak of the total values are determined as the positions of the edge lines. In FIG. 43, the two ends of each of arrows W represent the positions of the edge lines of each crop row 12. In the example of FIG. 43, the positions of the edge lines of each crop row 12 are positions of the scanning lines S having a 80% value with respect to the peak of the total values of the respective crop row 12.

In the present example embodiment, the processor 122 totals the color index values of the crop row on each of the scanning lines S in a state where the second pixels are masked. With this method, wrong determinations caused by fallen leaves or weeds are reduced or prevented, and the robustness of the row detection can be enhanced.

FIG. 44 shows an example in which the crop rows 12 extend obliquely. In the image 40 acquired by the imager 120, the crop rows 12 may extend in directions that are inclined right or left, depending on the orientation of the agricultural machine 100. In the case where the plan view image 44 is generated from such an image through homography transformation, as in the example of FIG. 44, the direction of the crop rows 12 is inclined with respect to the image vertical direction (v-axis direction).

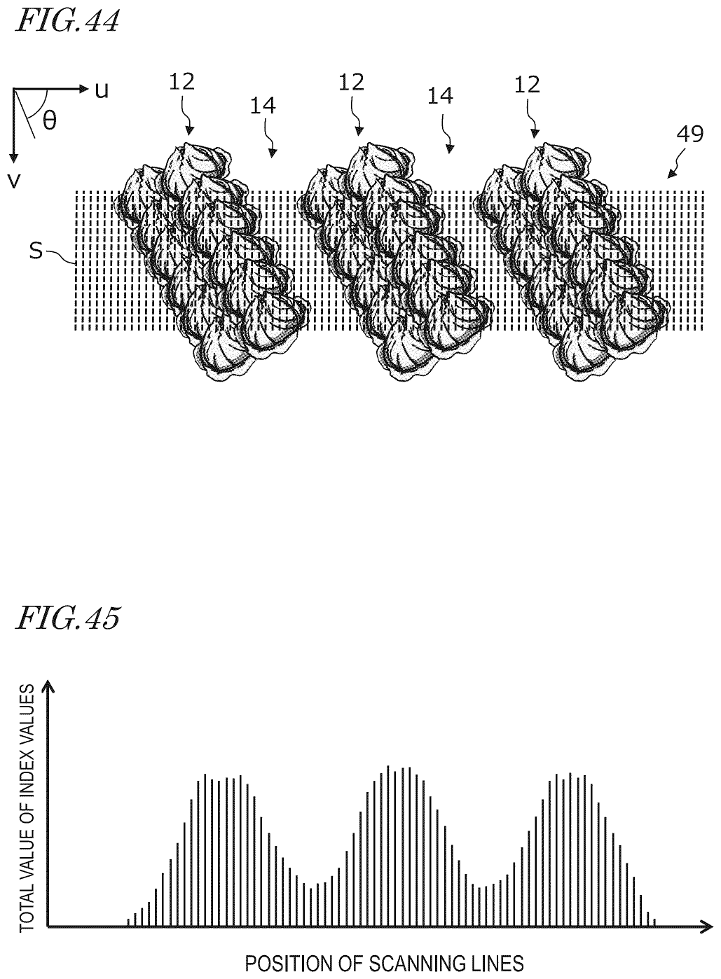

FIG. 44 also shows a large number of scanning lines S that are parallel to the image vertical direction. The processor 122 totals the index values of the pixels that are located on such a plurality of scanning lines S, for each scanning line S, to obtain a total value of each scanning line S. FIG. 45 schematically shows the relationship between the position of the scanning lines S and the total value of the index values, obtained for the block 49 of the plan view image shown in FIG. 44. From this relationship, it is impossible to clearly specify the edge lines of the crop rows 12.

In this situation, the processor 122 in the present example embodiment changes the direction (angle) of the scanning lines S to search for the direction, of the scanning lines S, that is parallel to the direction of the crop rows 12, for each of the blocks 49.

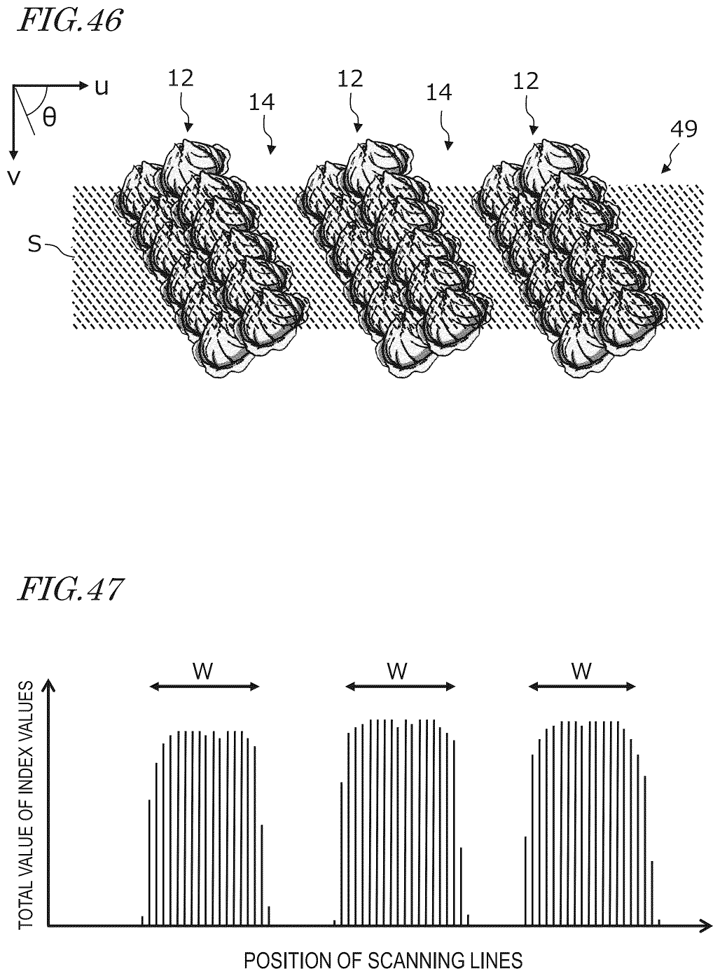

FIG. 46 shows an example of state where the direction of the scanning lines S and the direction of the crop rows 12 match each other. FIG. 47 schematically shows the relationship between the position of the scanning lines S and the total value of the index values, obtained for the block 49 of the plan view image shown in FIG. 46. The processor 122 changes the direction of the scanning lines S within a predetermined range to search for the direction by which the convex portions and the convex portions are distinguished from each other most clearly as shown in FIG. 47.

The process of searching for the direction, of the scanning lines S, that matches the direction of the crop rows 12 in the present example embodiment may also be executed in accordance with the flowchart shown in FIG. 26. The processor 122 in the present example embodiment executes the operations in steps S131 through S133 for each of the blocks 49.

In step S131, the processor 122 sets the direction (angle) of the scanning lines S. Herein, an angle in the clockwise direction with respect to the u axis in the image coordinate system is set as the angle θ (see FIG. 42, FIG. 44 and FIG. 46). The search for the angle θ may be done by, for example, setting a range of e.g., 60° to 120° and changing the angle by 1 degree. In this case, in step S131, 60°, 61°, 62°, . . . , 119° and 120° are set as the angle θ of scanning lines S.

In step S132, the processor 122 totals the index values of the pixels on plurality of the scanning line S extending in the direction of each angle θ to obtain data on the distribution of the total values of the index values in a direction perpendicular to the scanning lines. This data shows the relationship as shown in, for example, FIG. 43, FIG. 45 or FIG. 47, and shows different distributions for different angles θ.

In step S133, the processor 122 selects, from a plurality of distributions obtained for each of the angles θ, a distribution in which the boundaries between the concave regions and the convex regions are clear as shown in FIG. 47 and the crop rows 12 are distinguished from the intermediate regions 14 clearly, and determines the angle θ of the scanning lines S generating the distribution. The direction of this angle θ is treated as the direction in which the crop rows 12 extend in the block 49.

In step S134, the processor 122 determines the edge lines of each of the crop rows 12 based on the peak value of the total values in the distribution corresponding to the angle θ determined in step S133. As described above, the positions of the scanning lines S each having a total value that is, for example, 0.8 times the peak value may be adopted as the positions of the edge lines.

Note that, when searching for the direction (angle) of the scanning lines S, each time the angle θ is changed by the unit angle (e.g., 1 degree) within the range of search, the processor 122 may determine the distribution of the total values on the scanning line S at the angle θ. The processor 122 may calculate a feature amount (e.g., depth of the concave region/height of the convex region, differential value of the envelope, etc.) from the waveform of the distribution of the total values, and determine whether or not the direction of the crop rows 12 is parallel to the direction of the scanning lines S based on the feature amount.

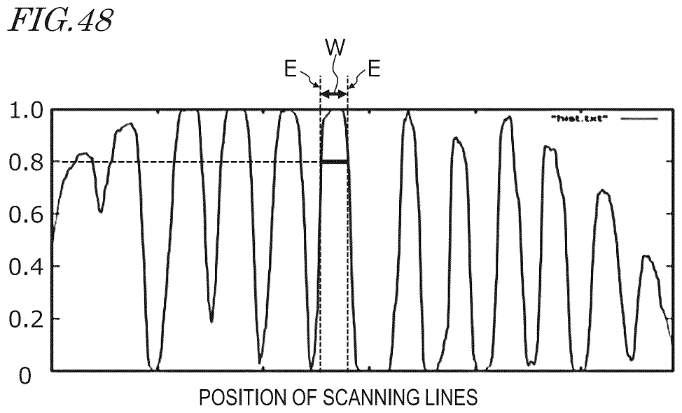

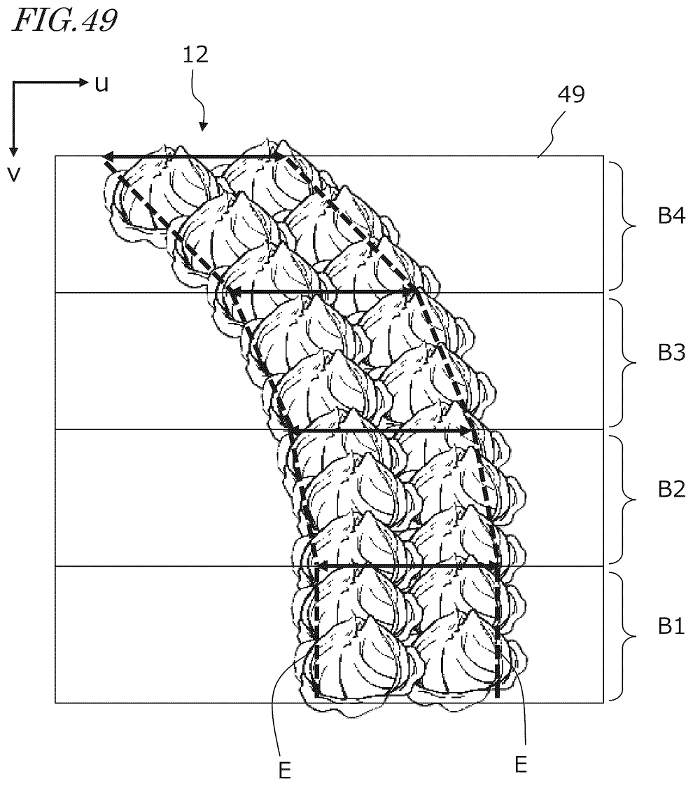

With the above-described method, influences of daylighting conditions that vary depending on the weather conditions such as forward light, backlight, sunny weather, cloudy weather, fog or the like or the time of work can be reduced or prevented, and thus the crop rows can be detected at high precision. Even if there is a change in the type of crops (cabbage, broccoli, radish, carrot, lettuce, Chinese cabbage, etc.), growth state (from seedling to a fully grown state), presence/absence of diseases, presence/absence of fallen leaves or weeds, or soil color, the crop rows can be detected with high robustness. FIG. 48 shows an example of distribution of the total values, which is created from one block 49 in the plan view image shown in FIG. 41. In this example, regarding the convex portion at the center of the distribution, the positions of the scanning lines having a total value that is 0.8 times the peak value of the convex portion are set as the positions of the edge lines E. In this distribution, as the position of the scanning lines becomes farther from the center in a leftward direction or a rightward direction, the peak of the convex portion becomes lower and broader. Reasons why this occurs are, as can be seen from the image in FIG. 41, that the degree of distortion of the image is small at the center of the plan view image but becomes larger in a direction away from the center, and that the black triangular regions at the two corners of the bottom side decreases the total values. In the case where the detection of the crop rows is used for the travel of the agricultural machine, the crop rows that should be detected accurately are the crops rows at the center or in the vicinity thereof in the image. Therefore, the distortion of the regions closer to the left and right ends of the plan view image can be ignored.

The process shown in FIG. 26 is executed for each of the plurality of blocks 49. That is, the processor 122 searches for the direction of the scanning directions S for each of the blocks 49, and determines the direction of the crop rows 12 and the positions of the edge lines. As a result, even in the case where the curved crop rows 12 are provided, the direction of the crop rows 12 and the positions of the edge lines can be accurately determined.

The process shown in FIG. 26 is executed on the blocks 49 sequentially, for example, from the block located closest to the agricultural machine 100 (lowermost block in the image) to the block located farthest from the agricultural machine 100 (uppermost block in the image). At this point, setting of the direction of the scanning lines S in a certain block may be adjusted based on the direction of the crop rows 12 and the positions of the edge lines of the crop rows 12 determined for the immediately previous block. For example, the division number of the plurality of blocks (i.e., number of blocks) is set as N (N is an integer of 3 or larger), and the plurality of blocks are labeled a first block, a second block, . . . and an N'th block sequentially from the lowermost block in the image. The processor 122 may change the direction of the plurality of scanning lines in the (i+1)th block within a predetermined range of angles centered around the direction of the crop rows determined for the i′th block (i is an integer of 1 or larger and N−1 or smaller). Alternatively, the processor 122 may determine a row region corresponding to the crop rows based on the determined positions of the edge lines for the i′th block, and set a start point of the plurality of scanning lines S in the (i+1)th block at a point in a range of the top end of the row region determined for the i′th block. Hereinafter, a specific example of this process will be described.

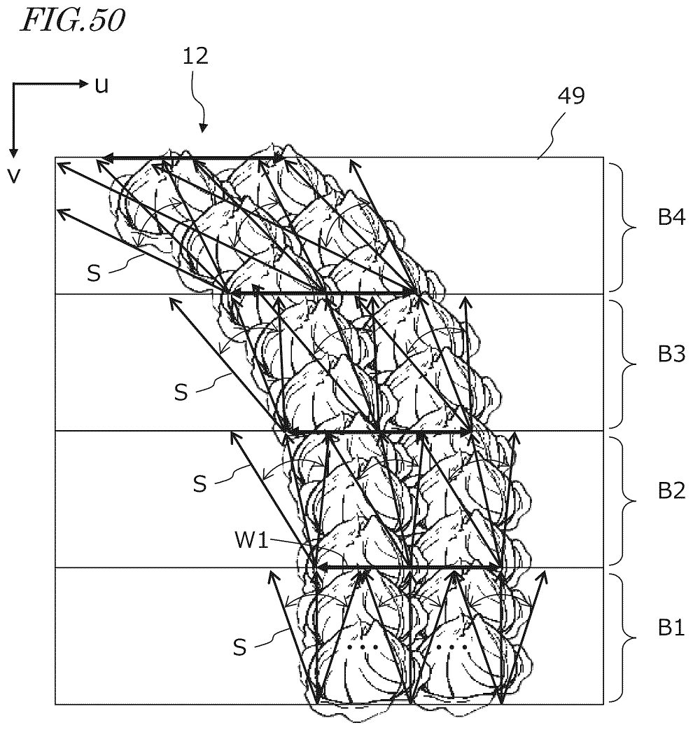

FIG. 49 shows an example of edge lines E of the crop row 12 extending in a curved manner. FIG. 49 shows four blocks 49. These blocks 49 include a first block B1, a second block B2, a third block B3 and a fourth block B4 sequentially from the block closest to the agricultural machine 100 (from the lowermost block in the image). In FIG. 49, the edge lines E of the crop row 12 in each of the blocks are represented with broken lines. A region between the two edge lines E is determined as a row region corresponding to the crop row 12. In FIG. 49, a range of the top end of the row region of each block is represented with a two-headed arrow.

FIG. 50 schematically shows an example of range of the scanning lines S in each block. In FIG. 50, the plurality of scanning lines S are represented with arrows. In this example, for the first block B1, the processor 122 changes the angle (direction) of the scanning lines S within a predetermined angle range (e.g., +15°, +30°, +45°, etc.) centered around the traveling direction of the agricultural machine 100 (v-axis direction). The processor 122 determines the direction of the crop row 12 and the positions of the edge lines in the first block B1 based on the distribution of the total values of the index values by the process described above. The processor 122 sets the region sandwiched by the two edge lines E as the row region in the first block B1. For the second block B2, the processor 122 changes the direction of the plurality of scanning lines S within a predetermined angle range centered around the direction of the crop row 12 determined for the first block B1. The processor 122 sets a start point of the plurality of scanning lines S in the second block B2 at a point in the range of a top end W1 of the row region determined for the first block B1. The processor 122 determines the distribution of the total values of the index values, and determines the direction of the crop row 12 and the positions of the edge lines in the second block B2 based on the distribution, by the process described above. After this, substantially the same process is executed for the third block B3 and the subsequent blocks.

With such processes, the processing amount required for the search for the direction of the scanning lines S can be decreased, and the time required for the detection of the row region in each block can be shortened. Note that in the case where the angle range for the search for the direction of the scanning lines S is set to a relative wide angle, the search may be performed in an angle range centered around the angle of the traveling direction (v-axis direction) of the agricultural machine 100, for all the blocks. For the second block B2 and the subsequent blocks, instead of determining the total value of the index values along a large number of scanning lines, the processor 122 may determine a total value of the index values along two parallel scanning lines starting from the two edge lines determined for the immediately previous block. With such a method also, the direction of the crop row and the edge lines in the second block B2 and the subsequent blocks can be estimated.

In the above-described example, the direction of the crop row and the edge lines in each block are determined based on the distribution of the total values that are determined by calculating the total value of the color index values of the crop row 12 for each scanning line. Any other method may be used. For example, the processor 122 may count the number of the first pixels each having an index value that is equal to, or higher than, the threshold value along a plurality of scanning lines parallel to each other, and may set the direction of the scanning lines, at which the total of the counted numbers is maximum, as the direction of the crop row 12 in the block. Based on the distribution of the counted numbers of the first pixels obtained by scanning performed in the direction determined in this manner, the processor 122 can determine the direction and the edge lines of the crop row 12 in the block.

Upon determining the direction in which the crop row 12 extends and the edge lines of the crop row 12 in each of the plurality of blocks, the processor 122 executes the operation of step S216 shown in FIG. 37.

In step S216, the processor 122 determines an approximation line of the crop row 12 based on the direction and the positions of the edge lines determined for each of the plurality of blocks. For example, the processor 122 may determine the center of the row region between the edge lines at the two ends of the detected crop row 12 (hereinafter, the center may be referred to as a “crop row center”) for each block, and may determine the approximation line of the crop row 12 based on the position of the center of the row region in each block. More specifically, the processor 122 may determine an approximation curve based on the position of the center of the row region in each of the plurality of blocks, and may determine the approximation curve as the approximation line of the crop row 12. Alternatively, the processor 122 may set a polyline, connecting the centers of the plurality of blocks, as the approximation line of the crop row 12.

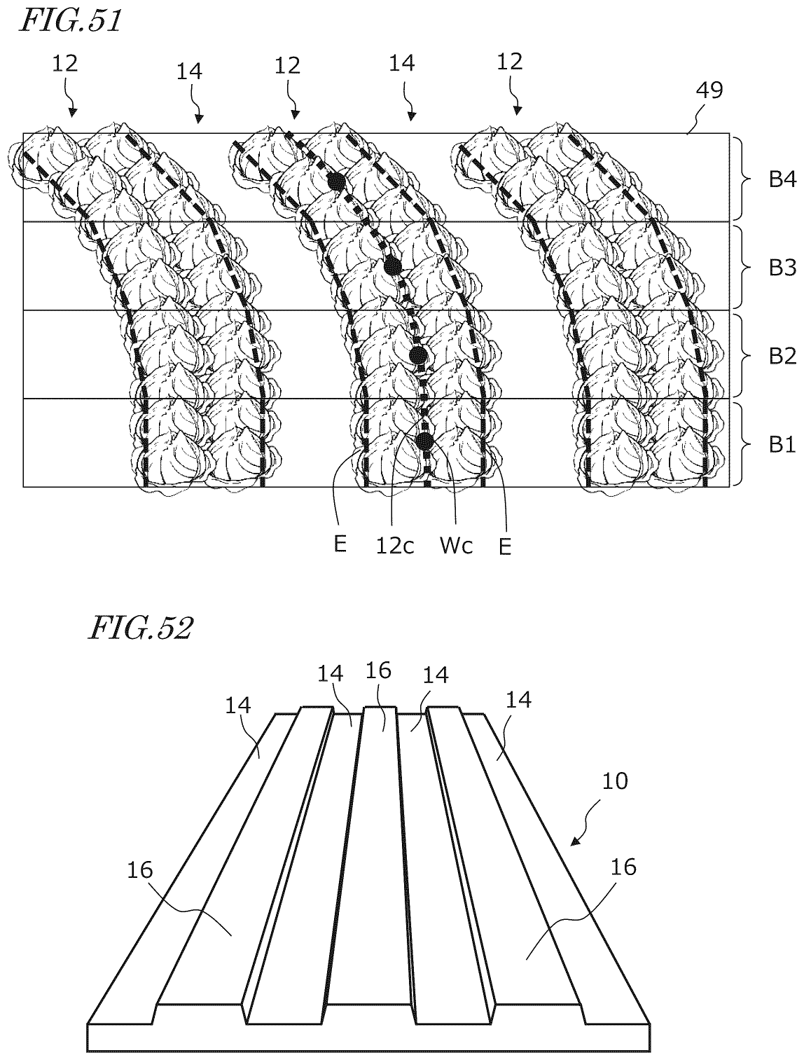

FIG. 51 shows an example of approximation line 12c of the crop row 12. In FIG. 51, the crop row center Wc in each block is represented with a black circle. In the example of FIG. 51, the crop row 12 at the center among the three crop rows 12 included in the image is the target of the row-following travel. Therefore, the approximation line 12c is determined only for the central crop row 12. The approximation line 12c may be determined for each of all the crop rows 12 in the image. The crop row center Wc in each block is located at the center of the region sandwiched between two edge lines at the two ends of the crop row 12. The approximation line 12c may be, for example, a curved line (e.g., a high-order curve such as a cubic curve or the like) determined so that the root mean square of the distances (errors) from the plurality of crop row centers Wc is minimum. Such an approximation line 12c corresponds to a curved line passing the center of the crop row 12 including a curved portion. The processor 122 may generate an approximation curve such as a Bezier curve or a spline curve as the approximation line of the crop row, based on the positions of the plurality of crop row centers Wc.

Once the processor 122 determines the approximation line 12c of the crop row 12, the processor 122, or a path generation device that has acquired information representing the position of the approximation line 12c from the processor 122, can determine a target path of the agricultural machine based on the position of the approximation line 12c. For example, the target path may be determined so as to overlap the approximation line 12c or so as to be parallel to the approximation line 12c. The target path may be generated so that the wheels of the agricultural machine 100 are maintained in the intermediate regions (work paths) 14. For example, the target path may be generated so that the central portion of each of the wheels in the width direction passes the center between the two edge lines located at the two ends of the intermediate region 14. With such a target path, even if the agricultural machine 100 deviates from the target path by several centimeters while traveling, the possibility that the tire enters the crop row can be decreased.

In the present example embodiment, an enhanced image in which the crop region is enhanced is generated from the time-series color images acquired from the imager 120, and then homography transformation is performed. Alternatively, the step of generating the enhanced image may be performed after the homography transformation. For example, homography transformation may be performed on the time-series color images acquired from the imager 120 to generate a plan view image, and an enhanced image in which the crop region is enhanced is generated from the plan view image.

The above-described row detection methods are implemented by a computer, and may be executed by causing the computer to execute predetermined operations.

Example 2 of the row detection system according to the present example embodiment will be described. In this present example embodiment, a ridge is detected as the “row detection”.

FIG. 52 is a perspective view schematically showing rows of ridges 16 provided on the ground surface 10. “Ridges” are places where plants for serial sowing or serial planting are to be planted, in which earth is raised high at intervals to result in bumps that extend essentially linearly. The ridges 16 may each have a cross-sectional shape, taken perpendicularly to the direction in the ridge 16 extends, that is generally trapezoidal or semicircular. FIG. 52 schematically shows the ridges 16 having a trapezoidal cross-section. Actual ridges do not have such a simple shape as shown in FIG. 52. What exists between two adjacent ridges 16 is an intermediate region 14, which is called an “interridge land”. Such intermediate regions 14 function as work paths. Crops may be planted in the ridges 16, or only the soil may be exposed at the entirety of the ridges 16 with no crops being planted. Each of the ridges 16 may be covered with a mulching sheet.

The height, width, and intervals of the ridge 16 do not need to be uniform, but may vary from place to place. Generally, the height of the ridge 16 is a difference in height between the ridge and the interridge land. In the present specification, the “height” of a ridge 16 is defined by a distance to a top surface of the ridge 16 from the aforementioned reference plane Re.

In the example of FIG. 52, the edge lines of the ridges 16 are clear. However, in actuality, the ridges 16 are portions of the ground surface 10 that are continuous from the intermediate regions 14, and have various “cross-sectional shapes” as described above. Therefore, the boundaries between the ridges 16 and the intermediate regions 14 are not always clear. In an example embodiment of the present disclosure, the edge lines of the ridges 16, i.e., the boundaries between the ridges 16 and intermediate regions 14, are defined as positions that are located on opposite sides of a peak of each of ridges 16 and have a height of a predetermined ratio with respect to the height of the peak. The positions of the edge lines are, for example, positions having a height that is 0.8 times the height of the peak of each ridge 16.

As shown in FIG. 30, the row detection system 1000 in this example also includes the imager 120 and the processor 122 executing image processing on the time-series images acquired from the imager 120. The hardware configuration of the processor 122 is the same as that of the processor 122 in example 1.

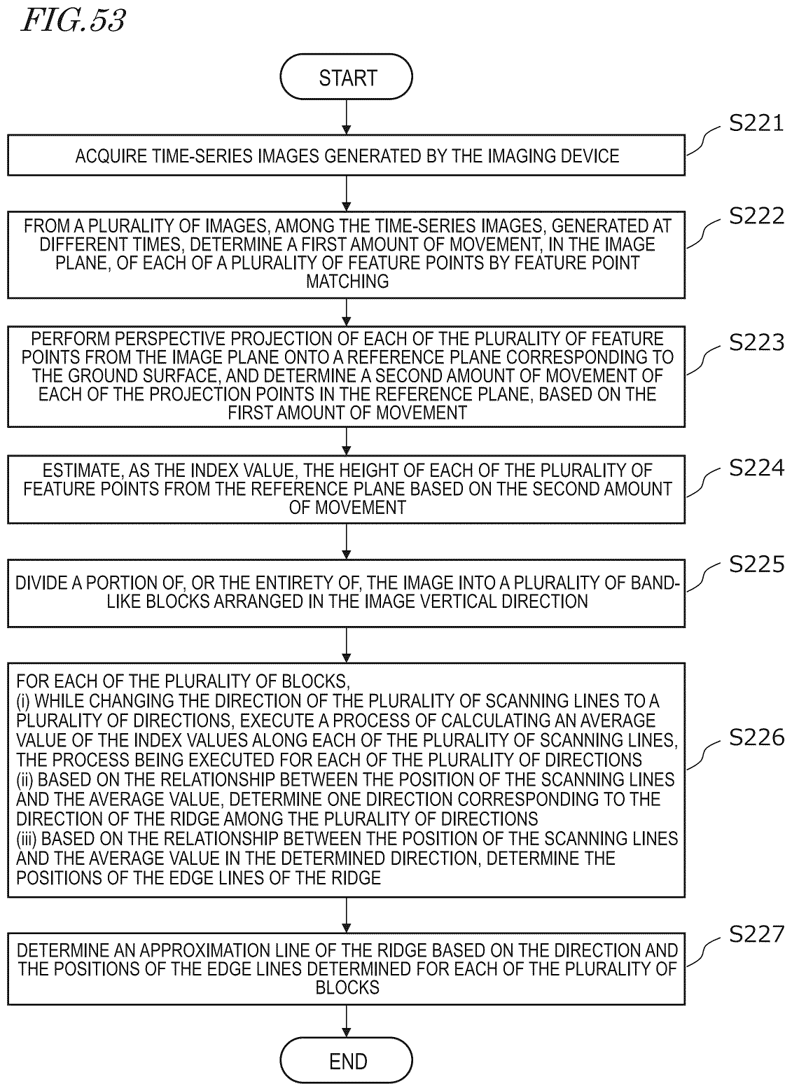

FIG. 53 is a flowchart showing operations of the processor 122. The processor 122 is configured or programmed to execute the operations of steps S221 though S227 shown in FIG. 53. Hereinafter, the operation of each step will be described.

In step S221, the processor 122 acquires the time-series images generated by the imager 120. This operation is substantially the same as that of step S211 shown in FIG. 37. The time-series images form an aggregation of images that are chronologically acquired by the imager 120 through image capturing. The time-series images do not need to be color images, but may be color images. In the case of outputting time-series color images, the processor 122 may apply gray-scale processing to a given color image as a target of processing, among the time-series color images. As described above in example embodiment 1, each of the images is formed of a frame-by-frame group of pixels. The frame rate is also as described above in example embodiment 1.

In step S222, the processor 122 determines a first amount of movement, in the image plane, of each of a plurality of feature points by feature point matching, from a plurality of images, among the time-series images, generated at different times.

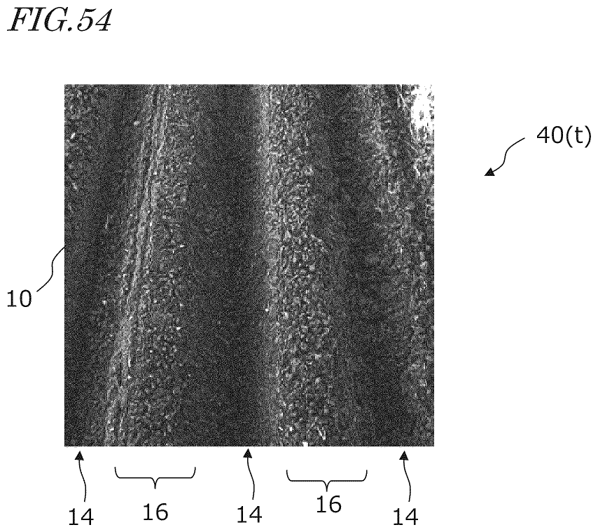

FIG. 54 shows a one-frame image 40(t) among time-series images acquired, at time t, by the imager (in this example, a monocular camera) 120 mounted on the agricultural machine 100. In this example, crops are not planted in the ridges 16. The data on the image 40(t) captured by the monocular camera does not include depth information. Therefore, it is impossible to learn, from this single image 40(t), the difference in height between the ridges 16 and the intermediate regions 14.

Not only at time t but also at other points in time, e.g., time t+1, t+2, t+3, . . . , the imager 120 chronologically acquires an image 40(t+1), an image 40(t+2), and an image 40(t+3), . . . . Each of the plurality of images that are chronologically acquired by the imager 120 during the travel of the agricultural machine 100 may include the same region of the ground surface 10 in a partially overlapping manner.

In the present example embodiment, the processor 122 extracts feature points from the image 40(t), the image 40(t+1), . . . . A “feature point” is a point having a pixel(s) of a luminance value or a color that is distinguishable from those of the surrounding pixels, such that the position(s) of the pixel(s) can be specified within the image. By extraction of the feature points in the image, a plurality of images that have captured the same scene can be associated with one another. In a region of the image where the luminance value and color are uniform, it is difficult to distinguish any pixel in that region from the surrounding pixels. Therefore, a feature point is selected from a region in which the luminance value or the color locally changes within the image. A feature point is a pixel or a group of pixels that has a “local feature amount”.

In the present example embodiment, a purpose of extracting the feature points is to perform feature point matching to measure an amount of movement of each of the feature points from the time-series images 40(t), 40(t+1), . . . that are acquired while the agricultural machine 100 is moving. The feature point extraction that is suitable for such feature point matching can be performed by the processor 122 through image processing. Examples of feature-point extraction algorithms based on image processing include SIFT (Scale-invariant feature transform), SURF (Speed-Upped Robust Feature), KAZE, and A-KAZE (ACCELERATED-KAZE). Like SIFT or SURF, KAZE and A-KAZE are feature-point extraction algorithms that are highly robust because of the strength thereof in scaling, rotation, and changes in lighting. Unlike SIFT and SURF, KAZE and A-KAZE do not employ a Gaussian filter. Therefore, KAZE and A-KAZE are unlikely to be affected by rotation, scaling, and changes in luminance values, and are able to extract feature points even from a region of the image where changes in the luminance value and the color are relatively small. This makes it easy to extract feature points that are suitable for feature point matching, even from an image of the soil surface or the like. As compared to KAZE, A-KAZE is advantageous in having high robustness and in being capable of enhancing the processing speed. In the present example embodiment, the A-KAZE algorithm is used to extract the feature points. Note that the algorithm for the feature point matching is not limited to those in this example.

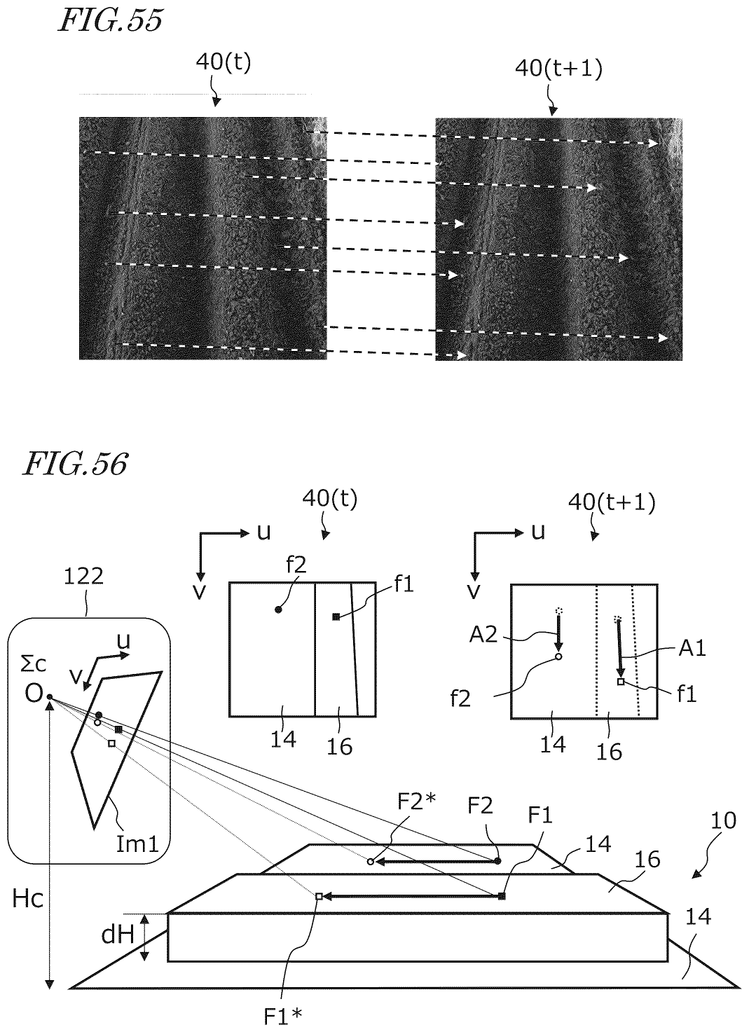

FIG. 55 schematically shows the correspondence of feature points between the image 40(t) acquired from the imager 120 at time t and the image 40(t+1) acquired from the imager 120 at time t+1. Herein, the time interval between time t and time t+1 may be e.g., not shorter than 100 milliseconds and not longer than 500 seconds.

A plurality of feature points extracted from the image 40(t) and a plurality of feature points in the image 40(t+1) respectively corresponding to such a plurality of feature points are associated with each other by a feature point matching algorithm. In FIG. 55, 8 pairs of feature points corresponding to each other are connected by arrows. In the present example embodiment, the processor 122 is able to extract, e.g., hundreds or thousands of feature points from each of the image 40(t) and the image 40(t+1) by A-KAZE. The number of feature points to be extracted may be determined based on the number of images to be processed in one second.

After performing such feature point matching, the processor 122 determines the amount of movement (first amount of movement) in the image plane, for each of the plurality of feature points. It is not that the first amount of movement determined from the two images 40(t) and 40(t+1) has one common value for all the feature points. Depending on the physical difference in height between the feature points on the ground surface 10, the first amount of movement exhibits different values.

FIG. 56 is a perspective view schematically showing the movement of the ridge 16 and the intermediate region (work path) 14 appearing in the images acquired by the imager 120. FIG. 56 also schematically show the image 40(t) and the image 40(t+1). FIG. 56 schematically shows how a point F1 on the ridge 16 and a point F2 on the intermediate region (interridge land or work path) 14 horizontally move leftward in the figure. This horizontal movement is a relative motion that occurs by the imager 120 secured to the agricultural machine 100 moving rightward together with the agricultural machine 100. In FIG. 56, for simplicity, the origin O of the camera coordinate system Σc in the imager 120 is kept stationary, whereas the ground surface 10 moves leftward. The origin O of the camera coordinate system Σc has a height Hc. In the illustrated example, the ridge 16 is a simplified ridge having a height dH.

In the image 40(t) of FIG. 56, a feature point f1 of the ridge 16 and a feature point f2 of the intermediate region 14 are shown. These feature points f1 and f2 are examples of a large number of feature points which are extracted by the feature-point extraction algorithm such as A-KAZE or the like. In the image 40(t+1), the feature points f1 and f2 after the movement are shown. Also in the image 40(t+1), for referencing sake, arrow A1 indicating the movement of the feature point f1 and arrow A2 indicating the movement of the feature point f2, during the period of time from time t to t+1, are shown. The length of arrow A1 (corresponding to the first amount of movement) is longer than the length of arrow A2 (corresponding to the first amount of movement). As can be seen, the amount of movement of a feature point in the image (first amount of movement) differs depending on the distance from the origin O of the camera coordinate system Σc to the corresponding point in the subject. This is caused by the geometric nature of perspective projection.

The feature points f1 and f2 in the image 40(t) are, respectively, points resulting through perspective projection of the points F1 and F2 on the ground surface 10, which is a subject, onto the image plane Im1 of the imager 120. Similarly, the feature points f1 and f2 in the image 40(t+1) are, respectively, points resulting through perspective projection of the points F1* and F2* on the ground surface 10, which is a the subject, onto the image plane Im1 of the imager 120. The center point of the perspective projection is the origin O of the camera coordinate system Σc of the imager 120. Since the perspective projection has a bidirectional relationship, the points F1 and F2 can be considered to be points resulting through perspective projection of the feature points f1 and f2 in the image 40(t+1) onto the ground surface 10. Similarly, the points F1* and F2* can be considered to be points resulting through perspective projection of the feature points f1 and f2 in the image 40(t) onto the ground surface 10.

As shown in FIG. 56, from time t to time t+1, the point F1 on the ridge 16 moves to the position of the point F1*, and the point F2 on the intermediate region 14 moves to the position of the point F2*. The distances of these movements are each equal to the distance (distance of horizontal movement) traveled by the agricultural machine 100 from time t to time t+1. By contrast, the amounts of movement of the feature points f1 and f2 on the image plane Im1 of the imager 120 are different from each other.

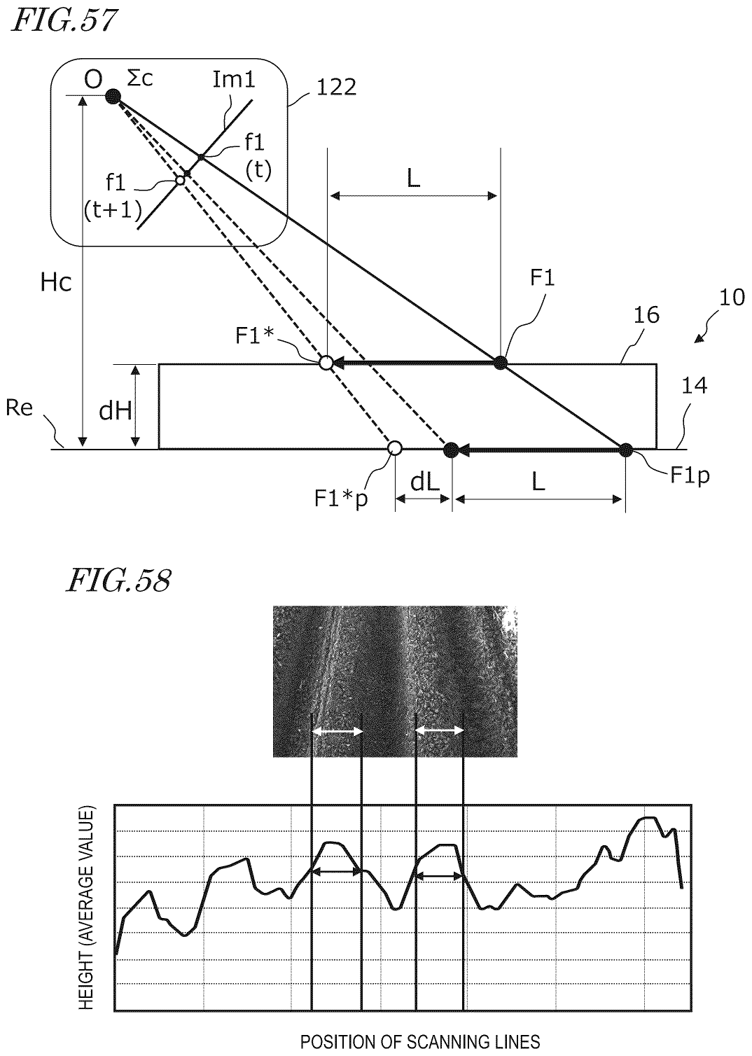

FIG. 57 schematically shows the relationship between the amount of movement (L) of the point F1 on the ridge 16, corresponding to the feature point f1 on the image plane Im1 of the imager 120, and the amount of movement (second amount of movement L+dL) of a point (projection point) F1p projected onto the reference plane Re. In this example, the height of the reference plane Re is matched to the height of the intermediate region (interridge land) 14, while the ridge 16 has the height dH.

As can be seen from FIG. 57, the point F1 on the ridge 16 has moved leftward by a distance (amount of movement) L that is equal to the traveled distance of the agricultural machine 100; whereas the amount of movement (second amount of movement) of the point (projection point) F1p resulting through the perspective projection onto the reference plane Re is expressed as L+dL, which is longer than L. This is because the point F1 on the ridge 16 is at a position higher than the reference plane Re and is closer to the center of the perspective projection (origin O of the camera coordinate system). In correspondence with this excess length dL, the amount of movement (first amount of movement) on the image plane Im1 is increased.

From the ratio (homothetic ratio) between lengths of the sides of two homothetic triangles shown in FIG. 57, the following equation is derived.

$$\frac{Hc}{L + dL} = \frac{( Hc - dH )}{L} \qquad [ eq . 6 ]$$

The above equation is transformed to give the following equation.

$$dH = Hc ( 1. - \frac{L}{L + dL} ) \qquad [ eq . 7 ]$$

In order to estimate the size of the bump-dent difference on the ground surface 10 based on the above equation, the processor 122 according to the present example embodiment executes the operation of step S223. That is, the processor 122 performs perspective projection of each of the plurality of feature points from the image plane onto the reference plane Re corresponding to the ground surface 10 and determines and the second amount of movement (L+dL) of each projection point in the reference plane Re based on the first amount of movement. The distance L in the above equation can be acquired by measuring the traveled distance of the agricultural machine 100. Moreover, the height Hc of the origin O of the camera coordinate system from the reference plane Re is known. Therefore, once the second amount of movement (L+dL) becomes known, the height dH of the ridge 16 can be calculated from eq. 7. The second amount of movement (L+dL) can be determined from the first amount of movement.

After executing the process of step S223, the processor 122 executes the process of step S224.

In step S224, the processor 122 estimates the height dH of each feature point from the reference plane Re as the index value based on the second amount of movement (L+dL) of each feature point, and detects the ridge 16 on the ground surface 10.

In the present example embodiment, given the height Hc of the center point O of perspective projection from the reference plane Re, the height dH of the plurality of feature points from the reference plane Re, the second amount of movement L of a feature point (having the height dH of zero) on the reference plane Re, and the second amount of movement L+dL of a feature point having the height dH larger than zero, the height of each feature point can be determined as Hc·(1−L/(L+dL)). For determining the second amount of movement based on the first amount of movement, homography transformation can be used. Specifically, the aforementioned inverse H1⁻¹ of the transformation matrix H1 may be used to transform the coordinates of each feature point on the image plane Im1 into coordinates of the corresponding point on the reference plane Re. Therefore, first, the processor 122 determines the first amount of movement from the coordinates of each feature point on the image plane Im1 before and after the movement. Next, the processor 122 transforms the coordinates of each feature point into coordinates of the corresponding point on the reference plane Re through homography transformation, and then can determine the second amount of movement from the coordinates on the reference plane Re before and after the movement.

$$( \begin{matrix}X \\ Y \\ 1\end{matrix} ) = H {1}^{- 1} ( \begin{matrix}u \\ v \\ 1\end{matrix} ) \qquad [ eq . 8 ]$$

As a result of the above-described process, an estimated value of the height from the reference plane Re can be obtained for each of the large number of feature points in the image. A two-dimensional map of such estimated values of height represents a distribution of differences in height of the bumps and dents existing on the ground surface 10. After estimating the height of each feature point from the reference plane, the processor 122 executes the process of step S225 shown in FIG. 53.

In step S225, the processor 122 divides a portion of, or the entirety of, the image (time-series images or a plan view image transformed from the time-series images) into a plurality of band-shaped blocks arranged in the image vertical direction. The process of this step is substantially the same as that in step S214 shown in FIG. 37. Note that the division into the plurality of blocks may be performed between step S221 and step S222. In this case, the processes in steps S222 through S224 may be performed only on the region of interest defined by the plurality of blocks.

In step S226, the processor 122 executes the following processes for each of the plurality of blocks.
(i) While changing the direction of the plurality of scanning lines to a plurality of directions, executes a process of calculating an average value of the index values along each of the plurality of scanning lines parallel, the process being executed for each of the plurality of directions.
(ii) Based on the relationship between the position of the scanning lines and the average value, determines one direction corresponding to the direction of the ridge among the plurality of directions.
(iii) Based on the relationship between the position of the scanning lines and the average value in the determined direction, determines the positions of the edge lines of the ridge.

As described above regarding example embodiment 1, in the present example embodiment also, a plurality of scanning lines are set in each block. Note that in the present example embodiment, the average value of the height of the feature points is calculated along each scanning line. Moreover, the direction (angle) of the scanning lines is changed, so that the direction in which the ridge extends can be determined from the distribution of the average values of the height of the feature points. Once the direction in which the ridge 16 extends is determined, the edge lines of the ridge 16 can be determined by a method substantially the same as the method for determining the edge lines of the crop row 12.

FIG. 58 shows the relationship between the average value of the height of the feature points on each of the scanning lines parallel to the direction in which the ridges extend and the position of the scanning lines. In the graph of FIG. 58, the horizontal axis represents the position of the scanning lines, whereas the vertical axis represents the average value of the height of the feature points on each scanning line. As shown in the graph, the average value of the height repetitively increases and decreases as the position of the scanning line moves from left to right. A position at which the average value of the height exhibits a peak corresponds to the center of each ridge. Note that the curve indicating the average value of the height forms a trough between two adjacent peaks. This trough corresponds to the center or the vicinity thereof of the intermediate region (interridge land or work path) 14.

The graph showing the distribution of the average values of the height as shown in FIG. 58 changes in accordance with the direction of the scanning lines. The processor 122 determines, as the direction in which the ridges extend, the direction of the scanning lines at which the peak and the trough of the average values of the height are distinguished from each other most clearly, for each of the blocks. The processor 122 determines the positions of the edge lines of the ridges based on the distribution of the average values of the height in the determined direction. For example, the processor 122 determines, as the edge lines of the ridge, the positions that are on opposite sides of the peak of the average values of the height and have a height of a predetermined ratio with respect to the peak (e.g., 0.8 times the height of the peak). FIG. 58 shows, above the graph, white arrows representing the positions of the edge lines of the two ridges in the image.

After determining the positions of the edge lines of the ridges, the processor 122 executes the process of step S227 shown in FIG. 53. The process of step S227 is substantially the same as the process of step S216 shown in FIG. 37.

According to the present example embodiment, the row detection does not depend on the “color of the crop row”, and therefore, has an advantage of not being susceptible to the type of crops or the daylighting conditions. Not only tall ridges, e.g., “high ridges” that are often made for growing vegetables, but also relatively low ridges having a height in the range of 5 to 10 centimeters, for example, can be detected.

The processor 122 may perform the detection of the crop rows in example 1 and the detection of the ridges in example 2 simultaneously or selectively. In the case where crops are planted on the ridges, the processor 122 may function as the crop row detection system in example 1 and the ridge detection system in example 2. In this case, the edge lines of the crop row and the edge lines of the ridge are determined. The target path of the agricultural machine 100 can be determined based on the edge lines of both of, or either one of, the crop row and the ridge.

The processor 122 may calculate a detection reliability for each of the crop row detection and the ridge detection. The reliability of the crop row detection may be determined based on, for example, the distribution of the total values of the index values shown in FIG. 48, the magnitude of the peak values or the like. The reliability of the ridge detection may be determined based on, for example, the magnitude of the difference between the maximum value and the minimum value in the height distribution shown in FIG. 58, etc. For instance, in the case where a target path is generated based on the edge lines of the detected crop row and the agricultural machine is traveling along the target path, it may possibly occur that the crop row detection is made impossible or that the reliability thereof has decreased to a level below a predetermined level. At a site where such an incident has occurred, the ridge detection may be executed in the background so that the target path is generated based on the edge lines of the ridge.

In the case where the processor 122 may perform both of the crop row detection and the ridge detection, one of, or both of, the crop row detection and the ridge detection may be performed while being selected by the operator.

In the present example embodiment also, the method for detecting the crop rows or the ridges formed in a field is not limited to the one described in the above example, and the crop row detection and the ridge detection can be performed by use of any of a wide variety of known algorithms. For example, a method of linearly approximating a crop row described in Japanese Patent No. 2624390 granted to the present Applicant is usable. A method of detecting a line formed by steps or trenches of a ridge described in Japanese Laid-Open Patent Publication No. 2016-146061 is usable.

Now, an example configuration of the agricultural machine including the row detection system according to the present example embodiment will be described.

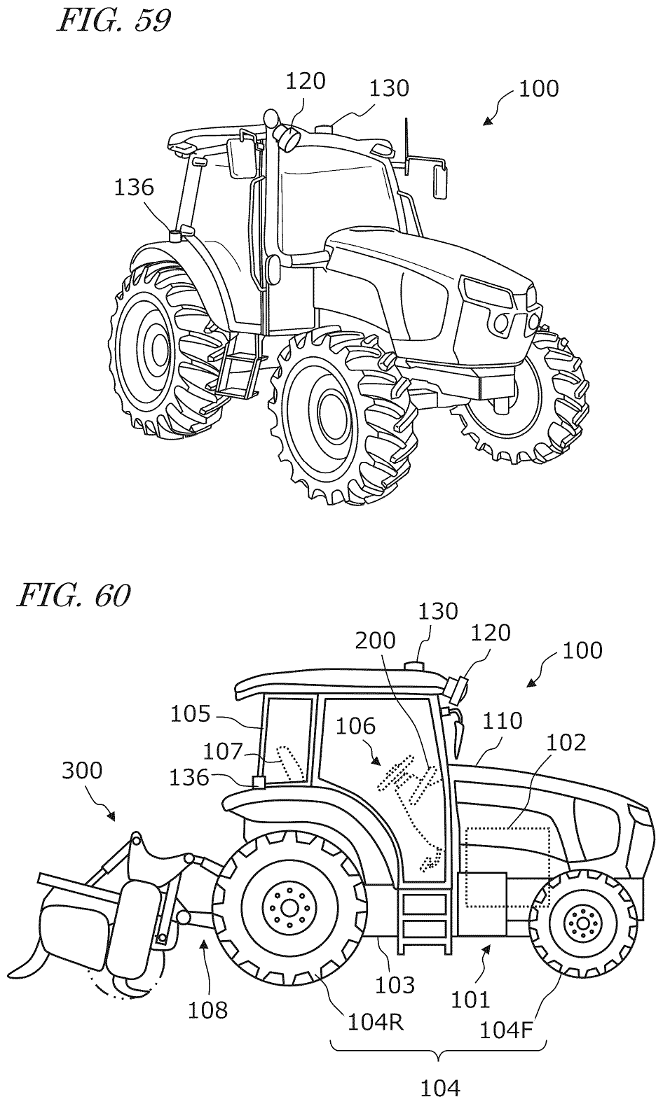

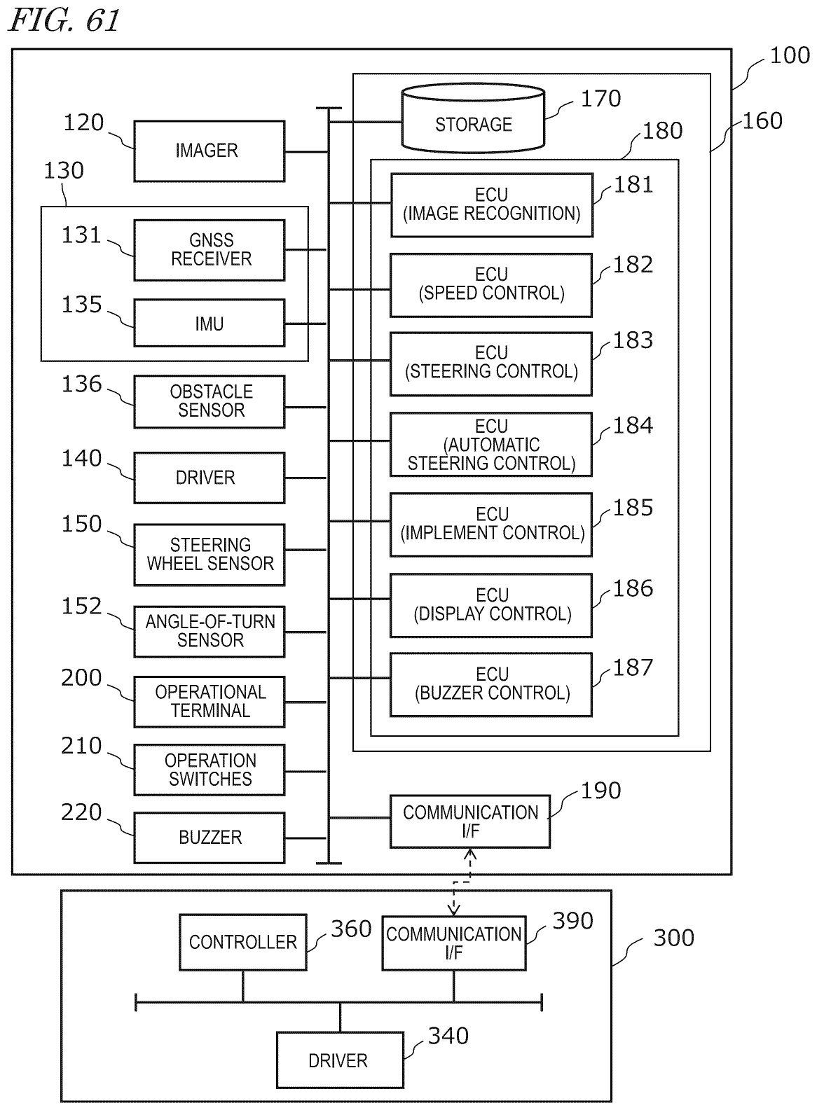

FIG. 59 is a perspective view showing an example of external appearance of an agricultural machine 100 according to the present example embodiment. FIG. 60 is a side view of an example of the agricultural machine 100 in a state where the implement 300 is attached thereto. FIG. 61 is a block diagram showing an example of general configuration of the agricultural machine 100 and the implement 300. Unlike the agricultural machine 100 shown in FIG. 27 through FIG. 29, the agricultural machine 100 shown in FIG. 59 through FIG. 61 includes one imager 120 instead of the two imagers 120 and 121. Except for this, the agricultural machine 100 shown in FIG. 59 through FIG. 61 includes substantially the same component elements as those of the agricultural machine 100 shown in FIG. 27 through FIG. 29.

Through the action of the plurality of ECUs shown in FIG. 61, the controller 180 realizes driving via manual steering or automatic steering. During usual automatic steering driving, the controller 180 is configured or programmed to control the drive device 140 based on the position of the agricultural machine 100 as measured or estimated by the positioning device 130 and the target path stored on the storage 170. As a result, the controller 180 causes the agricultural machine 100 to travel along the target path. By contrast, in the row-following travel control mode where the travel is done along the rows, the ECU 181 for image recognition determines the edge lines of the crop row or the ridge from the crop row or the ridge detected by the above-described process based on the image acquired by the imager 120, and generates a target path based on the edge lines. The controller 180 performs an operation in accordance with this target path.

In the above-described example embodiments, the agricultural machine 100 may be an unmanned work vehicle which performs self-driving. In that case, component elements which are only required for human driving, e.g., the cabin, the driver's seat, the steering wheel, and the operational terminal, do not need to be provided in the agricultural machine 100. The unmanned work vehicle may perform operations substantially the same as the operations in each of the above-described example embodiments via autonomous driving, or by remote manipulations by an operator.

A system that provides the various functions according to each of the example embodiments can be mounted on an agricultural machine lacking such functions as an add-on. Such a system may be manufactured and sold independently from the agricultural machine. A computer program for use in such a system may also be manufactured and sold independently from the agricultural machine. The computer program may be provided while being stored on a computer-readable, non-transitory storage medium, for example. The computer program may also be provided through downloading via telecommunication lines (e.g., the Internet).

In the above-described example embodiments, the agricultural machine 100 is a work vehicle for agriculture, but the agricultural machine 100 is not limited to the work vehicle, The agricultural machine 100 may be, for example, an unmanned flying object (e.g., drone) for agriculture. The row detection system according to an example embodiment of the present disclosure can be mounted on such an unmanned flying object to detect a row region such as a crop row or a ridge on the ground surface. Such an unmanned flying object can perform agricultural work of, for example, spraying drugs or fertilizers while flying along the detected row region.

The example embodiments and modifications thereof according to an example embodiment of the present disclosure can be applied to agricultural machines, such as, for example, vehicles for crop management, vegetable transplanters, tractors, or agricultural drones.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A row detection system, comprising:
a first imager attached to an agricultural machine to capture an image of a ground surface to generate a first image of a first region of the ground surface;
a second imager attached to the agricultural machine to capture an image of the ground surface to generate a second image of a second region of the ground surface partially overlapping the first region; and
a processor configured or programmed to:
execute image processing on the first image and the second image;
execute a process including planar panorama image synthesis based on the first image and the second image to generate a synthesized image; and
detect a crop row or a ridge on the ground surface based on the synthesized image.

2. The row detection system of claim 1, wherein
the first imager is attached to a first position on the agricultural machine;
the second imager is attached to a second position on the agricultural machine rearward of the first position; and
the second region is located rearward with respect to the first region.

3. The row detection system of claim 2, wherein
the first imager is attached so as to face in an obliquely forward and downward direction; and
the second imager is attached so as to face in a downward direction.

4. The row detection system of claim 1, wherein
the agricultural machine is a work vehicle; and
an image capturing area of each the first imager and the second imager includes a portion of the ground surface located below the work vehicle.

5. The row detection system of claim 4, wherein the image capturing area of each of the first imager and the second imager includes at least a portion of wheels of the work vehicle.

6. The row detection system of claim 4, wherein the image capturing area of each of the first imager and the second imager is longer in a front-rear direction than in a left-right direction of the work vehicle.

7. The row detection system of claim 1, wherein the processor is configured or programmed to:
transform the first image into a first plan view image as seen from above the ground;
transform the second image into a second plan view image as seen from above the ground; and
synthesize the first plan view image and the second plan view image to generate the synthesized image.

8. The row detection system of claim 1, wherein
the first image, the second image and the synthesized image are color images; and
the processor is configured or programmed to:
generate, from the synthesized image, a synthesized enhanced image in which a color of the crop row is enhanced; and
detect the crop row on the ground surface based on the synthesized enhanced image.

9. The row detection system of claim 1, wherein
the first image and the second image are color images; and
the processor is configured or programmed to:
generate from the first image, a first enhanced image in which a color of the crop row is enhanced;
generate, from the second image, a second enhanced image in which the color of the crop row is enhanced;
generate, from the first enhanced image, a first plan view image, as seen from above the ground, in which pixels are classified into pixels each having a color index value of the crop row that is equal to, or higher than, a threshold value and pixels each having a color index value of the crop row that is lower than the threshold value;
generate, from the second enhanced image, a second plan view image, as seen from above the ground, in which pixels are classified into pixels each having a color index value of the crop row that is equal to, or higher than, the threshold value and pixels each having a color index value of the crop row that is lower than the threshold value;
synthesize the first plan view image and the second plan view image to generate the synthesized image; and
detect the crop row on the ground surface based on the synthesized image.

10. The row detection system of claim 1, wherein
the first image and the second image each include time-series images; and
the processor is configured or programmed to:
repeat, at a predetermined frame rate, a process of generating the synthesized image based on the first image and the second image;
determine a first amount of movement, in an image plane, of each of a plurality of feature points by feature point matching, from a plurality of the synthesized images generated at different times;
perform perspective projection of each of the plurality of feature points from the image plane onto a reference plane corresponding to the ground surface, and determine a second amount of movement, in the reference plane, of each of projection points based on the first amount of movement; and
estimate a height of each of the plurality of feature points from the reference plane based on the second amount of movement to detect the ridge on the ground surface.

11. The row detection system of claim 7, wherein the processor is configured or programmed to generate the synthesized image by a synthesis process including a process of determining a weighted average of a pixel value of each of pixels in a first overlapping region and a pixel value of each of pixels in a second overlapping region respectively corresponding to the each of the pixels in the first overlapping region, the weighted average being determined in accordance with a position of each of the pixels, the first overlapping region being a region of the first plan view image that overlaps the second plan view image, and the second overlapping region being a region of the second plan view image that overlaps the first plan view image.

12. The row detection system of claim 1, wherein the processor is configured or programmed to:
acquire a first reference image generated by the first imager capturing an image of a specific subject located on the ground surface a second reference image generated by the second imager capturing an image of the subject;
extract a plurality of feature points of the subject from each of the first reference image and the second reference image; and
generate or update a transformation matrix usable for the planar panorama image synthesis based on the relationship between positions of the plurality of feature points in the first reference image and positions of the plurality of feature points in the second reference image.

13. The row detection system of claim 1, wherein the processor is configured or programmed to determine a target path of the agricultural machine based on a position of the detected crop row or the detected ridge, and output information representing the target path.

14. An agricultural machine, comprising:
the row detection system of claim 1; and
an automatic steering device configured or programmed to control a traveling direction of the agricultural machine based on a position of the crop row or the ridge detected by the row detection system.

15. The agricultural machine of claim 14, further comprising a traveling device including a wheel responsible for steering; wherein
the automatic steering device is configured or programmed to control a steering angle of the wheel responsible for steering, based on the position of the crop row or the ridge detected by the row detection system.

16. A row detection method to be implemented by a computer, the row detection method causing the computer to execute:
acquiring a first image from a first imager attached to an agricultural machine to capture an image of a ground surface to generate the first image of a first region of the ground surface;
acquiring a second image from a second imager attached to the agricultural machine to capture an image of the ground surface to generate the second image of a second region of the ground surface partially overlapping the first region;
executing a process including planar panorama image synthesis based on the first image and the second image to generate a synthesized image; and
detecting a crop row or a ridge on the ground surface based on the synthesized image.
